(19) United States
(12) Patent Application Publication
(10) Pub. No.: US 2003/0152145 A1
(43) Pub. Date: Aug. 14, 2003

(54) Crash prevention recorder (CPR)/video-flight data recorder (V-FDR)/cockpit-cabin voice recorder for light aircraft with an add-on option for large commercial jets

(76) Inventor: Kevin Kawakita, Temple City, CA (US)

Correspondence Address: KEVIN KAWAKITA, 5812 TEMPLE CITY, BL. #100, TEMPLE CITY, CA, 91780, US

(21) Appl. No.: 09/999,589

(22) Filed: Nov. 15, 2001

(51) Int. Cl. H04N 7/12; H04N 7/18

(52) U.S. Cl. 375/240.12; 348/117; 348/144

(57) ABSTRACT

FIG. 1 shows a light airplane with the installed invention comprising: an Electronic Rear-view Mirror Component (100) in the cockpit usable by the pilot or co-pilot from the adjustment of twin mechanical arms, a Video Local Area Network (V-LAN) Component (3000), several Bug-Eye Sensor Components (2000) for the front-video camera (2004), rear video camera (2008), right video camera (2012), and left video camera (2016), and a Crash Prevention Recorder (CPR) Component (4000).

### BACKGROUND—CROSS-REFERENCE TO MY RELATED INVENTIONS

U.S. patent application Ser. No. 09/638,072 filed on Aug. 15, 2000 concerning an “Add-on Electronic Rear-View Mirror for Trucks, Campers, Recreational Vehicles (RV's), and Vans.” This patent refers to my related invention concerning an Electronic Rear View Mirror or blind spot mirror for these types of vehicles. This patent also covers three optional embodiments for a High Security Data Recording (HSDR) Option, a Crash Prevention Recorder (CPR) Option/Video Flight Data Recorder (V-FDR) Option/Cockpit-Cabin Voice Recorder (CVR) Option, and a Telematics Computer Option (trip computer integrated with a Global Positioning System satellite navigation receiver). The vehicles for the optional embodiments may be land vehicles, ships, or airplanes. This prior art patent is used as a component in this proposed systems level patent.

### BACKGROUND

1. Field of Invention

This invention relates to aircraft avionics or flight electronics and also to auxiliary airplane avionics support equipment.

2. Discussion of Prior Art

### Public Use in Prior Art Electronic Positioning Independent Radio Beacon (EPIRB)

The US Coast Guard has prior art standards for a commercial Electronic Positioning Independent Radio Beacon (EPIRB). This is a portable, hand-held, radio transmitting only beacon used for flight crew distress signalling of the keyed-in historic date, time, and location of a crash site and the keyed-in current date, time, and drift position of a life raft. The EPIRB can be used along with a hand-held, Global Positioning System (GPS), satellite navigation receiver or by other means. The EPIRB unit is small, inexpensive, and portable for use by flight crew on life rafts, small boats, airplanes, etc. The older units did not require a built-in Global Positioning System (GPS) satellite navigation receiver, but, the newer units have one built-in for automatic position determination and broadcast.

The radio distress call is sent out over two common radio distress frequencies, one of which is also picked up by a geostationary US GOES weather satellite where it is re-broadcast to a US Coast Guard listening station. US Coast Guard helicopters and search vessels can listen in on one of the radio frequencies while closing in on a search pattern.

### Electronic Location Transmitters (ELT's)

Electronic Location Transmitters (ELT's) are used universally with a 95% success rate in US Air Force and US Navy aircraft in which combined deployable Flight Data Recorders (FDR's)/Cockpit Voice Recorders (CVR's) are jettisoned with an air foil or else with solid rocket propellant. The “black box” lands away from the crashed aircraft with its exploding munitions and hotly burning aviation fuel. The “black box” deploys a parachute and float for water landings. A radio frequency and float on the military “black box” replaces the sonar locator on a commercial, Flight Data Recorder or on its separate box commercial, Cockpit Voice Recorder. The deployed antenna is usually free of crash debris signal blockage. The “black box” automatically holds the Global Positioning Satellite (GPS) position of the point of jettison which it broadcasts to rescue aircraft over either a combat situation, encrypted, Spread Spectrum Radio Frequency Channel accessible only by US Air Force Rescue Helicopters in warfare situations or over a non-encrypted, standard, Coast Guard Rescue Radio Frequency in peace-time situations. Embedded into the ELT is an independent, low-cost, GPS receiver which computes the current float position for radio transmission. The ELT device works even with a fatal crash involving the pilot. It avoids the problem of water crashes with a fixed Flight Data Recorder. The device avoids the problem of exploding weapons ordinance and a prolonged aviation fuel fed fire problem of a fixed Flight Data Recorder.

### Charge Couple Device (CCD) Based Video Cameras

Lipstick sized, color, Charge Couple Device (CCD), video cameras have been developed under the Clinton Administration's Partnership for a New Generation of Vehicles Program started in 1992. This program is a joint program of research and development by Federal Research labs and the US automobile industry with the goal of developing a car which gives 60 miles per gallon in combined city and freeway driving. The video cameras are nicknamed “lipstick cameras” and are wide-angle and passively focused using electronics. Unfortunately due to limited rate production and current use only in research and development programs, the “lipstick cameras” are now very expensive.

Stanford University is now in y. 2001 licensing fully digital, Complementary Metal Oxide Semiconductor (CMOS), solid state technology imaging Integrated Circuits (IC's) which directly produce digital signals for video camera use without need of an analog signal line and a separate and expensive Analog to Digital Converter (ADC). The y. 2001 currently prevailing view is that although these cameras are very inexpensive, they have very high lighting requirements and very low resolution compared to CCD device based video cameras.

### Analog Signal Formats

Closed Circuit TeleVision (CCTV) security cameras have many known prior art circuits and applications. The dominant analog signal standards are US National Television Standards (NTSC) which is also used in Japan, Phase Analog Logic (PAL I, PAL II) used in Europe, and Sequential Color Media (SECAM) used for security, video cameras.

These analog audio/video signal standards are basically the same excepting details. The NTSC signal is described as an example. A frame is 525 lines (483 viewable lines) which are scanned at a 30 Hz progressive rate or else scanned every other line at a 60 Hz interlaced rate (interlacing uses US AC power's 60 Hz cycling rate). The analog or s-shaped signal is a modulated power intensity vs. time where the power intensity is the measured light intensity produced in a single color frequency, Charge Couple Device (CCD) in a video camera. A separate CCD is used for the primary broadcast colors of Red, Green, and Blue (RGB) analog signal production with identical processes for each primary color. The video camera also produces row timing pulses known as “line syncs” and frame timing pulses known as “frame syncs”. A slight 11 micro-second delay occurs during “horizontal blanking” at the end of each line before a “line sync” to move the electron beam to the start of the next row. At the end of each frame before a “frame sync”, a precise extra count of 42 garbage rows (525−42=483 viewable rows) are sent to allow for the “vertical blanking” period of 830−1330 micro-seconds which allows the electron beam to move back to the top left of the screen.

For each NTSC audio/video channel, an amplitude (vertical) vs. frequency (horizontal) chart can be used to describe the signal format. For each audio/video channel, a lower sideband of separation is used. A middle band holds the three primary color video channel. The middle band consists of the single carrier frequency band of the amplitude modulated, three primary colors which are phase shifted so that they do not interfere with each other. The three primary broadcast colors are sent as amplitude modulated signals sent at the same carrier frequency which are offset by fixed phase angles. The different primary colors are identified by the short phase modulated “name tag” signal called a chrominance signal which is added after each horizontal line sync signal and in turn is followed by the amplitude modulated primary color at that defined phase angle. An upper sideband is used to send 2-channels (stereo) of Frequency Modulated (FM) audio. The complete analog, RGB analog signals with separate, 2-channel audio (stereo) are amplified for transmission over coaxial cable and possible storage upon analog, video cassette or else for broadcast over the airwaves. The complete audio/video for a single channel with separation takes up 6.0 Mega Hertz of bandwidth.

The Phase Analog Logic (PAL I and PAL II) analog, video signals are designed for more viewable lines and less flicker from a higher refresh rate available in European AC power. The signal also uses phase modulation instead of amplitude modulation.

The Sequential Color Media (SECAM) analog, video signals are designed for higher resolution with very small frame security video cameras.

### Analog TV's and Security Displays

In the analog television display, the signal is amplified with a Low Noise Amplifier (LNA), and used to modulate an electron beam which strikes color RGB phosphors in the television screen. In the most expensive Sony (R) Trinitron type of “one gun one lens” design, three separate electron beam guns with three separate magnetic, focusing lenses are used for each RGB color. The intensity of the signal triggers a stronger electron beam “tingle” of a Red, Green, and Blue (RGB) phosphor with more intensity for a brighter color. The analog signal uses the “horizontal blanking period” for sending the electron beam from right to left at the start of a new row. The analog signal uses the “vertical blanking period” for sending the electron beam from bottom to top at the start of a new frame. Separate video signals exist for the Red, Green, and Blue (RGB) transmission colors as well as for a two-channel (stereo) audio channel from the signal spectrum. The color, analog signal standards take up a total of about 6.0 Mega Hz per color, 2-channel audio (stereo)/video channnel including signal separation.

### Coaxial Cable

A standard coaxial cable used in Closed Circuit TeleVision (CCTV) has a total multiple frequency, analog signal bandwidth of 400 MHz. This maximum analog maximum bandwidth is limited by electromagnetic interference with cramming more than one carrier frequency used too closely together. This coaxial bandwidth can be divided up by engineers any way into dedicated, analog, 4 MHz, color, video channels or else analog, 20 KHz, audio, only channels. The NTSC combined audio/video signal for one channel has a lower sideband separator, followed by 1-channel of Amplitude Modulated (AM), color video with the three primary colors offset at the same carrier frequency by different phases, followed by an upper sideband of 2-channels of Frequency Modulated (FM) stereo audio. The total per audio/video channel bandwidth for a NTSC signal is about 6.0 Mega Hertz of bandwidth.

A digital signal modulated to analog by a modem can be sent over the coaxial cable. Digital signals have increased immunity to noise and electromagnetic interference allowing cramming in of much closer multi-frequency carriers or broadband use. Cable modems allow full use of the digital, broadband, 900 Mega Hz capacity of the coaxial cable. Cable TeleVision systems use the coaxial cable with “cable modems” or broadband modems. Such cable modems are designed to be highly asymmetric for World Wide Web and Internet use. Typical commercial cable modems use 30 Mega bits/second downstream rates per loop and 384 Kilo bits/second upstream rates per loop with the loop divided or shared by one to thirty homes. This is the current y. 2001 standard used on cable subscribing homes many of which have older, analog, cable TV converter boxes. There was a cable company requirement for backwards analog compatiblity to serve these older analog cable television set-top boxes with expanded channel coverage which consumed much of the available, digital 900 Mega Hz bandwidth. Only a small fraction of the total available bandwidth was allocated to digital cable modem service giving the 30 Mega bits/second rate which must be divided up by up to 30 cable loop users. Full use of the coaxial cable for dedicated compressed, 900 Mega Hertz, fully digital service of cable television, pay-per-view, and broadband modem use will give over 900 Mega bits/second which can be divided up between up to 30 cable loop users!!!!!!!

### Fiber Optic Cable

Single frequency or narrow band fiber optic cable carries digital data at a one Giga (billion) bit/second rate. Multi-frequency or multi-mode fiber can carry data at a 100 Giga bit/second rate. Fiber optics are inherently a digital format because a Laser Frequency (visible light wavelength) Light Emitting Diode (LED) also called a Laser Diode is used to transmit laser pulses of a burst of light for a binary “1” and a quiet period for a binary “0”. This single frequency (fixed wavelength) laser signal is transmitted at the speed of light over the fiber optic cable by internal cable wall reflections. The signal is received at the other end by a photo-diode which is a light sensitive transducer which converts the binary light pulse back into electrical signals which a micro-processer can handle. In the late 1990's, multi-node or multiple-frequency fiber optic cables were commercially introduced which have HUGE TRANSMISSION CAPACITIES, but, are very expensive and complex. Fiber optics have tremendous inherent immunity to noise, electromagnetic interference, cross-talk (cross-signal intereference), and attenuation (signal weakining with distance).

Fiber optic cables can carry digitized analog signals using Pulse Code Modulation (PCM) (see BACKGROUND—Computer Industry Digital Signal Formats). Conversion from digital to analog produces modulation Losses.

### Video Cassette Recorders (VCR's)

Video Cassette Recorder (VCR) magnetic tape can easily record analog signals for up to 7 hours of full-motion on one audio/video channel by using reduced resolution and slower frame rates. Video tape is Mylar (R) brand vinyl plastic tape which is coated with ferro-magnetic, magnetic oxide particles. A helical scanning or diagonal scanning head is used to write and read the magnetic tape to increase linear recording. An “s-shaped” analog, amplitude modulated signal or in other words a fixed frequency with amplitude showing the intensity of the light at a given point in the horizontal scan line is magnetically written across a diagonal or helical track going across the tape. The helical track is electronically joined together into a single continuous line. Tape cartridges using 8 mm tape (Super 8 format) have higher magnetic densities, recording resolution, and longer tape lifespans than VHS (R) brands of tape cartridges commonly used for home videocasette taping machines.

Video Cassette Recorders (VCR's) use a VHS tape format in VCR players and a Super-8 mm tape format in video cameras. Super-8 mm tape format has higher image resolution and much longer tape life and durability.

Some specialized, security video cameras use freeze-frame video cassette recording of sequenced or permanently bordered, merged (up to four frames by four rows or 16 separate video channels), analog video (without audio) channels. The freeze-frame rates are about one frame per three seconds. This allows video recording of up to sixteen separate video channels for several days upon one single video tape.

### Security Video Camera Digital and Analog Signal Processing

Analog frame merging/sequencing is very limited with analog, frame sequencers of full-size video only frames and analog, fixed border, video only mini-frames of up to 16 channels per screen being predominant prior art techniques. Also dedicated one video display per video camera and one Video Casette Recorder (VCR) per video camera are used in security viewing rooms as at Las Vegas casinos. This approach produces racks and racks of video screens and video cameras which fill entire rooms. Cockpit space (footprint space) and weight is very limited in planes, so, this technique is not desirable or even practical.

Special security Video Cassette Recorders (VCR's) are available which do time lapse or freeze frame recording. This techniques is used in bank Automatic Teller Machines (ATM's) to extend the recording range of VCR tapes beyond the 7 hours of full-motion, reduced quality, analog, video signal. Two frames a second recording rates instead of 60 frames/second allow the use of one VCR tape for 105 hours or 4.37 days.

### Computer Industry Digital Video Signal Formats

The computer industry has developed separate, digital, video standards from broadcast television. The current standard in y. 2001 is the digital, color, Ultra extended Graphics Array (UXGA) standard. This digital video standard can be understood in terms of a history of the preceeding digital video standards.

The preceeding Video Graphics Array (VGA) standard was based upon each picture element or “pixel” having one “color code” which is an index into an artist's pallette (color look-up table) of pre-mixed colors. The Video Graphics Array (VGA) color code is 8 bits long which gives an artists pallette of up to 256 different, pre-mixed colors (pre-mixed with 8-bits of red, 8-bits of green, and 8-bits of blue). The specified VGA minimum screen size of 480 pixels/row by 640 pixels/column requires for full motion video a total of [480 pixels/row×640 pixels/column×8 bits/pixel×30 frames/second/1024 bits/kilobit/1024 bits/kilobit=70.3 Mega bits/second or about uncompressed, 8.79 Mega bytes/second at 8 bits/byte].

This high data rate was a burden for the slow, 20 Mega Hertz, 16-bit micro-processors of the 1985's. VGA color video at full screen sizes was often done with non-full motion. Full-motion, compressed, color video was done at less than full-screen size often with postage stamp sized viewing sub-screens as in Microsoft Windows Media Player and MacIntosh Quicktime Video. Hard disk drives of the era had 300 Mega byte capacities and 2-3 Mega bytes/second of sustained disk transfer rates. The uncompressed, color, VGA video could not be handled by the hard disk drives.

The Super Video Graphics Array (SVGA) added to VGA digital video signal formats a “true color” mode of 24-bits per pixel or 8 bits of Red, 8-bits of Green, and 8-bits of Blue. At the same minimum screen sizes of 480 pixels/row by 640 pixels/column (3 to 4 aspect ratio) at 30 frames/second and at 24-bits/pixel the data rate was multiplied by three times to 26.4 Mega bytes/second!!!!! A larger screen size of 800×1000 pixels was also supported.

This data rate was a burden for the 66 Mega Hertz, 32-bit microprocessors of the 1990's. Hard disk drives of the era had 2-3 Giga bytes of storage and 8 Mega bytes/second sustained data transfer rates. This hardware could barely handle compressed, digital color, SVGA video often using hardware plug-in cards for time consuming and highly asymmetric video compression, and spare processer throughput for video decompression.

The y. 2001 Ultra extended Graphics Array (UXGA) is VGA and SVGA compatible. It supported “true color” mode of 8 bits Red, 8 bits Green, and 8 bits Blue per pixel as well as a larger frame size of 1000 pixels/row by 1200 pixels/column at a 30 frames/second refresh rate and 1200×1600 at a 15 frames/second refresh rate.

This UXGA color, digital video is supported by 1 Giga Hertz, 64-bit micro-processors of the 2000's. Hard disk drives of the era had 20-30 Giga bytes of storage and 40 Mega bytes/second of sustained data transfer rates.

### Computer Industry Digital Audio Signal Formats

Digital audio is entirely separate from the video channel. It uses Pulse Code Modulation (PCM) or fixed-point binary number sound sampling with the vertical access being analog, s-shaped, sound wave amplitude and the horizontal axis being time. Digital companding uses a non-linear or non-equally spaced vertical scale which gives more sampling bits to higher frequency sound than to lower frequency sound.

Digital sound requires a minimum of an additional uncompressed, 56 Kilo bits/second per audio channel for 8-bits/sample (8-bit) at 7 Kilo Hertz sampling. More realistic 16-bit sound used 16-bit sound samples at 20 Kilo Hertz sampling rates or 320 Kilo bits/second or 40 Kilo bytes/second. State of the art concert quality Compact Disk (CD) quality sound uses 24-bits/sample at a 44 Kilo Hertz sampling rate which produces a digital bandwidth of 1056 Kilo bits/second or 132 Kilo bytes/second. Some extra bits are added for parity error detection which are ignored in these calculations. Some extra bits are added for error detection and forward error correction (Reed Solomon or RS coding) which is ignored in this simple analysis.

Digital, 2-channel (stereo) audio requires two separate digital, audio channels which for CD quality stereo sound is a data rate of 264 Kilo bytes/second. Multi-channel, digital, surround sound requires a minimum of 5-channels of audio usually for four surround the television stereo speakers with a woofer (bass), tweeter (high frequency), and mid-range, and a single, fifth speaker dedicated only to a woofer (bass). 5-channel CD quality sound requires a data rate of 660 Kilo bytes/second.

Musical instruments have complicated sound patterns which in prior art were computer generated through an artificial process called “FM synthesis”. This produced artificial sounding music. The state or the art practice developed and licensed through Stanford University is to use “wave tables” or actual digital samples of sound from different instruments held on Compact Disk which can be used to generate realistic sounding synthetic music.

### Computer Industry Video Cards and Audio Cards

These are Input/Output (I/O) bus cards made to handle the specific digital video and digital audio signal formats by interfacing the Central Processing Unit (CPU) to the specific digital, computer monitor or specific analog, loudspeaker being used. Multi-sync monitors were initiated by Toshiba Corporation and are adjustable to link a multi-sync monitor to many different brands of digital, graphics video cards. The older monitors required a graphics card specifically made for it. The latest and fastest graphics cards used with Intel (R) Pentium computers are called Accelerated Graphics Port (AGP) cards. AGP grahpics cards do not fit onto the I/O bus called a Peripherral Connection Interface (PCI) bus, but, have a dedicated video graphics port directly connected by a PCI/AGP bridge chip to the CPU's Random Access Memory (RAM).

The Video Card usually has a graphics co-processer chip. This chip is a dedicated type of video Central Processing Unit (video CPU) dedicated to fast video signal processing. The video co-processer takes over some of the work from the main CPU to free it up for better things. The main CPU gives the video CPU high level graphics accelerator commands for constructing 2-Dimensional and 3-Dimensional graphics. The Video Card may have its own Moving Picture Experts Group Standards II (MPEG II) digital video compression chip. The video CPU usually has its own video Input/Output (I/O) bus to connect to video input/output devices.

The Audio Card usually has an audio co-processer chip. The chip is a dedicated type of audio Digital Signal Processing (DSP) chip dedicated to fast audio signal processing of digital sound turned into fixed-point, Pulse Code Modulated (PCM) binary numbers. The audio co-processer takes over some of the work from the main CPU to free it up for better things. A main task of the Audio Card is Analog to Digital Conversion (ADC) and Digital to Analog Conversion (DAC). The audio card can also have a Moving Picture Experts Group Standards I Level 3 (MPEG I Level 3 or MP3) digital audio, compression chip. The audio co-processer usually has its own audio Input/Output bus to connect to audio input/output devices such as up to 5-channels of analog speaker lines and analog microphone lines.

### Digital Data Compression

Digital data compression with typical medium's can reduce 24-bit color (true-color), Super Video Graphics Array (SVGA), digital video bandwidth's from a whopping 26.4 Mega bytes/second (the latest very fast computer hard disks can only transfer 32 Mega bytes/second while the fastest 24×Compact Disks can only transfer 3.4 Mega Bytes/second) down to 3.4 Mega bytes/second using Moving Picture Experts Group Standards II (MPEG II) audio/video compression. This method uses an Intra-frame (I-frame), Predicted Frame (P-frame), and Bi-directional Frame (B-frame) to store motion picture differences instead of absolute video frames. An Intra-frame (I-frame) is self-contained and compresses data using the discrete cosine transform, Run Length Encoding (RLE) to identify strings of 0 by length count, and Huffman encoding to form tables of repeating bit patterns and repeat count. This MPEG II I-frame technique is the same as for Joint Photographers Experts Group (JPEG) still photo compression. Future security video cameras should be able to integrate into an MPEG data stream very high resolution JPEG still pictures for facial identification purposes either from a hybrid still camera system or an occasional higher resolution video camera shot. The other types of frames are inter-frames. A Predicted Frame (P-frame) is motion predicted from an Intra-frame using various techniques. A Bi-directional Frame (B-frame) is interpolated between an I-frame and a P-frame. The use of long time periods between I-frames with low data rate compression produces large timing distortions which is not good for crash data recording. Crash data recordings will require high MPEG bandwidth and even maximum periods of timing slop between I-frames. Some video details are thrown out in order to maximize Run Length Encoding (RLE) strings of consecutive 0's for compression efficiency which is called lossy compression and is not good for computer programs or critical data. The digital compression data reduction ratio is typically 9 to 20 times depending upon the size and degree of static nature of the background material. Timing is not done with frame sync and line sync timing pulses as in analog video, but, instead with “presentation time stamps” which give the computer time to display a frame which are synchronized with the audio data.

Audio compression can reduce typical 8-bit, sound patterns from 56 kilo bits/second/channel down to 20 kilo bits/second/channel using Moving Picture Experts Group Standards I Level 3 (MPEG I-LVL 3 or MP3) audio, compression. MP3 compression uses several techniques to produce non-concert quality or non-CD quality sound equivalent to a strong, FM radio station. The main MP3 technique is called “audio perceptual shaping” which gets rid of fine, detailed, background sound which is masked out by louder foreground sound. Timing is not done with timing pulses, but, instead with “presentation time stamps” which give the time to play audio synchronized with video.

Dolby Labs (R) has a new US Patented Analog Compression 3 (AC3) standard for digital compression of multi-channel up to five channel, theater type sound (usually allocated to four spaced apart loudspeakers with high, low, and mid-range speakers, and a fifth woofer only loudspeaker for deep bass). De-compression can be selectable from 5 channel sound down to 2 to 5 channel sound. This format is useful for entirely general compressed, digital sound recording of music and movie sound tracks for selective use by either 2-channel (stereo) sound systems, or 5-channel theatre type sound systems.

### Hybrid Key Cryptography

Hybrid Key Cryptography is a hybrid combination of Public Key Cryptography and Secret Key Cryptography. The legal attributes of authentication (like exchanging cursive signatures) and data integrity (wholeness or non-tampering of digital data) is accomplished by using Public Key Cryptography. The legal attributes of secrecy (encryption) and speed are accomplished by Secret Key Cryptography. Data integrity is accomplished by the use of Digital Signatures. Digital Signatures are done by computing a Message Digest Cipher for all digital data and then using a Private Key to uniquely encrypt the Message Digest Cipher into a Digital Signature. The Digital Signature is in “scrambled text” which anyone with a Public Key can decrypt, but, only the holder of the unique and secret Private Key can encrypt for a new value. Hybrid Key Cryptography will give data the legal attributes of:

1). authentication (like an exchange of picture ID's),

2). encryption (like an exchange of confidential, sealed letters),

3). integrity (non-tampering of information),

4). digital signatures (like cursive ink signatures),

5). non-repudiation (denial of a digital signature by the signer),

6). authorization (like handwritten signing of contracts),

7). accessibility (like denying sensitive file access to Joe Hacker)

8). archiving (like filing away postmarked and ink signed documents),

9). audit trail (recording parties accessing information), and

10). play codes and play counts (for digital media custom encryption/decryption and access control).

Hybrid Key Cryptography will be important for Video Local Area Network Data for developing court admissible legal video evidence having authentication, data integrity, and data secrecy.

Key Escrow can be done to put “split Private Keys” and “split Secret Keys” into 3rd party storage. The escrowed keys will be available in case of lost keys, court ordered review of data, and dispute over ownership of encrypted data.

### Legal Issues of Crash Data

Key legal issues of video crash recorder data release to the Free Press must be decided by the democratic US Constitutional process such as “significant newsworthy events” under “Free Press” vs. Federal and state “expectation of privacy” laws. Cockpit Voice Recorder tapes under International and Federal law must undergo review by a Federal judge and the US National Transportation Safety Board for public release of data. Under Federal law, US 911 calls are considered “significant newsworthy events” and are open for US Free Press review. Video data of crashes will be even more sensitive than voice recordings.

Hybrid Key Cryptography will technologically enforce legal attributes of crash data such as authentication, secrecy, data integrity, and crypto key escrow.

Hidden video camera activity which is done without a court warrant and legal “probable cause” of a crime and which has no posted warning sign can constitute an extreme danger to personal privacy in the form of the US Constitution's 4th Amendment (only for government agencies) and Federal and state “expectation of privacy” laws. Posted warning signs of all hidden and open videotaping should be enforced by technology as through electronic posted warning signs and simple open circuit logic which deactivates video cameras when the signs are deactivated.

### Digital Computer Hard Disks

Y. 2001 digital, computer hard disks contained in Hard Disk Drives (HDD's) and attached to HDD controllers can store up to 30 Giga (billion) bytes. Arrays of multiple Hard Disk Drives called disk arrays can store upwards of 1 Tera (trillion or thousand billion or 10 exp 12) bytes. Following 1 Tera (trillion or 10 exp 12) will come 1 Pecta (fillion or 10 exp 15) and then 1 Exa (eillion or 10 exp 18). A single Hard Disk Drive can transfer data at a sustained 40 Mega byte/second rate. Use of disk arrays with disk striping or the storing and reading of data on multiple hard disks almost simultaneously can raise this sustained data transfer rate to 2 Giga bytes/second.

Hard Disk Drives are very susceptible to vibration and catastrophic disk head crashes which will destroy almost all data on the disk drive. A thin cushion or layer of air separates the thin-film head from the rotating disk cylinder which rotates by at a rate of 230 miles per hour!!!!!! Hard disk drives are NOT used for mobile use for this reason and are replaced by solid state computer memory and embedded computers.

### Digital Streaming Tape Drives for Computer Storage

Uncompressed digital audio/video takes lots of computer storage!!!!! Digital video can be stored in digital form on magnetic tape as in computer streaming tape drives used for computer backup of hard disk drives. This recording format stores very closely packed, tiny, magnets of iron oxide aligned in one direction for a binary “1” and the opposite direction for a binary “0”. This recording technique is unlike analog video recording described in BACKGROUND—Analog Video Recording. A y. 2001 high capacity computer, streaming tape drive can hold up to 100-200 Giga bytes of data (100 billion bytes or 100×1000 Mega bytes of data or 800 Giga bits of data) or about 850,000 seconds of uncompressed, full motion, 8-bit color, VGA digital audio/video or 39 hours. The high capacity, digital streaming tape drive recording rate is 20 Mega bytes/second which is fast enough to record about 5 separate channels of MPEG II compressed, video channel without any audio.

Computer streaming tape has very good vibration resistance and re-writable qualities which was why it was used for Cockpit Voice Recorders and Flight Data Recorders in the 1970's to 1980's where it replaced metal foil tape. The Mylar (R) brand Vinyl tape would still wear with use and sometimes have wrapping and breakage problems. In the early 1990's, all new Flight Data Recorders and Cockpit Voice Recorders replaced magnetic tape with the then more limited capacity, solid state memory (Electrically Erasable Programmable Read Only Memory (EEPROM)) (see just below).

### Solid State Memory

Solid State Memory became commmercially available after 1990. It is also called Electrically Erasable Programmable Read Only Memory (EEPROM) which does not need a battery to keep its memory. A very worst case statistical scenario of 100,000 maximum write cycles per EEPROM cell is stated by chip manufacturers. Byte programmable and bank programmable (flash programmable) EEPROM solid state circuits are in the prior art. Consumers know one variant of this EEPROM memory as the Intel FLASH (R) memory cards used for MP3 music file storage.

Earlier solid state non-volatile memory technologies used Lithium battery backed Dynamic Random Access Memory (DRAM). Lithium combined with hydrogen produced Lithium Hydride gas which is almost as toxic as Hydrogen CyaNide, therefore, Lithium batteries were banned from avionics use especially for use in Flight Data Recorders.

EEPROM capacity so far has increased exponentially under Moore's Law (industrial engineering rule-of-thumb) just like semi-conductor capacities which double in transistor count every 18 months. Moore's Law will be hitting the ceiling of non-nanotechnology by the year 2005 using current semi-conductor device physics. About $US 100 billion per year of worldwide, semiconductor Research and Development and the world's sharpest minds keeps Moore's Law progressing. In 1990, the first commercial, flash EEPROM Integrated Circuits (IC's) were 4 Mega bits/IC (512 Kilo bytes). in 1993, flash EEPROM capacity was 16 Mega bits/IC (2 Mega bytes). In 1996, EEPROM capacity was 64 Mega bits/IC (8 Mega bytes). In 1999, flash EEPROM capacity was 256 Mega bits/IC (32 Mega bytes). In y. 2002 EEPROM capacity will be 1 Giga bits/IC (128 Mega bytes).

EEPROM chips can be arranged into removable Solid State Memory Cards such as the Intel FLASH (R) Memory Cards. Initial FLASH (R) memory cards introduced in. y. 1991 held 4 Mega bytes/card (about 8 units of 4 Mega bits/IC EEPROM IC's). Y. 1993 FLASH memory cards held 16 Mega bytes/card (about 8 units of 16 Mega bits/IC EEPROM IC's). Y. 1996 FLASH memory cards held 64 Mega bytes/card (about 8 units of 64 Mega bits/IC EEPROM IC's). Y. 1999 FLASH (R) memory cards held 256 Mega bytes/card (about 8 units of 256 Mega bits/IC EEPROM IC's). Y. 2002 FLASH (R) memory cards will hold 1 Giga (1 thousand million) bytes/card (about 8 units of 1 Giga bits/IC EEPROM IC's).

A y. 2002 FLASH (R) memory card will cost about US $500 dollar for the latest, highest density, 1 Giga Byte FLASH cards. This is very expensive memory!!!!!!!. A 30 Giga byte storage device with removable cartridges will cost US $15,000. Compare this with computer streaming tape drive storage prices per Giga byte. A y. 2002, 300 Giga byte streaming tape drive costs US $150. The moral of the story is that solid state memory is fine for HIGHLY CRITICAL CRASH DATA where survivability is worth the extra cost, but, is not the right removable media for LESSER CRITICAL MAINTENANCE DATA AND SECURITY RECORDING DATA.

EEPROM Integrated Circuits (IC's) arranged into a solid state memory circuit board with several boards used in a Flight Data Recorder or Cockpit Voice Recorder were perfect for almost no maintenance, re-writable, Flight Data Recorders and Cockpit Voice Data Recorders which were introduced in the early 1990's. Current Flight Data Recorders used in the Boeing 777 have 80 Mega bytes of solid state storage and can record up to 512 parameters (no video data is stored in y. 2001). Newer y. 2001 models of solid state memory, Flight Data Recorders have up to 50 Giga bytes of storage and can even record MPEG II compressed digital video data (see BACKGROUND—Video Flight Data Recorders (V-FDR's)).

### Compact Disks

A single sided, single layer, music Compact Disk (CD) holds about 700 Mega bytes of digital data or about enough for two and one-fifth hours of CD quality uncompressed digital, 2-channel (stereo), at 16-bits/sample and a 44 Kilo Hertz sampling rate. This is a 88 Kilo bytes/sec data recording rate (see above). A y. 2001, 24×original issue CD speed transfers data at 3.4 Mega bytes/second.

Uncompressed SVGA video at 24-bits/pixel, 480×640 screen size, and a 30 frame/second recording rate produces a whopping 26.4 Mega bytes/second recording rate!!!!!!!! The original music CD would hold only 28 seconds of uncompressed, digital video without any audio!!!!

Compact Disks Record Once (CD-R) allow one time recording of digital data.

Compact Disks Re-writable (CD-RW) allow multiple re-writes of digital data.

Even ruggedized housing CD's and DVD's are susceptible to vibration. Non-ruggedized housing can experience 50 Hz over 8 octaves vibration with no errors. Ruggedized or vibration damped housing can take 100 Hz over 8 octaves vibration. Three times digital oversampling (multiple reads into read-ahead buffers) and use of Reed-Solomon (RS) error detecting and correcting codes reduces bit error rates. Anyone with a Sony (R) CD Walkman knows about this vibration problem.

### Digital Versatile Disks (DVD's)

A single sided, single layer, movie Digital Versatile Disk (DVD) holds about 10 times the data of an original single sided, single layer CD. The single sided, single layer, DVD holds 7 Giga (billion) bytes of digital data. This is enough for 24 hours of concert quality, 2-channel (stereo), CD sound consisting of digital, uncompressed, 16-bits/sample at a 1-channel 44 Kilo Hertz sampling rate. This data rate gives a 2-channel (stereo) 88 Kilo bytes/second recording rate. An original issue y. 1999 DVD is equivalent to a 24×CD in sustained data transfer rate or about 3.4 Mega bytes,/second. The DVD will hold only 248 seconds or 4.4 minutes of uncompressed SVGA video at 24-bits pixel, 480×640 screen size, and a 30 frame/second recording rate which produces a whopping 26.4 Mega bytes/second recording rate (without any audio)!!!!!!

DVD's use MPEG II audio/video data compression at a 3.4 Mega bytes/second rate. The DVD player has a built-in MPEG II decoder chip. Computer based DVD drives use the Central Processing Unit (CPU) for uncompressed digital video transfer. Stand-alone DVD players must have an embedded computer for this job. This much lower MPEG II video digital data rate allows storage of 2058 seconds or 34 minutes of audio/video on the single sided, single layer DVD.

Two sided, two layer, audio/video DVD's hold about 4×700 Giga bytes or 2800 Giga bytes of digital data. This is about 132 minutes or 2.2 hours of MPEG II compressed audio/video.

Even ruggedized housing CD's and DVD's are susceptible to vibration. Non-ruggedized housing can experience 50 Hz over 8 octaves vibration with no errors. Ruggedized or vibration damped housing can take 100 Hz over 8 octaves vibration. Three times digital oversampling (multiple reads into read-ahead buffers) and use of Reed-Solomon (RS) error detecting and correcting codes reduces bit error rates. Anyone with a Sony (R) CD Walkman knows about this vibration problem.

### Computer Hard Disk Drives (HDD's) and Super Density Floppy Drives

These drives are barely mentioned because of their well known intolerance to any form of vibration which can cause a tragic disk head crash. The disk head floats on a thin, aerodynamic cushion of air above the magnetic disk media flying by at 270 m.p.h. A disk head crash will wipe out most data on the disk.

Removable catridge hard disk drives such as the Iomega (R) Jazz drives store up to 2-3 Giga bytes of data. Mini-cartridge hard disk drive systems from Iomega (R) are now offered for MP3 music use with MP3 players and car audio systems. The vibration handling of these systems is unknown.

Super Density Floppy Drives such as Iomega (R) Zip Drives use a hardened floppy disk in a stiff package to squeeze more density out of floppy disks. Data storage goes up from 1.4 Mega bytes/disk to 100 Mega bytes/disk. They have more vibration tolerance than hard disk drives, but, the tolerance is not great enough for vehicle recording use even with special ruggedized housing with active and passive vibration dampening.

### Combined Analog and Digital Video Signal Formats

An analog video signal format such as National Television Standards Committee (NTSC) can be mixed with digital data. Digital data can be modulated into analog data through known prior art modulation schemes such as Binary Phase Shift Keying (BPSK) of 2-phases per baud (1 bit per baud) and Quad Phase Shift Keying (QPSK) or 4-phases per baud (2 bits per baud). The phase modulated digital data can be added to a video data stream without interference by using the horizontal blanking period and much longer vertical blanking period's “garbage data (see Analog Signal Format above)”. Prior art use of the vertical blanking period's garbage data to transmit useful digital information has occurred in prior art in the US analog, NTSC signal television broadcasts, where, modulated digital television program title and forwarning of local advertising breaks are mixed into the analog audio/video, NTSC broadcast signal. Closed captioning for the hearing impaired is also sent over the vertical blanking period.

Dr. Henry Yuen was issued U.S. Pat. No. 6,239,794 on May 29, 2001 (see BACKGROUND OF INVENTION—Relevant Prior Art Patents) which describes a cable television method of distributing personalized, on-line, interactive, TeleVision (TV) guide information by using the vertical blanking period's “garbage data (see Analog Signal Format above).” This patent was assigned to Gemstar (R) Corp. of VCR Plus fame which was founded by and has Dr. Yuen as President.

Mr. Gilbert Dinkins was issued U.S. Pat. No. 5,854,793 on Dec. 29, 1998 for a system of broadcasting video from a central broadcast station having a single GPS receiver to remote stations with time synchronisation of clocks at every station done through propagation of the GPS time and compensation for broadcast signal delays. The time synchonisation method is to send the current GPS time in the vertical blanking period's garbage data out to the remote stations. A signal propagation delay estimate can be added to GPS time (20 nanosecond accuracy at the GPS receiver) to set the remote station's time (10-20 microsecond accuracy).

These patents establish specialized application, analog audio/video/digital Video Local Area Network (V-LAN) for carrying and distributing real-time video data.

### Analog Video Frame Merging/Sequencing

Prior art analog, security cameras use analog signal video sequencing from up to ten attached video cameras connected to an analog, video MUltipleXer (video MUX or selector) box.

Prior art analog, security cameras can do full analog frame merging of up to sixteen separate video input frames per display by using a master sync timing signal distributed to all video cameras. The input analog video signals from up to sixteen, small frame, independent video cameras are strung together by an analog frame merging box with the scan lines from all frames on a certain row concatenated or joined together. This analog process gives the sixteen mini-screens (4×4) inside of one display security camera displays. The analog frame merging process is very inflexible as the video is not user selectable and the audio is not selectable and is usually left out of the recorded signal.

Prior art analog, security cameras can do analog, static, frame merging of reduced size analog frames into fixed regions of a standard sized video display. This is done for security displays and security data recording of multiple video cameras into a time-lapse, Video Casette Recorder.

Prior art analog, security cameras can show non-user selectable, four frames per row by four rows or up to sixteen mini-displays from sixteen separate video cameras in one, standard sized, security video display by using Analog to Digital Conversion (ADC), digital frame merging of multiple frames, Random Access Memory Digital to Analog Conversion (RAMDAC), and analog display. This technique is best called analog generation, analog to digital conversion, digital manipulation, digital to analog conversion, and analog display.

### Digital Video Frame Merging/Sequencing

Digital frame merging/sequencing is very flexible and easy using for each video channel, one Analog to Digital Converter (ADC) feeding one Video or Duo-port Random Access Memory (DPRAM's), and a fast, video, Digital Signal Processor (video DSP) merging or sequencing digital video for deposit in one Duo-port Random Access Memory (DPRAM) accessed by the Cental Processing Unit (CPU). Video DSP's are simply computer chips dedicated to fast processing of digital video signals. Separate frames can be digitally manipulated as in merged, sequenced, enlarged with added scan lines, reduced with removed scan lines, electronically focused, etc. Analog signals can be easily converted into digital signals by Analog to Digital Converters (ADC's), and visa versa by Digital to Analog Converters (DAC's), and Random Access Memory Digital to Analog Converters (RAMDAC's).

A digital video processor can manipulate a digital video signal. The video digital video signal can be prepared for output transmission by putting it through digital MPEG II COMpression and digital DECoding (video CODEC or digital compression and digital decoder) which converts it to an analog signal for transmission. The Digital decoding is done with a Digital to Analog Converter (DAC).

The reverse process can input an analog video signal into a digital video processor by using the same reversed CODEC circuit The input transmission analog signal is encoded to digital and then undergoes digital de-compression. An Analog to Digital Conversion (ADC) is used for digital encoding. MPEG II de-COMpression is done to restore the uncompressed, digital video signal for manipulation by the video digital signal processor.

### Analog Audio Channel Merging/Sequencing

Audio MUltipeXors (audio MUX) can select one out of N audio input lines or output lines.

### Digital Audio Channel Merging/Sequencing

Digital audio channel merging/sequencing is very flexible and easy using for each audio channel, one Analog to Digital Converter (ADC) feeding one Video or Duo-port Random Access Memory (DPRAM's), and a fast, general purpose Digital Signal Processor (DSP) merging or sequencing digital audio for deposit in one Duo-port Random Access Memory (DPRAM) accessed by the Cental Processing Unit (CPU). Audio DSP's are simply computer chips dedicated to fast processing of arrays of fixed-point digital video signals. Separate audio channels can be digitally manipulated as in merged, sequenced, expanded with added sound effects, reduced with removed sound, electronically altered to a different loudness and over-tones, etc. Analog audio signals can be easily converted into digital signals by Analog to Digital Converters (ADC's), and visa versa by Digital to Analog Converters (DAC's), and Random Access Memory Digital to Analog Converters (RAMDAC's).

Digital audio processed by a general purpose Digital Signal Processor (DSP) is at a fairly slow rate of 20 Kilo Hertz. This uncompressed digitized audio can be digitally compressed and then converted to analog for output to a transmission line. A Digital to Analog Converter (DAC) is used to digitally decode the signal. MPEG I Level III (MP3) digital compression is used to compress the digital signal. The audio CODEC or digital compression and digital decoder does this in a manner just like the video CODEC described above.

The input from the analog transmission line to the Digital Signal Processor (DSP) can use the same reversed function CODEC to digitally encode the input transmission analog signal and then digitally de-compress the signal for Digital Signal Processing (DSP) use. An Analog to Digital Converter (ADC) is used to digitally encode the analog signal and then MPEG I Level III (MP3) is used for digital audio de-compression.

### Prior Art Video Flight Data Recorders (V-FDR's)

An experimental Video Flight Data Recorder (V-FDR) is being tested by the US Federal Aviation Administration (FAA) in y. 2001. This non-patented device is used for cockpit display to the pilot and co-pilot, video recording of pilot actions and cockpit instrument displays, flight electronics instrument data recording, Analog to Digital Conversion (ADC), digital video compression and encryption, and digital, video recording in a crash-proof, digital, solid state memory, Crash Data Recorder (CDR). The external flight control surfaces are targeted for video recording. The Man Machine Interface (MMI) is a laptop computer kept in the cockpit.

AD Aerospace's (http:\\www.ad-aero.co.uk) Flight Vu (TM) is a y. 2001 Video Flight Data Recorder (V-FDR). This is a crash and fire resistant, solid state memory data recorder, which serves as a Cockpit Voice Recorder (CVR)/Flight Data Recorder (FDR)/Video Flight Data Recorder (V-FDR). This flight tested device has inputs from up to four audio channels from four separate microphones (e.g. typically pilot's headset, co-pilot's headset, open cabin microphone for aircraft background noise, and open radio stand microphone). The device has up to a maximum of eight hard wired, video channels (no sound) from up to eight separate video cameras (e.g. typically for a small commercial jet one front mounted aft aimed video camera for all tail flight control surfaces, one top of tail mounted front aimed video camera for all wing flight control surfaces, one bottom of aircraft security camera for baggage loading, one landing gear video camera, one top of aircraft security camera, one interior cockpit camera of instrument displays and pilot actions, and two interior of passenger cabin security cameras). Finally the recorder has one input channel for traditional Flight Data Recorder (FDR) data which is concentrated in a separate, prior art, concentrator box which has up to 500 discrete inputs from modern, prior art, flight data instruments. The recording rate of the video is a disappointing freeze-frame of 2 frames a second for each of the eight video channels just like time-lapse security video cameras with solid state memory capacity for 4 hours of video data which would over-write in 4 hours or until loss of power. The Crash Data Recorder is crash and fire hardened. The Crash Data Recorder also has an Ethernet input/output port and detachable cable from which all historically video recorded data can be downloaded by maintenance personnel for viewing on a laptop PC or Personal Digital Assistant PC. The Ethernet data link can be augmented by a high-speed, microwave frequency, wireless, data link to a laptop PC or palm-top PC.

There was previously no form of cockpit video display for the Flight Vu (R) stored video in the Crash Data Recorder beyond the almost simultaneous, video play-back of the already stored data accessed through the Ethernet port. This cockpit audio and video Man Machine Interface was a laptop computer playing standard MPEG II digital compressed audio/video files transferred over a standard Ethernet Network Interface Card.

A recently proposed and tested use of AD Aerospace's Flight Vu (TM) after the World Trade Center bombing in September of 2001 is to use one interior video camera as a door access security camera for a future, standardized, bullet-proof, explosion resistant, cockpit cabin door. These superstrong, lightweight, armor doors are made by other companies and are simply layers of super hard, Titanium metal steel for explosion resistance, layers of Dupont Kevlar (R) to catch metal shrapnel, and an inside layer of fiberglass to catch any Titanium shrapnel from the door itself. The special door would need an intercom system, some system to equalize pressure in case of rapid, cabin de-pressurization on one side or the other of the door, and special pre-cautions to allow for flight crew exit in case of a fire. The security door video is hardwired to go to a cockpit resident video screen for pre-screening entrants and also to the Video Flight Data Recorder for storage over only one fixed video channel.

The Flight Vu (R) system was fine for what it was designed for, a small private jet or aircraft such as a helicopter with a maximum need of freeze frame recording to the latest solid state memory densities of a maximum of 8 video cameras and a maximum of 4 audio microphones with all storage in a single, non-deployed, crash resistant, Flight Data Recorder box. There is also no satellite navigation integration of the data or telematics computer integration in the system. The Flight Vu (R) solution is not a HIGH INTEGRATION, LOWEST COST design approach for light airplanes. The Flight Vu (R) solution falls short for recording the huge volume of video data and flight data created by up to twenty video cameras and ten audio channels on a large commercial aircraft including needs of recording massive amounts of non-crash resistant, preventive maintenance LOW CRITICAL DATA which is in an easily removable, cartridge form for post-flight analysis.

The very first early 1990's Solid State Memories (see BACKGROND—Solid State Memories) in Flight Data Recorders stored only 80 Mega bytes of data. Year 2000 Flight Data Recorders made of several Solid State Memory boards filled with 256 Kilo bits/IC EEPROM IC's can hold 5120 Mega bytes (5 Giga bytes) of memory. The latest Solid State Memories used in Video Flight Data Recorders have about 5 Giga bytes of storage which is enough data capacity for freeze-frame (2 Hz or two frames a second) storage of even digital, MPEG II compressed, flight video from up to a maximum of 8 video cameras with separate digital, compressed MPEG I Level 3 (MP3) audio channels from up to a maximum of four audio channels. This is illustrated by AD Aerospace's Flight Vu (R) flight data recorder designed for helicopters and small business planes (see BACKGROUND—Video Flight Data Recorders).

Solid State Memory vs. Computer Streaming Tape Drives for video Flight Data Recording use? The future trend is towards all digital, all solid state electronics for use in crash resistant and deployable Flight Data Recording and Cockpit Voice Recording used only for HIGHEST CRITICALITY CRASH DATA. This is because of almost no maintenance, almost human-goof-proof reliability, extremely high fire resistance with the addition of heat and vibration absorbing foam plastic fillings. The disadvantage of solid state memory is the high cost/Mega byte and the fact that the memory is NOT on-the-runway field-maintenance removable as the memory boards must be replaced by breaking black box seals at the certified depot maintenance level.

The use of removable cartridge Intel FLASH (R) solid state memory cards is not feasible for fixed box (non-deployed) crash survivable design or for deployed-box design, since, the box armored structure win be weakened by card slots and the memory cards might fall loose or fail under extreme vibration. The use of such data for on-the-runway maintenance and real-time cockpit viewing must be accessed through almost real-time computer file downloading of already recorded files. This can be done through a palm-top or lap-top computer connected to an Ethernet Network Interface Card (NIC) (10 to 100 Mega bits/second) accessing the solid state memory or else through a palm-top or lap-top computer connected through a high-speed, Microwave Local Area Network (u-LAN) (100 Mega bits/second) to the solid state memory system. This is fine for short condensed data files such as time-stamped, avionics self-test data files, but, for huge digital video computer files (20 Giga bytes) will take an extremely long period over one hour.

### Prior Art Commercial Aircraft Flight Data Recorders (FDR's) and Cockpit Voice Recorders (CVR's)

There are several functions for prior art Flight Data Recorders which are sometimes combined in several boxes or merged into one box. The functions are more important than the boxes!!!!!!!!! The proper design approach would be that the data should be 1st be classified by CRITICALITY and then mapped into the available or new box designs based upon box crash survivability and data CRITICALITY given the state of the art current memory considerations:

The critical data classifications:

HIGHEST CRITICALITY CRASH DATA.

MEDIRUM CRITICALITY FLIGHT SAFETY DATA.

LOWEST CRITICALITY MAINTENANCE AND SECURITY DATA.

The boxes:

1). Flight Data Recorder (FDR)—this box records flight parameters such as plane position, engine thrust, times of radio contact, etc.). HIGHEST CRITICALITY CRASH DATA.

2). Cockpit Voice Recorder (CVR)—this box records from four microphones: the pilot's headset, the co-pilot's headset, an open microphone above the flight cabin for background noise, and a microphone recording all radio contacts. HIGHEST CRITICALITY CRASH DATA.

3). Flight Data Acquisition Unit (FDAU)—this box near the cockpit gathers digital information over discrete digital inputs from throughout the aircraft for condensing into a digital data stream for connection to the Flight Data Recorder (FDR).

4). Crash Prevention Recorder (CPR)—this box records flight maintenance data such as digital avionics readouts during flight, periodic self-test results, etc. The data is often too voluminouus for crash survival packaging. LOWEST CRITICALITY MAINTENANCE AND SECURITY DATA.

5). Video Flight Data Recorder (V-FDR)—this box records video information on external, flight control surfaces for recording at freeze-frame, time-lapsed rates into the Flight Data Recorder. It can also use one camera to record pilot's hand motions and all active cockpit displays for training and flight testing purposes. Contains both HIGHEST CRITICALITY CRASH DATA and MEDIUM CRITICALITY FLIGHT SAFETY DATA.

6). Electronic Location Transmittor (ELT)—this box is usually deployed away from the crashed aircraft to get unimpeded line of sight transmission of Radio Frequency signals giving rescue personnel the crash location automatically obtained before the crash from an on-board satellite navigation receiver. HIGHEST CRITICALITY CRASH DATA.

7). High Security Data Recorder (HSDR)—this box is a video recorder medium containing box which records video camera activity for security purposes while the aircraft is on the ground and during flight. This box is usually not crash protected. Contains both HIGHEST CRITICALITY CRASH DATA and LOWEST CRITICALITY MAINTENANCE AND SECURITY DATA.

8). Fixed Box—is designed to withstand a severe jet crash with an intense fire fed by aviation fuel. The box is armored with heat absorbing foam and a sonar location beacon for underwater location.

9). Deployable Box—is designed to eject away from an aircraft under crash conditions or slow sinking conditions in water. The deployable sometimes uses a pneumatically initiated air foil or solid rocket propellant. The deployable can have a parachute and always has a float for water landings. Especially effective when combined with an ELT (see above).

10). Fixed/Deployable Boxes—is designed to have part or some of the boxes fixed and part or some of the boxes deployable, Certain Flight Data Recorder functions are assigned to each box. More boxes in different parts of the plane are more likely to survive initial crash impact upon one part of the plane. The goal is to maximize at least some critical flight data surviving a fatal crash.

Prior art for large commercial jets are the famous “black boxes” or the Crash Data Recorder (CDR) and Cockpit-Cabin Voice Recorder (CVR). These units are often used by the US National Transportation Safety Board (NTSB) as critical pieces of information in an integrated fact finding mission to establish a master, space and time-line for an often tragic, commercial airline crash. The Flight Data Recorder (FDR) (plane position information, engine thrust information, times of radio contacts, etc.), Cockpit Voice Recorder (pilot and co-pilot conversations, air controller radio contact conversations, all other radio conversations, and an open microphone's background noise recording of flap hydraulic noises, engine noises, and landing gear noises from lowering and locking and unlocking and raising) data is integrated into a master, flight time-line along with eye-witness accounts, air traffic control radio conversations, ground radar video records, structural, and electrical analysis of crash remains, and coroner reports on crash victims. A systemic cause of crashes found in such a manner from common pilot errors, common maintenance flaws, common but infrequent weather conditions such as wind shear, or structural failure can often be identified. Such analysis in the past has saved hundreds of lives from preventing future crashes. However, in a state of “gallows humor” or black humor to relieve overwhelming stress in dealing with overwhelming tragedy, crash investigators sometimes call the “black boxes” use of “post-mortem” crash analysis and crash prevention. A future of y. 2001 sort of Crash Prevention Recorder (CPR) which prevents such tragic crashes would be more than welcome to supplement the “black box” functions.

The two “black boxes” are specified by the US Federal Aviation Administration (FAA) for large commercial jets only and larger private aircraft, as the cost per box often exceeds US $20,000 apiece. The Cockpit Voice Recorder (CVR) is entirely separate mechanically and electrically from the Crash Data Recorder (CDR) and even has a separate power line from main aircraft power which terminates “black box” activity when the power is sheered off or stops delivering. This independent box redundancy was done deliberately to maximize one of the boxes surviving a fatal crash, but, both boxes are located in the tail section of the plane where crash forces are the least. Commercial “black boxes” never had a radio location beacon, never were pre-crash ejected, never had parachute deployment, and never had float deployment.

Modern “black boxes” are made of high strength Titanium alloy steel, with internal Titanium alloy steel bolts to stop crushing forces of the hollow cavity. The hollow cavity has layers of circuit boards, and solid state electrical memory (no more magnetic tape). The solid state electrical memory is typically Electrically Erasable Programmable Read Only Memory (EEPROM) which is kept as stacked, round-circuit boards stored in a heavily armored with Titanium, protruding, cylindrical housing. The solid state memory used after 1990 is favored over the older Mylar (R) magnetic recording tape used after 1970 and the original metal recording foil used in the 1950's and 1960's. The solid state memory is very high density, nearly maintenance free, re-usable for up to ten years under normal use, and extremely fire resistant. The latest Boeing 767 Flight Data Recorders have 80 Mega bytes of solid state memory. The interior air spaces between all circuit boards are filled with a special heat absorbing plastic foam which slowly burns up absorbing heat away from the circuit boards which especially protects the solid state electronic memory. The burning up of all the remaining heat absorbing foam in a prolonged fire marks the start of heat damage to the circuit boards. The latest “black boxes” are specified to withstand aviation fuel (high grade kerosine) fed fires of up to one hour or else an ordinary fire for a several hour period. This is about 2012 degrees Fahrenheit for up to one hour or else a normal 900? degrees Fahrenheit fire for a several hour period. The “black boxes” are made to withstand severe crash forces. One FAA test done on new designs of “black boxes” is to shoot them out of a canon into a cement wall to test for structural failure.

The boxes are designed to survive under sea-water for up to one year without damage. A protruding sonar beacon which looks like a handle and also functions as one sends out a “ping” noise only if water immersion is detected by the box. The sonar beacon can emit full time for a one month period before using up all battery power.

The prior art, Crash Data Recorder (CDR) is limited in size and weight and has very limited solid state memory (the latest Boeing 767 CDR's designed in the early 1990's have 80 Mega bytes of solid state memory). This prior art box can only store very limited data at a rate of once or twice a second for two to four hours before a crash depending upon how modern are the box's electronics. The very limited data is carefully chosen for memory storage limitations. The initial Flight Data Recorders from the 1960's used metal foil and recorded only eleven flight parameters for twice a second during the last one half hour before a crash. The original eleven parameters were time, altitude, airspeed, vertical acceleration, heading, time of each air traffic control contact, pitch attitude or angle, roll attitude or angle, longitudinal acceleration, pitch control surface position, and thrust of each engine. The introduction in the 1970's to Crash Data Recorders of digital, vinyl, Mylar (R) magnetic tape (borrowed from the newly introduced Cockpit Voice Recorders), greatly expanded memory capacity and reliability allowing more parameters to be stored (up to 29). The introduction in the 1990's of solid state, computer memory greatly increased storage capacity even more and allowed recording more variables which quickly increased from 29 to 250 all the way up to y. 2001 700 variables recorded twice a second for up to four hours in the latest Boeing 777 aircraft which has 80 Mega bytes of solid state memory.

The y. 2001 Crash Data Recorder (CDR) records up to 250 variables which can even be down-loaded by remote, encrypted, spread spectrum or frequency hopping, Radio Frequency (RF) link. This newest feature found only on the latest production aircraft such as Boeing 777's. The new Crash Data Recorders even allow ground support crews to do a routine, remote, computerized, maintenance function using a laptop computer with a Radio Frequency Interface Card. Thus the most modern Crash Data Recorders (CDR's) also serve as Crash Prevention Recorders (CPR's) and are economically beneficial to the airlines for maintenance cost reduction. The prior art, commercial aircraft, Crash Data Recorder (CDR) always had a sonar “pinger” for undersea location, but, box ejection, parachute, float, and a radio location beacon has never been specified or used.

Data capacity in all prior art Crash Data Recorder's due to the recording medium type of even solid state computer memory is incapable of the huge amounts of storage needed even for analog or digital, full motion, video data (see BACKGROUND—Analog Signal Formats, Digital Signal Formats, and Audio and Video Digital Data Compression).

The prior art, Cockpit Voice Recorder (CVR) records from four microphones: the pilot's headset, the co-pilot's headset, an open microphone placed on top of the cockpit which is used for recording critical background noises (such as engine noises, flap hydraulics noises, landing gear down and locked noises, landing gear unlocked and up noises), and an open microphone installed in the cockpit's radio microphone stand shared between the pilot and co-pilot which records flight control conversations and all radio conversations. The first Cockpit Voice Recorders used closed loop, digital, magnetic tape allowing for about one-half hour of taping before overwriting or before a crash and loss of power stopped recording. More recent Cockpit Voice Recorders have switched to solid state computer memory which gives up to two hours of digital, audio recording from up to four audio channels. The Cockpit Voice Recorder also has a sonar “pinger” for undersea location while batteries hold out. The commercial aircraft Cockpit Voice Recorder never had a radio location mechanism, ejection mechanism, parachute or float deployment, or a radio location beacon.

Finding a Crash Data Recorder and Cockpit Voice Recorder after a major crash is no small feat. This responsibility falls to the US National Transportation Safety Board (NTSB) in US jurisdiction with invitation to help in international air disasters. The aircraft wreckage may be scattered over several square miles of land. The crash site may be in two hundred fifty feet of sea water which requires specially trained Navy deep-sea, salvage divers. The crash site may be in a swamp. The prolonged aviation fuel fed fires of some crashes exceed the specifications for prolonged heat limitation on the famed “black boxes” usually damaging the solid state memory inside which is covered with heat absorbing plastic foam which eventually burns up. The pressures of some crashes detonate or break up into smaller pieces the enormously hardened “black box”, Titanium alloy steel with internal Titanium bolts used to prevent caving in or rupture. One Federal Aviation Administration test for new types of “black boxes” is to shoot them through a canon at a cement wall to check for crash resistance.

The “black boxes” tell a very limited story of what happened from the initially required 11 parameters at a rate of twice a second. Limited flight control surface data is recorded and limited engine data is recorded such as thrust per engine. There is no selectable recording of avionics data on anomalies or intermittent failures except in the very latest y. 2001 “black boxes.”

Most commercial aircraft crash due to inadvertent pilot or human error in the air or on the ground within five miles of an airport. Pilot errors, maintenance errors, flight controller errors, maintenance crew errors, ground crew errors, and pilot misunderstandings lead the list. After the cause of human error is bad weather conditions causing poor visibility and poor flying conditions. After weather causes are deliberate acts of sabotage, terrorism, and vandalism. The least frequent cause is pure structural, mechanical, or electrical failure.

The process of a factual finding regarding the cause of a crash is difficult because of the many sources of aircraft failure and the sheer complexity of a modern commercial jet. Even with both “black boxes” recovered undamaged, the US National Transportation Safety Board (NTSB) has often been forced to spend several years piecing together many crashes by piecework in order to find the cause of a crash from examing the structural collapse and explosive pattern evidence. Planes don't disintegrate, they just break up into smaller pieces.

e.g. The TWA Flight 800 fiery, mid-air explosion and crash just off Maine in TBD took the National Transportation Safety Board (NTSB's) most skilled crash investigators over two years to reconstruct in an on-shore rented hanger. Explosions don't destroy material, but, simply break it up into smaller pieces which fly apart based upon the laws of physics. The crash occurred over the Atlantic Ocean in fifty foot deep sea water. The speculation of terrorist missiles, stray Air Force missiles, a terrorist bomb were all defeated by finding no traces of explosive residues. The debris was collected undersea by Navy deep sea divers and Navy salvage ships, collected and re-assembled piece by piece in the rented hanger. The explosive pattern and structural collapse from the piece by piece reconstructed plane clearly showed without a doubt that a frayed insulation wire passing through the wings sparked. Since the wings also serve as fuel tanks, the aviation fuel (which is high grade kerosine) detonated and exploded the entire plane just like a bomb. Ageing Capton (R) brand wiring insulation is a known problem in commercial aircraft planes causing many known and reported, on-board fires from electrical sparks. The US Federal Aviation Administration (FAA) immediately initiated a mandatory visible wiring inspection program on all US produced aircraft.

e.g. The Pan American Boeing 747 Flight over Lockerbee Scotland in 1990? killed all onboard. The cause of the crash was quickly determined to be plastic explosives from trace residue found on the wreckage. The source of the plastic explosive was even narrowed down to luggage which was in a certain cargo bay. The luggage was traced back to two Algerion terrorists who curb-side checked in the luggage, but, never boarded the plane. Arrest warrants were issued for the terrorists in hiding in an Islamic terrorist cell based in Europe, but, they fled to Mohmar Khaddafi's fundamentalist Islamic and left-wing, radical country of Libya, where they were greeted as Islamic Jihad or Islamic Holy warriors, willing to murder five hundred innocent civilians.

Year 2000 United Kingdom Civil Aviation Authority (CAA), the British equivalent to the US Federal Aviation Administration, mandates that aircraft under its authority have mandated digital data logging of selected flight instrument readings for Crash Prevention Recorder (CPR) and maintenance purposes. Any anomalies or intermittent failures in electronics or aerodynamic flight control surfaces can be detected before a tragic crash. Several racks of digital streaming computer tape drives are used to record the data and are stationed just aft of the cockpit in a service galley normally used for food tray carts. There is no requirement in this Crash Prevention Recorder for crash worthiness and no expectation of crash survival. There is no way to eject the recording media, parachute it, float it, and find it. The digital data is recorded on digital, streaming tape drive, computer cartridges and can be manually removed and analyzed in a systematic way. The tape cartridges from all classes of aircraft are analyzed by computer for systemic pilot, maintenance, mechanical, electrical, aerodynamic and other problems. Crash survival requirements are not mandated. The commercial airline industry has resisted this type of very large, rack type device because of the old airline industry rule of, “One more pound of dead-weight is one less pound of paying air freight and paying customer.”

The compact and light, crash survivable, third “black box” Crash Prevention Recorder (CPR) approach, or the Boeing 777 approach of Crash Prevention Recorder (CPR) functions integrated into the Crash Data Recorder (CDR) in which support for the airline maintenance function is included is the modern engineering trend. This is an easier “money saving” sell to the airlines.

### Prior Art US Military Aircraft Flight Data Recorders (FDR's)/Cockpit Voice Recorders (CVR's)

The US Navy and US Air Force's latest fighter jets such as the McDonnel Douglas F-18 Hornet use combined Flight Data Recorders (FDR's)/Cockpit Voice Recorders (CVR's) which pre-crash eject away from the plane using solid rocket propellant in order to maximize chances of survival with exploding ordinance usually onboard the plane and also with the intense heat from aviation fuel fed fires. The single “black box” soemtimes deploys a parachute and always deploys a float in case of water landings. An Electronic Location Transmitter (ELT) is included in the “black box” which broadcasts to rescuers the Global Positioning System (GPS) of the crash site. The “black box's” radio antenna is usually clear of plane wreckage which complements the deployment function. These military “black boxes” have no need for a sonar “pinger” since it has been replaced by the ELT. The military “black boxes” have a 95% survival and retrieval rate even in wartime conditions. There is the benefit of an almost instantaneous, automatic crash location function even in event of a fatal crash.

Standard prior art use of military video recorders is for a 1st back of cockpit mounted single camera pilot's hands/cockpit instruments on the Digital Display Interface view which is used for flight training purposes. A 2nd dedicated video camera can view the Head's Up Display for avionics pilot aid's and missile shooting cues. A 3rd dedicated video camera can view the pilot's face for signs of high G turn blackout. A four tape, 4-channel, 8 mm tape cartridge, video tape player is accessible by the pilot from the cockpit. There are no crash worthiness requirements for these military video recorders.

New design military aircraft are specially fitted with test range equipment which uses extensive, on-board aircraft video recorders. The video data is transmitted in real-time in encrypted, digital form to ground computers for real-time flight data analysis. The high data rates and high microwave frequency data links operate only at short ranges and are confined to use over the test ranges for now. Many US Air Force and foreign air force people think that the future of military jets is with unmanned drones used as fighter jets which can pull 30 G force turns without worrying about a fighter pilot on the verge of blacking out at 9 G's from lack of blood flow to the brain. No pilot can survive a 10 G turn.

### Prior Art Crash Data Recorders (CDR's) Used in Automobiles

Modern US automobiles produced in y. 2001, have an intelligent, air bag deployment controller board with very limited, solid state memory which executes a computerized automobile motion model. The rate accelerometers for several axis are stored in very limited computer memory and used for calculations of automobile position, delta position or velocity, delta velocity or acceleration, and delta acceleration or jerk over time. Severe values of jerk or prolonged, and large values of acceleration analyzed in the computer model will deploy the air bags including the new door air bags. This is the technology developed to prevent false air bag deployment which can be extremely dangerous to the occupants especially in a near-crash situation in which -the driver very skillfully avoids a crash by hard driving maneuvers and slamming on the anti-lock brakes.

General Motors (GM) newest cars have an electronic module which will read the air bag computer memory values into a laptop computer for use in automobile accident analysis. Insurance crash investigators are clamoring for legislation to allow them routine access to the crash computer memory values for use as “admissible court evidence” to supplement traditional use of eye-witness accounts, road skid marks, physical evidence, and crashed car remains.

All y. 2001 Indianapolis 500 racing cars, the fore-runners of most break-thru, automotive technology, have been fitted with digital, intelligent, Crash Data Recorders recording extensive data in solid state computer memory. The data comes from the unit's built-in rate accelerometers and also from the computerized automobile electronics and computerized engine controls. This data is invaluable in crash anlysis and even in routine race car maintenance tuning for different types of races.

### Global Positioning System (GPS) Satellite Navigation Receivers

Global Positioning System (GPS) receivers require line of sight access to a minimum of four satellites at once to “triangulate or range” GPS date, extremely accurate GPS time (accurate to 20 nanoseconds plus signal propagation delay of 10-20 microseconds), GPS latitude, GPS longitude, GPS altitude, GPS delta latitude, and GPS delta longitude. GPS basically measures the distance to the four satellites by timing the speed of light propagation to each one using very accurate clocks. Receiver knowledge of crude satellite orbits or satellite almanac for initial location and satellite availability is critical as well as approximate date, time, and initial position. Receiver knowledge of satellite precise orbit or ephemeris is critical. Satellite health and availability is subject to US Department of Defense priorities. The four satellites must be in a high volume, spaced apart, spatial tetrahedron geometry for high position accuracy or GDOP. All in sight satellites must be above a minimum elevation or masking angle which might be critical in landing situations.

Civilian GPS receivers can obtain a 100 meter 95% accuracy (2 sigma) position from the civilian accessed Course/Acquistion or C/A code (L1 frequency). Military GPS receivers can obtain 10 meter or 95% (2 sigma) position using special military only spread-spectrum codes called P-codes and Y-codes using L1 frequencies and L2 frequencies and also corrected data denied to civilian users. The commercial data can have deliberate errors introduced called “dithering” to reduce their accuracy in times of war. The US Department of Defense makes no guarantees for use of GPS beyond US military use.

Use of augmentation techniques to increase civilian receiver accuracy and reliability has been developed which are listed here and are beyond the scope of this patent: speed and heading dead reckoning sensors, map dead reckoning, Inertial Reference Unit (IRU) aiding, false ground based satellites called pseudo-lites, differential correction receiver's and transmitted differential corrections (for 5 meter civilian accuracy), and future use of the US FAA's Wide Area Augmentation System (WAAS).

The US FAA's Wide Area Augmentation System (WAAS) is a geosynchronous satellite which has four functions:

1) as a pseudo-lite or false satellite in case of regular satellite failure or outage during critical close-approach landings and take-offs to supplement many other airport based ground pseudo-lites

2) as an active satellite in the “big 4” final satellite selection which increases position accuracy by better geometries (a higher volume spatial tetrahedron is available)

3) as a transmitter of regional differential position corrections to reduce position error from 100 meters down to about 20 meters (60 feet) (5 meter error can be obtained by using highly local differential correction ground signals)

4) as a communications satellite for broadcasting real-time satellite health, since, the regular satellite health obtained by the GPS satellite telemetry is reserved by the US Department of Defense and cannot be relied upon.

A very inexpensive (less than $500) GPS receiver will be FAA mandated for use onboard every aircraft, especially small planes. Every plane especially near airports or close approach take-off and landing situations, will get redundant ground pseudo-lite and WAAS satellite access in case of primary GPS satellite failure or removal from service for DOD use. A duo-GPS antenna or up/down GPS antenna as used in high dynamics military GPS receivers will be necessary for tracking GPS satellites and the WAAS satellite as well as the ground based pseudo-lites positioned near airports. The inexpensive, GPS receiver will use local differential correction signals (especially near airports) to compute a 5 meter (15 feet) GPS position or else a non-local 20 meter error with only WAAS satellite regional differential correction signals. The differential correction communications channel will hopefully be the same Gold codes used for GPS telemetry data to save use of a separate communications channel. The GPS receiver will compute GPS date, GPS time (accurate to within 20 nanoseconds plus signal propagation delay of 10-20 microseconds), and GPS position (latitude, longitude, altitude, delta latitude, and delta longitude).

The small plane involved in WAAS will send all this GPS data to the ground radar for central coordination along with its flight ID number using a low cost flight transponder which piggy-backs the information upon bounced off ground radar transponder signals. This simple $500 system per plane will mimic million dollar altitude radar and transponder flight information systems used on large, commercial aircraft!!!!

WAAS combined with duo-redundant, low-cost, airborne cellular radio and a computer screen will also allow airplanes “free flight” away from congested urban areas so that they can take fuel saving direct routes outside of established FAA flight corridors or “freeways in the sky.” FAA flight corridors are implemented with ground radar and ground-based Vectors Over Radio (VOR)/Distance Measuring Equipment (DME) equipment (see Objects of Invention—item L)). One application of “free flight” will be fuel saving global over the pole flights outside of major air transportation corridors maintained by Vectors Over Radio (VOR)/Distance Measuring Equipment (DME) equipment. This “free flight” GPS equipment using WAAS has been called the “poor man's airspace radar” which replaces a two million dollar military aircraft radar looking out 50 to 150 nautical miles with a $500 dollar GPS receiver and a $500 duo-redundant, airborne cellular radio using some form of Frequency Division Multiple Access (FDMA) or Code Division Multiple Access (CDMA) signal modulation. Airborne cellular radio will allow very dynamic public radio frequency re-use in local aerial cell areas to create an aerial digital cellular phone system centered around each aircraft. WAAS will use duo-redundant, cellular radio between aircraft to broadcast aircraft ID, GPS date, GPS time, GPS latitude, GPS longitude, GPS alitutude, GPS delta latitude, GPS delta longitude, GPS delta altitude, and GPS position errors (DOPS). Received broadcasts from all aircraft in the local vicinity will give a cockpit computer display of target or track vectors on all nearby aircraft out to 50 nautical miles.

### SUMMARY

This invention is a systems patent for the combined components of an Electronic Rear View Mirror Component (see BACKGROUND—Cross-Reference To My Related Inventions), used as the Man-Machine Interface (MMI), a Video Local Area Network (Video LAN) Component, Video Camera Components, and a Crash Prevention Recorder (CPR) Component consisting of a Video Flight Data Recorder (Video-FDR)/Cockpit-Cabin Voice Recorder (CVR). The Crash Prevention Recorder (CPR) Component is pre-crash ejectable, parachutable, floatable, and findable.

The Preferred Embodiment is for use in light aircraft. The Electronic Rear View Mirror Component (see BACKGROUND—Cross-Reference To My Related Inventions) will add a control and display Man Machine Interface (MMI) to the system. The Video Camera Components will add a front video camera for the single, front engine, a rear video camera for the tail assembly with “rudder”, a left video camera for the left wing “flap”, and a right video camera for the right wing “flap”. The invention will have the surprising result of magically allowing the pilot to “see right through” closed passenger and cargo areas just as if the passengers and cargo were made invisible. The Crash Prevention Recorder (CPR) Component will be pre-crash ejectable, parachutable, floatable, and findable.

A 1st Alternative Embodiment of the new invention is for an Add-On System Device for Large, Commercial Aircraft to supplement the existing Flight Data Recorder (FDR)/Cockpit Voice Recorder (CVR) “black boxes”. The Rear View Mirror Component (see BACKGROUND—Cross-Reference To My Related Inventions) is used as a control and display Man Machine Interface (MMI), along with a Video Local Area Network (Video-LAN) Component, Video Camera Components consisting of interior, audio/video, security cameras, also with video recording of external, flight control surfaces which data is sent to a Crash Prevention Recorder (CPR) Component consisting of a pre-crash ejectable, parachutable, floatable, and findable package.

A 2nd Alternative Embodiment of the new invention is for a design-in system for a future, commercial winged-body, aircraft with no passenger windows. This system invention consists of the Rear View Mirror Component (see BACKGROUND—Cross-Reference To My Related Inventions) is used as a Man Machine Interface (MMI) in the seat-back of every passenger seat with a master control display in the flight crew cabin, a Video Local Area Network (Video-LAN) Component, Video Camera Components consisting of interior, audio/video, security cameras, also with video recording of external, flight control surfaces, and external Blind-Spot areas which data is sent to a Crash Prevention Recorder (CPR) Component consisting of a crash-ejectable, parachutable, floatable, and findable package.

### OBJECTS & ADVANTAGES

### vs.

### Prior Art—Purpose and Requirements

### Objects and Advantages of the Preferred Embodiment

A. An object of this invention is to provide full pilot view of the left wing flap surfaces and right wing flap surfaces on a single, front engine, light airplane through an Electronic Rear View Mirror Component function (see BACKGROUND—Cross-Reference To My Related Inventions).

Current light aircraft have partial or obstructed pilot views of the left wing flap (aileron) surfaces and right wing flap (aileron) surfaces.

B. An object of this invention is to provide full pilot view of the front engine of a single, front engine, light plane and its rear vertical stabilizer (tail) with “rudder” surfaces through an Electronic Rear View Mirror Component function (see BACKGROUND—Cross-Reference To My Related Inventions).

Current light airplanes have full pilot view of a single, front mounted engine. Views of the vertical stabilizer and its “rudder” are non-existant or blocked.

C. An object of this invention is to provide full pilot view of both wing mounted engines and all flight control surfaces on twin engine, light aircraft through an electronic Rear View Mirror function (see BACKGROUND—Cross-Reference To My Related Inventions).

Twin engine, light aircraft have partial sideways pilot views of both engines mounted on each wing. Twin engine, light aircraft often have tail wings with rear tail flaps or “elevators” and sometimes a “rudder” contained on the tail assembly's vertical stabilizer.

D. An object of this invention is to be fully electronic in implementation in everything except the Crash Prevention Recorder (CPR) Component's pre-crash ejectable, parachutable, floatable, and findable package. This full electronic design approach will lower system cost and increase system integration, flexibility and functionality.

E. An object of this invention is to not interfere in any way with any other aircraft aerodynamic controls, mechanical controls, or aircraft avionics systems.

F. An object of this invention is to provide a High Security Data Recording (HSDR) Option for light aircraft.

This option is a specially protected security video recording feature to guard light planes parked in storage using motion sensor activated video cameras with low power florescent light floodlights.

G. An object of this invention is to provide an inexpensive, vehicle Crash Prevention Recorder (CPR) Component consisting of a Video Flight Data Recorder (V-FDR) and Cockpit-Cabin Voice Recorder (CVR) to light aircraft.

Prior art for light airplanes is no crash recording beyond a portable, carry-on video camera and trying to radio for help.

For light airplanes this invention will offer the only low cost, Crash Prevention Recorder (CPR) feature.

H. An object of this invention is to provide a Telematics Computer Option or satellite navigation and trip planning computer option using Global Positioning System (GPS) satellite navigation receivers. The Global Positioning System receiver will allow use of GPS day, GPS time, GPS latitude, GPS longitude, GPS alititude, GPS delta latitude, GPS delta longitude for digitally inserting into the video data of “GPS date, GPS time, and GPS position stamps” for recording by the Frame Merger/Sequencer Unit which is inside of the Electronic Rear View Mirror Component (100).

This option is a centralized, Man Machine Interface (MMI) to a vehicle navigation computer or telematics computer option which might be a light plane's only satellite navigation, Global Positioning System (GPS) based trip planning unit. This telematics computer feature is already provided by the Rear View Mirror Component (see BACKGROUND—Cross Reference To My Related Inventions).

Synthesized speech, voice recognition, keyboard entry, and bezel matrix display pushbutton entry will complete the Man Machine Interface (MMI).

A means for pilot control of light aircraft navigation computer and light aircraft navigation computer display is necessary. An optional aircraft navigation computer or Video Recorder display provides trip planning information and entertainment on long trips. Pilot monitoring is important on long trips to prevent flight hypnosis and driver sleep fatalities.

A newer commercial jet will have its own built-in GPS unit in an integrated, Inertial Navigation Unit (INU). In this case, the Telematics feature of the Rear View Mirror Component (see BACKGROUND—Cross-Reference To My Related Inventions) can act as a back-up GPS system and auxiliary system used with the attached Digital Versatile Disk (DVD) reader with a commercial trip planning DVD giving trip information and trip planning.

I. An object of this invention is to provide an intelligent method of video reduction for the massive amounts of either analog or digital video recorded by a series of video cameras.

For a 1st Alternative Embodiment consisting of an Add-on System to Large Commercial Jets, up to ten exterior flight surface/security video cameras, ten interior security audio/video cameras, and two cockpit security video cameras might be used all with very limited, crash survivable, data recording available.

AD Aerospace's (R) Flight View (R) product (see BACKGROUND—Prior Art Video Flight Data Recorders) addresses this objective by using compressed, digital data from a maximum of eight, color video cameras which is recorded at a maximum twice/second freeze-frame rate into a crash survivable Flight Data Recorder (FDR) using solid state memory. A maximum of four audio channels are continuously recorded using digital, compressed audio into the solid state memory. AD Aerospace advertises a video recording capacity of four hours of freeze-frame video before requiring memory over-writing. The solid state memory capacity is not listed but assumed 0.227 Mega bytes/sec at a freeze-frame, 2 Hz refresh rate of digital, compressed MPEG II video recording for four hours takes about 3268 Mega bytes or a little over 3 Giga bytes of solid state memory.

US Air Force jet fighter Flight Data Recorders (FDR's)/Cockpit Voice Recorders (CVR's) address this video recording capacity issue by not recording any video data in their deployable solid state memory (see BACKGROUND—Prior Art US Military Flight Data Recorders (FDR's)/Cockpit Voice Recorders (CVR's).

US Air Force jet fighter planes usually have 4-video cameras feeding a single box of a 4-channel video recorder kept in the cockpit having 4-channels of audio/video, analog recording to four units of 8 mm cartridge tape. The video cameras are used solely for flight training and aircraft development purposes. The 1st channel of video is trained upon the pilot's hands and the current three Digital Display Interfaces (DDI's) or cockpit video screens with bezel matrix buttons. The 2nd video camera is trained upon the Head's Up Display (HUD) which displays avionics pilot cues and missile shooting cues upon the cockpit. The 3rd channel of video is trained upon the pilot's face to verify high-g turn pilot black-out. The 4th channel of video is flexible. The 1st audio channel is used to record pilot headset microphone notes during the test flight. The 2nd audio channel is used to record 2-way radio microphone chatter. The 3rd audio channel is an open cockpit microphone to catch background noise. The 4th audio channel is flexible. There is no crash survivability or crash deployment requirement. Pilot access to the 8 mm video tape cartridges occurs at the back of the cockpit (see BACKGROUND—Prior Art US Military Flight Data Recorders (FDR's)/Cockpit Voice Recorders (CVR's).

US Air Force test and training ranges have specialized, on-board, video cameras for flight control surface recording. These video cameras do not record the large rates of video data, but, digitally compress it, cryptographically encode it, and transfer it by high speed microwave link to the test ranges sensitive telemetry antennas where it is analyzed real-time for flight anomalies. This technology does not currently work at such high rates over long distances (see BACKGROUND—Prior Art US Military Flight Data Recorders (FDR's)/Cockpit Voice Recorders (CVR's).

J. An object of this invention is to provide an extremely inexpensive, non-crash survivable, Augmented Crash Prevention Recorder unit or sub-box which is in the same box as the crash survivable, Crash Prevention Recorder/Video-Flight Data Recorder (V-FDR)/Flight Data Recorder (FDR)/Cockpit Voice Recorder (CVR)/High Security Data Recorder (HSDR) unit for compact and inexpensive use in a light airplane.

Light airplanes currently have no FAA mandated crash recording box unless they carry commercial passengers.

K. An object of this invention is to provide a 1st Alternative Embodiment consisting of an Add-on System to Large Commercial Jets which provides pilots with a full visible sight, pilot view of all flight control surfaces on existing, wide body, commercial jet aircraft.

Current large commercial jet aircraft have no pilot views of wing mounted engine pods, tail mounted engine pods, limited views of front and rear wing flaps also called ailerons, no views of tail wing flaps also called elevators, no view of the vertical stabilizer or “rudder” flight control surface, no view of any other tail mounted flight control surface such as the small, movable, tail mounted tail winglet on Boeing 727? jets (which have caused a few fatal crashes by mechanical failure).

L. An object of this invention is to provide a 1st Alternative Embodiment consisting of an Add-On System to Large Commercial Jets which provides pilots constant visible sight, 360 degree pitch plane, 360 degree roll plane, and 360 degree yaw plane knowledge of the airspace around their aircraft for emergency evasive maneuver.

Current light aircraft often give about 150 degree pitch plane, 360 degree pilot yaw plane, and 180 degree roll plane pilot visibility.

Current large commercial jetcraft give very limited pilot visibility. Mid-air crashes between large commercial jets and light planes often occur under “visible flight rules” without Visible IDentification (VID) by one or both pilots. Pilots must rely upon instrument readings, ground radar, FAA approved flight plans, co-pilot visible ID verifications, flight crew and passenger visible reports.

Ground radar units manned by Federal Aviation Administration (FAA) flight controllers usually radar capture small planes flying very near fast flying commercial jets in “incidents” in which the flight controllers must radio contact both planes to warn them of each other. These “incidents” often produce “near misses” when the air controller cannot radio contact the small plane or the small plane is piloted by a very amateur pilot endangering a commercial, 550 passenger jumbo jet. Often near large airports, small planes unintentionally wander into FAA restricted air corridors which are also called “freeways in the sky” restricted to fast flying, large commercial jets with the proper equipment. The “freeways in the sky” even change routes over 24-hours near congested commercial airports as noise abatement laws force night take-offs and landings over the sea or away from congested city areas. Air traffic controllers tracking small private planes have no altitude information and no radio frequency filing in a flight plan, all they get from current ground radar is a direction and speed radar blip. A small private plane flying at 180 m.p.h. will fly towards a commercial jet flying just below the speed of sound at 560 m.p.h (with a closing speed of 380 m.p.h.) over a distance of ten miles. The impact reaction time is only 1.58 minutes!!!!! FAA controllers are not worried about professional pilots with expensive “freeway in the sky” equipment, they are worried about the small private planes with amateur pilots. This is a major reason for the FAA's Wide Area Augmentation System (WAAS) (see BACKGROUND—Global Positioning System (GPS) Receivers).

Large commercial jets are equipped with “freeway in the sky” equipment consisting of digital flight plan filing (which can be re-filed automatically from the sky), Vector Over Radio (VOR)/Distance Measuring Equipment (DME) directional Radio wave equipment, long wavelength, Omega navigation equipment (course latitude and logitude), altitude only radar (only military aircraft can afford multi-million dollar per plane airspace radar which can look out 50 Nautical Miles to 150 Nautical Miles), Flight Number ID transponder (transmits Flight Number ID and alitutude data from the aircraft's altitude radar down to the flight controller through a small transponder ground radar which adds this data to the un-identified target (“bogey”) speed and heading information from the main ground radar for display on the flight controller's radar screen).

M. An object of this invention in the 1st Alternative Embodiment consisting of an Add-On System for Large Commercial Jets is to provide an interior of crew/passenger cabin audio/video security recording and display and alerting function to the pilot or co-pilot for security purposes and prevention of hijackings by the alerting of undercover, on-board US Sky Marshalls. Interior audio/video cameras should have “SOS” buttons (instead of motion sensors) for flight crew and passenger alarms to the cockpit. As well, the evidence is video recorded and stored in the Crash Prevention Recorder (CPR) Component to help catch hijackers or suicide bomber accomplices.

Existing commercial jets have no such features. Hijackings often occur in the passenger cabin without pilot or co-pilot knowledge in the flight crew cabin. A voice contact or intercom contact must be made from the flight crew to the pilot and co-pilot.

N. An object of this invention in the 1st Alternative Embodiment consisting of an Add-On System for Large Commercial Jets is to provide a Crash Prevention Recorder (CPR) Component which will include a Video Flight Data Recorder (V-FDR) and Cockpit-Cabin Voice Recorder (CVR) which is pre-crash ejectable, parachutable, floatable, and findable which will supplement the existing Flight Data Recorder (FDR)/Cockpit Voice Recorder (CVR) or the famous “black boxes.”

This video data medium is crew obtainable from outside of the plane through a locked service door for routine maintenance, service review.

The video data can also be sent over a wireless, high-speed microwave frequency, Local Area Network (uWave-LAN), to a ground crew member equipped with a palm held computer running a maintenance and data recording computer program.

An inside the passenger cabin locked box, fixed (non-deployed) box, non-crashworthy, Augmented Crash Prevention Recorder (A-CPR) box will also have convenient cartridge tape removal access of voluminous video flight data and self-test data.

For the 1st Alternative Embodiment or Add-on Option System to Large Commercial Jets, this invention will supplement the existing, standard “black boxes” or the Flight Data Recorder (FDR) and Cockpit Voice Recorder (CVR). Video Flight Data Recording (V-FDR) of flight control surfaces and interior to the passenger cabin security video in cases of hijackings can be integrated with satellite navigation (Global Positioning System or GPS) and Inertial Navigation Unit (INU) data for collection in the Crash Prevention Recorder (CPR) for crash use and more importantly for pilot training, routine maintenance, and crash-detectable ejectable preventive diagnostics.

A Crash Prevention Recorder (CPR) will have a tail mounted, pre-crash ejectable, parachutable, floatable, and findable mechanism which uses parachute deployment, float deployment, GPS float location, radio beacon float location, and radio beacon location of the original crash site.

This option gives a capability for monitoring vehicle crashes and also as a very low-cost, Video Flight Data Recorder (V-FDR), Cockpit-Cabin Voice Recorder (CVR) for light airplanes.

This feature can be used on light airplanes with a Cockpit Voice Recorder (CVR) for an inexpensive Video Flight Data Recorder.

The video recorder is kept in a tail mounted, crash-ejectable, parachutable, floatable, findable package. The float package has a Global Positioning System (GPS) location system and an Emergency Positioning Independent Radio Beacon (EPIRB) or radio location system.

O. An object of this invention in the 1st Alternative embodiment is to allow pilot or co-pilot selection of appropriate video to view and record. The frame merger/sequencer function allows the pilot or co-pilot to monitor the entire interior and exterior of the plane. However, not all the video can be recorded at once at all times as this will overwhelm any data recording device. Only human selected merged video can be viewed and recorded or else a full sequenced mode with a timed delay will sequence through and record all cameras one at a time.

The purpose of this feature is to add interior audio and video cameras to monitor the cabin spaces with only pilot or co-pilot selected frame merging/sequencing and video recording in the Crash Prevention Recorder (CPR).

The Add-on Option for Large Commercial Aircraft will add up to 8 units of interior to the cabin, audio/video security, and a total of 10 units of external video cameras for a total of 20 video cameras from which a co-pilot selection of up to a maximum of 4 units of exterior or interior video cameras will be used in frame merging for co-pilot listening, co-pilot display, and video recording. Video sequencing can sequence through all or a co-pilot chosen selection of the possible 20 video units for co-pilot listening, co-pilot display, and video recording.

The video recorder for the Crash Data Recorder (CDR) will be kept in a tail mounted, pre-crash ejectable, parachutable, floatable, and findable package. The float package has a Global Positioning System (GPS) location system and an Emergency Positioning Independent Radio Beacon (EPIRB) or radio location system.

The Flight View (TM) Video Flight Data Recorder does not allow pilot or co-pilot selection of video to view and record. It is fairly inflexible or hardwired, and limited to a maximum of four separate audio channels. It is limited to e separate video channels recording separately at a two frame per second freeze frame rate. Two video channels as a minimum must be used for external flight control surfaces. One video channel must be used for the bullet proof and explosion resistant cockpit door. One video channel should be used for pilot's hands/cockpit display. This leaves four video channel for interior and exterior passenger cabin area security. The landing gear are uncovered. Only the video aimed at the bullet proof and explosion resistant cockpit door has a video screen display in the cockpit. There is no pilot selected frame merging/sequencing. There is also no time and position stamping of the video data with Global Positioning System data. It can best be said that Flight View is for use in small corporate jets where eight camera views are often sufficient and high security data recording over large passenger areas is not required.

The purpose of this feature is to add interior audio and video cameras to monitor the cabin spaces with only pilot or co-pilot selected frame merging/sequencing and video recording in the Crash Prevention Recorder (CPR).

The Add-on Option for Large Commercial Aircraft will add up to 8 units of interior to the cabin, audio/video security, and a total of 8 units of external video cameras for a total of 16 video cameras from which a co-pilot selection of up to a maximum of 4 units of exterior or interior video cameras will be used in frame merging for co-pilot listening, co-pilot display, and video recording. Video sequencing can sequence through all or a co-pilot chosen selection of the possible 16 video units for co-pilot listening, co-pilot display, and video recording.

The video recorder for the Crash Data Recorder (CDR) will be kept in a tail mounted, pre-crash ejectable, parachutable, floatable, and findable package. The float package has a Global Positioning System (GPS) location system and an Emergency Positioning Independent Radio Beacon (EPIRB) or radio location system.

P. An object of this invention in the 1st Alternative Embodiment of an Add-on System for Large, Commercial Aircraft is to provide an upgradable Video Local Area Network (Video LAN) Component above the initial low bandwidth, analog, Video Local Area Network (Video-LAN) Component used This will NOT allow digital recording of more crash prevention data, since, Remember: THE VIDEO RECORDING DEVICE IS THE BOTTLENECK IN THE SYSTEM!!!!!.

Future upgrade to a high speed, high noise immunity, digital fiber optic data bus is desired.

Q. An object of the 1st Alternative Embodiment of an Add-on System for Large, Commercial Aircraft is to provide an easy to remove from inside of the passenger cabin system of data cartridges for post-analysis, in a fixed (non-deployed) and non-crashworthy, Augmented Crash Prevention Recorder (A-CPR), independent box for the holding of LOWER CRITICAL FLIGHT SAFETY DATA such as voluminous video data and extensive time-stamped self-test data.

Prior art systems for large commercial jets have no such feature.

AD Aerospace's (R) Flight View combines this function in solid state memory in a fixed box, crash-resistant, Flight Data Recorder (FDR) which is difficult to access for post-analysis.

R. An object of the 2nd Alternative Embodiment Design-in System for a Commercial Winged Body Plane's Electronic Rear View Mirror Component (see BACKGROUND—Cross-Reference To My Related Inventions), Video Camera Components, Video Local Area Network Components, Crash Prevention Recorder Component and Augmented Crash Prevention Recorder Component is to provide an integrated video function for the future, windowless passenger compartment, Boeing aircraft.

Each commercial, winged body, passenger will get NO physical windows, instead, he will get built into the facing seatback, his own Electronic Rear View Mirror Component (see BACKGROUND—Cross-Reference To My Related Inventions) with a 17″ flat panel display which will have a customer selectable choice of up to thirty electronic views around the aircraft!!!!!!! This will be integrated with a Crash Prevention Recorder (CPR) Component, a Video Camera Component, and a Video Local Area Network (Video LAN) Component.

There is no prior art on commercial, Winged Body aircraft, electronic window design. Military Winged Body aircraft such as the Northrop B2 bomber, have only pilot windows.

Z. Further objects and advantages of my invention will become apparent from a consideration of the drawings and ensuing description of it.

### DRAWING FIGURES—BRIEF DESCRIPTION OF DRAWINGS

FIG. 1. is a perspective drawing of the installed invention in the preferred embodiment in use with a single front engine, light airplane (9000). The three principle system components of the Electronic Rear View Mirror Component (100) (see Background Cross-Reference to My Related Inventions), the Video Recording Cameras Component (2000), and the Crash Prevention Recorder Package Component (4000) are shown.

FIG. 2 is a close-up drawing of the action of a pilot of the single front engine, light airplane (9000), looking into the Electronic Rear View Mirror Component (100) (see Background—Cross-Reference to My Related Inventions). The placement of the Video Recording Camera Components (2000), the Front Video Camera (2004), Rear Video Camera (2008), Left Video Camera (2012), and Right Video Camera (2016) are shown with the pilot video display.

FIG. 3 is a close-up view of the Electronic Rear View Mirror Component (100).

FIG. 4 is a close-up drawing of the action of someone looking into the Electronic Rear View Mirror Component (100) with “2 in 1 FB Mode” sequenced with “2 in 1 LR Mode” (shown in FIG. 4). The Front Blind-Spot (9012) and Rear Blind-Spot (9016) are shown.

FIG. 5 is a close-up drawing of the action of a driver looking into the Electronic Rear View Mirror Component (100) with “2 in 1 LR Mode” sequenced with “2 in 1 FB Mode” (shown in FIG. 3). The Left Blind-Spot (9020) and Right Blind-Spots (9024) are shown.

FIG. 6 is an electronic block diagram of a Video Frame Merger/Sequencer Unit design which is only one component of the Electronic Rear View Mirror (100) (see Background—Cross-Reference to My Related Inventions).

FIG. 7 is an action figure of the Crash Prevention Recorder Package Component (4000) showing pre-crash ejection, parachute deployment, float deployment, activation of Global Positioning System (GPS) satellite navigation receiver, and radio beacon activation.

FIG. 8 is an electronic block diagram of the Crash Prevention Recorder Component (4000) package.

FIG. 9 is an mechanical block diagram of the Crash Prevention Recorder Component (4000) package.

FIG. 10 is a perspective drawing of the 1st Alternative Embodiment or the Add-on Option To a Large, Commercial Jet Aircraft showing the Video Camera Components (2000), the exterior flight surface video cameras (2200), exterior Blind-Spot view video cameras (2200), interior security audio/video cameras (2300), Electronic Rear View Mirror Component (100) in the flight crew cabin, Video Local Area Network (V-LAN) (3000), Crash Prevention Recorder Component (CPR) (4000) in the tail assembly, Augmented Crash Prevention Recorder Component (A-CPR) (8400) in the passenger cabin, which will supplement the existing Flight Data Recorder (FDR) (9052) in the tail assembly, and also the existing Cockpit Voice Recorder (CVR) (9056) in the tail assembly.

FIG. 11 is a perspective drawing of the 2nd Alternative Embodiment or Design-in Option Used In a Future, Commercial, Winged-body Aircraft having no passenger windows. The systems level invention will consist of an Electronic Rear View Mirror Component (see BACKGROUND—Cross-Reference To My Related Inventions) (100), a Video Camera Component (2000), a Video Local Area Network Component (V-LAN) (3000), a Crash Prevention Recorder Component (CPR) (4000) in the tail assembly, and an Augmented Crash Prevention Recorder Component (A-CPR) (8400) in the passenger cabin which will supplement the existing, non-deployed, Flight Data Recorder (FDR) (9052) and the existing, non-deployed, Cockpit Voice Recorder (CVR) (9056).

### REFERENCE NUMERALS IN DRAWINGS

Following parts are in all embodiments:

Parts of the Electronic Rear View Mirror Component: (Telematics Computer)

100. Electronic Rear View Mirror Component

104. Personal Computer (PC) Motherboard

108. Embedded Central Processing Unit (CPU)

(ceramic chip carrier due to high heat requirements)

109. Boot Programmable Read Only Memory (PROM), Regular Basic Input/Output System (BIOS).

112. Solid State Cooler Chip

(ambient air may be long infrared heated by cockpit safety glass reflection and entrapment and ultra-violet heated from radiation off of metal parts causing super-heated air from a plane's unventilated cockpit. Used to cool embedded, CPU chip instead of a small DC electric, fan.)

116. Embedded Operating System

(e.g. Windows Consumer Electronics (Windows CE) (R), Sun Microsystem's Java (R), Integrated System's PSOS (R), Vertex (R), Wind River's VxWorks (R).)

120. Random Access Memory (RAM)

124. AC Power Plug Interface

125. Filtered and Regulated DC Power Line

128. DC Power Converter and Power Supply with Switched AC/DC Power Output

(AC input power converted to filtered and regulated AC and DC power for Control/Power line for “Bug-eye Sensor including florescent light power, video camera power, motion sensor power)

132. Laptop Computer like peripherals

133. Hard Disk Drive (HDD) Controller

(for digital computer streaming tape drive interface. Future use pending vibration damping packaging limitations for Digital Versatile Disk Rewritable (DVD−RW or competing format DVD+RW) use.

NO HARD DISK DRIVE ALLOWED due to extreme vibration equirements!!!)

136. Electrically Erasable Programmable Read Only Memory (EEPROM)

(for Computer Program storage instead of hard disk drive due to vibration limitations. Allows downloadable computer programs.)

137. First In First Out (FIFO) Buffer

140. Universal Serial Bus (USB) Connector and Interface Circuitry

141. Universal Serial Bus (USB) Cable

(from the Flat Panel Display's Bezel Matrix and Cross Control Panel's control buttons to the Frame Merger/Sequencer Unit)

144. Peripheral Component Interconnect (PCI) Bus

(for Plug-in or Screw-In Input/Output (I/O) Cards)

145. PCI/AGP Bridge Chip

Peripheral Interconnect Interface (PCI) is the prior art 32-bit or 64-bit computer industry standard Input/Output (I/O) bus. Accelerated Graphics Port (AGP) is the high speed graphics back-end port directly conected to Intel (R) Pentium Random Access Memory (RAM).

146. AGP Graphics Accelerator Chip

Digital video processing of high level 2-Dimensional and 3-Dimensional graphics primitives commands sent from the Central Processing Unit (CPU) to the AGP Graphics accelerator chip. Direct access to system Dynamic Random Access Memory (DRAM) allows for efficient 3-Dimensional texture mapping manipulations (this is like the flower skin on a Pasadena New Year's Day Rose Bowl parade float chicken wire wrapped frame body).

147. AGP Video Port

148. Frame Merger/Sequencer/SVGA Video PCI Card Slot (for coaxial cable or CCTV interfaces)

149. External Antennas Cable

152. Global Positioning System (GPS) PCI Card Slot

(satellite navigation attaches by cable to external, flight control surface conformable, micro-strip, receive only antenna. This Framer Merger/Sequencer Unit GPS receiver is distinct from the undeployed CPR GPS Receiver used only in a crash. This GPS receiver is necessary to actively track satellites and give GPS date and time-stamp, and current GPS position data to the audio/video data stream. This GPS receiver is necessary to give initialization data (recent satellite almanac (less than one month old), date and approximate time, and approximate initial position) to the undeployed CPR GPS receiver (see below).)

Global Positioning System (GPS) PCI Card Receiver itself is not part of this invention.

153. External GPS Micro-strip Antenna and Cable

A duo-antenna design (upper nose and lower nose) GPS antenna is used for high dynamics military jets because of “line of sight” to four satellites at once limitations for a position fix. Aerodynamic surface conformable, low drag, design is important.

Special aerodynamic antenna design might be unique to this invention for a low-cost, commercial GPS receiver.

156. INternational MARitime SATellite (INMARSAT) Commission, Standard C, Text Only, L-band Transmitter/Receiver PCI Card Slot

(Future Upgrade Option only—satellite communications attaches by cable to external flight control surface conformable L-band Microwave Frequency antenna)

INMARSAT Stndard C PCI Card Receiver itself is not part of this invention.

Special aerodynamic antenna design might be unique to this invention for a low-cost, commercial satellite communications terminal.

157. External INMARSAT Standard C Antenna and Cable

158. (Future Use) Airborne Cellular Radio PCI Card

159. (Future Use) Airborne Cellular Radio Antenna and Cable

160. Fiber Optic Network Interface Card (NIC) PCI Card Slot

(future upgrade option only—for large commercial jets especially the future, commercial, Winged Body Transport)

164. Fiber Frame Merger/Sequencer/SVGA Video PCI Card Slot

(future upgrade option only—for fiber optic data to and from the NIC PCI Card. Good for large commercial aircraft and the future, commercial, Winged Body Transport. Replaces the regular Frame Merger/Sequencer PCI Card dedicated to coaxial cable video input use.)

168. Ethernet Bus (commercial Air Research INdustry Council (ARINC) TBD) Network Interface Card (NIC)

400. Very Large Flat Panel Display with Bezel Matrix Buttons and Cross Control Panel

(color, Super Video Graphics Array (SVGA) signals with a display greater than 17″ diagonal without bezel)

404. Super Video Graphics Array (SVGA) Video Cable

(from Frame Merger/Sequencer/SVGA PCI Card)

408. Bezel Matrix Buttons

412. Adjustable Mechanical and Lockable Arms for Flat Panel Display

(like the arms on a dentist's x-ray machine)

416. Viewing Angle Adjustment Handles

420. Flat Panel Display Mounted Speakers

424. Flat Panel Display Mounted Microphones

428. Pilot's Microphone/Speaker Headset

432. Co-pilot's Microphone/Speaker Headset

436. Flat Panel Display Mounted Remote Mic Antenna with Radio Frequency Transmitter/Receiver

440. Shirt Clip-on Remote Microphone with Radio Frequency Transmitter/Receiver

448. Save Our Ship (SOS) Button

452. Tilt-up/Tilt-down “L-Arm” Glare Filters Holder

456. Slide-up/Slide-down Glare Filter

(e.g. Ultra-Violet Light (UV) filter, High Glare Filter, Low Glare Filter)

Cross Control Panel Buttons:

480. Mode Selection Button

484. View Immediate Selection and Hold “Cross” 4-Button

488. Power ON/OFF Button

492. Rear-view Mirror Power Cable

(AC power from the Uninterruptible Power Supply)

496. Computer Keyboard

(mounted with hook and loop fasteners below the Electronic Rear View Mirror)

500. Computer Keyboard Cable

(from keyboard to the Electronic Rear View Mirror's Motherboard)

Parts of the Frame Merger/Sequencer/SVGA Unit Sub-component:

(e.g. Peripheral Component Interconnect (PCI) bus plug-in Input/Output (I/O) Card of Super Video Graphics Array (SVGA) Video Card and Integrated Frame Merger Sequencer Unit)

1000. Frame Merger/Sequencer/SVGA Unit Sub-component

(e.g. in the form of a PCI bus Plug-in Input/Output Card)

1020. Video Camera Audio/Video Signal Cable Inputs

1021. Digital to Analog Converter (DAC)

1024. Analog to Digital Converter (ADC)

1025. Digital Video Compression Decoder (Video CODEC)

(Digital video processor outputs uncompressed digital video which goes to an MPEG II digital COmpression chip for digital compression and then goes to a Digital to Analog Converter (DAC) for digital DECoding (CODEC) to analog afterwhich the output analog (modulated digital) signal is transmitted. The reverse process of input analog signal (modulated digital) transmission is passed to an Analog to Digital Converter (ADC) where it is encoded from analog into digital and then passed to an MPEG II de-compression chip for digital compression with the de-compressed digital signal ready for processing by the digital video processor).

1028. Video Random Access Memory (VRAM)

(also called Duo-Port Random Access Memory (DP-RAM)

1029. Windows (R) VRAM (Win VRAM)

1030. Video BIOS

Video Basic Input Output System

1032. Video Processor Bus

1036. Digital Video Graphics Processer

(does digital video manipulation such as frame merging/sequencing, scan line conversion for frame enlargement and reduction, image translation (change of focal point), image rotation, mirror image, non-mirror image, negative image, positive image, electronic zoom, electronic reduction, electronic focus, edge enhancement.

If an analog video signal, also does digital data insertion (e.g. GPS date, GPS time and GPS position stamps, GPS receiver initiation data (e.g. satellite almanac, GPS date, GPS time, initial crude receiver location), etc.) into the analog signal's “horizontal blanking period” and also the “vertical blanking” period between video frames (see BACKGROUND—Analog Signal Formats).

If a digital signal does ASCII encoding and digital data overwriting of static background video areas before MPEG II compression using a protocol such as last bytes of video frame giving the address of the variably placed data. MPEG II compression can be modified to avoid lossy compression of this critical data while doing reduction differencing of everything except the changing ASCII digits.

Always recorded crashworthy or deployed storage video channels (may be frame merged four to a frame or frame sequenced) should be:

1). cockpit camera of pilot's/co-pilot's hands & cockpit displays

2). cockpit view of pilot's and co-pilot's body (signs of fatigue)

3). front of plane view (bird inhalation in engines, ground obstacles, etc.)

4). tail flight control surfaces (rudder, aielerons)

5). left wing flight control surfaces (trailing and leading edge flaps)

6). right wing flight control surfaces (trailing and leading edge flaps)

7). cockpit explosion proof door entry

8). landing gear in locked or raised position

9). pilot's selected view

10). pilot's selected view

Selected pilot video recording (may be frame merged 16 to a frame or frame sequenced):

1). internal security video cameras

2). external security video cameras

Augmented CPR Recording (see below) can record more video channels which are not stored in limited crashworthy or deployed storage.

1). all security video cameras in full motion during flight, during ground maintenance, and during over-night parking.

2). full frame views of all video cameras

3). airport runway and storage security video

4). )

1040. Super Video Graphics Array (SVGA) Video Processer

(does SVGA video signal processing, and video acceleration of graphics primitives received from the Embedded Central Processing Unit. Video Basic Input Output System (Video-BIOS) interfaces to the Embedded Central Processing Unit over the PCI bus.)

1044. Dynamic Random Access Memory (DRAM)

1048. Static Random Access Memory (SRAM)

1052. Electrically Erasable Programmable Read Only Memory (EEPROM)

(for embedded computer program)

1056. Programmable Array Logic (PAL)

1060. Random Access Memory Digital to Analog Converter (RAMDAC)

1064. Super Video Graphics Array (SVGA) Video Output (to Flat Panel Display through SVGA Video Cable)

1066. National Television Standards Committee (NTSC), Analog, Audio/Video/Digital Output

(to Crash Prevention Recorder (CPR) through the Video LAN Component)

1068. Discrete Logic

(including “Bug-eye Sensor” AC/DC Power Control, including “Bug-eye Sensor” control/power line for motion sensor control line, florescent light power control, video camera power control, and motion sensor power control)

Parts of the Audio PCI Card Component:

1600. Audio PCI Card Component

1604. Audio Digital Signal Processer (Audio DSP)

Analog NTSC audio/video signals give 2 FM audio channels as an upper sideband.

Additional analog audio channels can be converted to digital using Analog to Digital Converters (ADC), MPEG I Level 3 (MP3) compressed, modulated to analog using a modem for insertion into the “horizontal blanking” and “vertical blanking analog NTSC periods.

Digital audio signals can use MPEG I Level 3 (MP3) audio compression. Separate compressed, digital audio channels must be sent along with the compressed, digital video channels.

Crashworthy or deployed storage of:

Up to 7 channels of 1-channel audio:

1). Pilot's headset microphone, also used for the pilot's shirt clip-on microphone Radio Frequency connected to the Electronic Rear View Mirror

2). Co-pilot's headset microphone

3). top of cockpit open microphone for background noise (tell-tale noises of proper operation of landing gear, engine, hydraulics)

4). radio stand open microphone

5). explosion resistant cockpit door entry microphone

6). Pilot selected interior/exterior microphone

7). Pilot selected interior/exterior microphone

Augmented CPR Recording (see below) can record more audio channels which are not stored in limited crashworthy or deployed storage.

1608. Audio Processer Bus

1612. Digital Audio Compression Decoder (audio CODEC)

Used for fully digital audio/video/flight only which is modulated into analog for analog transmission over coaxial cable:

(Digital Signal Processor (DSP) outputs uncompressed digital audio which goes to a MPEG II Level 3 (MP3) chip to do audio Compression and us of a Digital to Analog Converter (DAC) to to digital DECoding to analog (modulated digital) for output analog transmission.

Reverse process of input analog (modulated digital) transmission goes to an Analog to Digital Converter (ADC) where it is encoded to compressed, digital and then to an MPEG II Level 3 chip for digital de-compression for final uncompressed digital input into the Digital Signal Processer (DSP)).

Parts of the Video Cameras Component:

2000. Video Camera “Bug-eye” Sensor Component

2004. Front Video Camera

2008. Rear Video Camera

2012. Left Video Camera

2016. Right Video Camera

2100. Control/Power Connecting Cable Sub-component

2120. Front Control/Power Connecting Cable

2124. Rear Control/Power Connecting Cable

2128. Left Control/Power Connecting Cable

2132. Right Control/Power Connecting Cable

2200. “Bug-eye Sensor” Sub-Component

2204. 2 Units Low-Wattage Florescent Lights

(2 units make up the bug eyes)

2208. 1 Unit Video Camera

(1 unit makes up the bug nose)

2212. 1 Unit Motion Sensor

(1 unit makes up the bug mouth)

2300. “Bug-eye Interior Sensor” with Microphone and SOS Button Sub-Component

2304. 2 Units of Florescent Lights

(2 units make up the bug eyes)

2308. 1 Unit of Video Camera

(1 unit makes up the bug nose)

2312. 1 Unit of Interior Microphone

2316. 1 Unit of SOS Button

2400. Video Camera/Motion Sensor/Microphone

Interior Sensor

(has no florescent lights)

2500. Aerodynamic Faring

(for exterior “Bug-eye Sensor” use with bug-eye holes, bug-nose holes, and bug-mouth holes)

Parts of the Video Local Area Network (Video-LAN) Component:

3000. Video Local Area Network (Video-LAN) Component

3004. Front Audio/Video Signal Cable

(Closed Circuit TeleVision (CCTV) coaxial cable)

3008. Rear Audio/Video Signal Cable

(Closed Circuit TeleVision (CCTV) coaxial cable)

3012. Left Audio/Video Signal Cable

(Closed Circuit TeleVision (CCTV) coaxial cable)

3016. Right Audio/Video Signal Cable

(Closed Circuit TeleVision (CCTV) coaxial cable)

3017. Video Recorder Wired Remote Input Cable

3018. Video Recorder Wired Remote Output Cable

3019. Video Recorder Video In Signal Interface

3020. Video Recorder Video Out Signal Interface

3021. Video Recorder Audio/Video/Digital In Signal Cable

(Purely Analog Audio/Video Signal Use—Coaxial cable taking Audio/Video/Digital analog signals with inserted digital flight data modulated to analog (with the Frame Merger/Sequencer Unit inserting the modulated digital flight signals) to the Crash Prevention Recorder's (CPR's) CPR Smart Motion Control Computer (who can read, over-write, and insert modulated digital control signals) and eventually to the Video Recorder.)

All Digital Audio/Video/Flight Data in the form of MPEG II compressed, digital, audio/video data stamped with digital flight data can be modulated into analog signals for transmission by using known prior art modulation techniques such as Binary Phase Shift Keying (BPSK) and Quad Phase Shift Keying (QPSK). Digital broadband or multi-frequency, full-duplex, symmetric modems (broadband modulation/de-modulation devices) must be used in this application area.)

Fully digital, fiber optic LAN is a future upgrade option. Remember: THE RECORDING DEVICE IS THE BOTTLENECK IN THE SYSTEM AND NOT THE VIDEO LAN!!!!!!!

3024. Video Recorder Audio/Video/Digital Out Signal Cable

(Purely Analog Audi/Video Signal Use—Coaxial cable taking Audio/Video/Digital signals (with Frame/Merger Sequencer Unit inserted modulated digital flight data) transmitted from the Crash Prevention Recorder's (CPR's) Video Recorder to the CPR Smart Motion Control Computer (who can overwrite the inserted modulated digital control signals) to the Frame Merger/Sequencer Unit (who can read, write, and insert the modulated digital control signals).

All Digital Audio/Video/Flight data in the form of MPEG II compressed digital audio/video data stamped with digital flight data can be modulated into analog for transmission using known prior art modulation techniques such as Binary Phase Shift Keying (BPSK) and Quad Phase Shift Keying (QPSK). Digital broadband or multi-frequency, full-duplex, symmetric modems (modulation/de-modulation devices) must be used in this application area.

Fully digital, fiber optic LAN is a future upgrade option. Remember: THE RECORDING DEVICE IS THE BOTTLENECK IN THE SYSTEM AND NOT THE VIDEO LAN!!!!!!!

Parts of the Crash Prevention Recorder (CPR) Component:

4000. Crash Prevention Recorder (CPR) Component

4004. Crew Access External Door for Video Recorder Medium

(Water-tight and Tamper Resistant, Anti-pick, Locked Door Flush with External Flight Surface)

4008. Mother Crash Prevention Recorder Package Interface

4012. Child Crash Prevention Recorder Package Interface

4016. Mother Crash Prevention Recorder (CPR) Package

4020. Aircraft Power Interface

4021. Aircraft AC Power Line

4024. Uninterruptible Power Supply (UPS)

4028. DC Power Converter and Regulator

4032. AC/DC Power Supply and Regulator

4036. Video Recorder AC Power Cable

4040. DC Power Line

4044. AC Power Line

(to Electronic Rear View Mirror in cockpit)

4048. Video Local Area Network (V-LAN) Network Interface Fiber Optic Cable

(future upgrade option only—for use with the fiber optic Video LAN)

4052. Video Recorder Audio/Video/Digital In Signal Cable Inteface (cable is part of Video LAN)

4056. Video Recorder Audio/Video/Digital Out Signal Cable Interface (cable is part of Video LAN)

4060. Video Recorder Wired Remote Control Cable

(supplements use of Video LAN)

4064. Video Recorder Wired Remote Interface

4065A. Auxiliary Crash Prevention Recorder Sub-box (A-CPR-sub-box)

(this sub-box has non-crash protected, non-deployed storage of cartridge removable data used for LESS CRITICAL MAINTENANCE AND SECURITY DATA STORAGE).

4065. Mother Video Recorder

For analog signals, analog VCR of 8 mm or VHS format players.

For digital signals, digital streaming computer tape drive.

4066. Mother Video Recorder Tape Cartridges

4067. Mother Video Recorder Controller PCI Interface Card

For analog signals, Video Cassette Recorder Interface.

For digital signals, digital streaming computer tape drive Hard D isk Drive (HDD) Controller.

4068, Mother's Umbilical Cord

(attached to child)

4400. Child Crash Prevention Recorder (CPR) Package

(Ejectable Deployment Package—watertight, airtight, smooth surfaced for no-snags, orange painted surface with florescent markings, “CRASH PREVENTION RECORDER—NO TAMPERING” markings.

4404. Pre-Crash Ejection Solid Rocket Propellant

(detonated by Child Crash Prevention Recorder's intelligent motion control model—just like a baby saying its time to rock & roll!!!!!!)

4405. Directional Thrust Nozzles

Control the direction of the solid rocket propellant fuel under CPR Smart Motion Control Computer aiming control.

4406. Deployable Mini-Winglets

Under rotation control by the CPR Smart Motion Control Computer. Should be placed in the direction of travel slightly behind the center of mass of the Child CPR component to create nose-down stabilizing aerodynamic stability.

4407. Deployable Vertical Stabilizer

Under timing deployment control of the CPR Smart Motion Computer.

4408. Child's Umbilical Cord

(attached to “Mom” in a detachable manner)

4412. CPR Smart Motion Control Computer

(embedded PC Motherboard Motion Control Computer with PCI Bus and PCI plug-in cards. Has an on the motherboard “time of day” digital clock having Month, year, date, and time which is converted by the Operating System (OS) into a binary time value from 00:00:00 hours of a fixed starting date (approximate date and time is needed by GPS receivers for proper initialization and satellite location). Has smart Video LAN Component connection to the Frame Merger/Sequencer Component to receive GPS receiver initialization data such as the latest satellite almanac, and crude initial position data. Can monitor the analog (eventually fully digital) audio/video/flight data before recording on the Video Recorder. The CPR Smart Motion Control Computer can return to the Frame Merger Sequencer Component real-time status back for pilot/co-pilot viewing.

The CPR Smart Motion Control Computer is used for closed loop servo-electronics done for a motion control computer based model using inputs from the Electronic Transducer, and Rate Accelerometers for birthing or ejection from ” mom”, as well as for float deployment, parachute hook release, for upside-down landing detection, for water landing detection and whether to deploy the ballast. After on-board GPS antenna deployment and activation, GPS data can be used in motion modeling, and also for transmission over the Electronic Positioning Independent Radio Beacon (EPIRB) of both the current float GPS position and any stored, historic GPS positions of the crash site which can come from the CPR GPS receiver or the Frame Merger/Sequencer Units GPS receiver).

Also has:

plug-in PCI bus GPS card slot (see below),

plug-in PCI bus EPIRB card slot (see below),

plug-in PCI bus Electronic Leveler Transducer combined with Rate Accelerometer Card slot (see below),

plug-in PCI bus Fiber Optic Network Interface (NIC) card (see below),

plug-in PCI bus Spread Spectrum (Frequency Hopping), Microwave Frequency, High Speed Wireless Local Area Network (Wireless LAN) Card slot (see below)

which will make it a smart, controller for the Crash Prevention Recorder.

4416. Video Local Area Network (V-LAN) Network Interface Card (NIC) PCI Plug-in Card

(future upgrade option only—for full digital, fiber optic LAN)

4420. Parachute Deployment Package

4424. Parachute Hook Release

4428. Float Deployment Package

4432. Emergency Positioning Independent Radio Beacon (EPIRB) or US Air Force Electronic Location Transmitter (ELT)

(with GPS Interface or plug-in PCI bus Input/Output (I/O) Card interface which would automatically gain GPS data access from the CPR Smart Motion Control Computer. This will automatically broadcast to a US Coast Guard Rescue helicopter, historic GPS date and GPS time of crash, historic GPS position of crash, and current GPS date, GPS time, and GPS position of the drifting, CPR float. Even a fatal crash for all on-board will be immediately locatable.

The drifting pilot's life-raft will have a hand-held EPIRB in which he can key in his current location obtained from a hand-held GPS receiver as well as the pilot's estimate of the historic crash GPS date, GPS time, and GPS location. In the event of a fatal crash, the hand-held pilot's EPIRB cannot be relied upon.)

4436. Deployable EPIRB Antenna and Cable

4437. Electronic Location Transmitter (ELT)

This is the US Air Force's counter-part to the EPIRB.

4438. Deployable ELT Antenna and Cable

4440. CPR Global Positioning System (GPS) Receiver

(with EPIRB Interface or plug-in PCI bus Input/Output (I/O) Card interface which would give GPS data access to the CPR Smart Motion Control Computer who will in turn give the latest GPS data to the EPIRB.

Important factors concerning CPR GPS position—Rapid (less than twenty minute) CPR GPS receiver convergence upon four satellites with course acquisitioon (C/A Code) accurate GPS position (less than 100 meter error), GPS date, and GPS time (accurate to several nanoseconds) is desired. This will require a recent (less than one month old) GPS satellite almanac (crude satellite orbits) and also the current data, a crude initial time, and crude initial position (date and time can be obtained from either the CPR Motherboard's “time of day” digital clock or the input audio/video/flight data stream having the GPS date, GPS time, and GPS position from the Electronic Rear View Mirror's GPS receiver). The most recent almanac collection and storage is usually done automatically in an active GPS receiver with an already deployed GPS antenna. An already deployed GPS receiver prompts the human user for the crude inital position or retrieves a stored value in a stationary GPS receiver. However, this scenario is not feasible for a remote, fully automatic, CPR GPS receiver unless the data is also digitally inserted into the audio/video data stream from another cockpit GPS receiver. The recent almanac and crude initial position is used to obtain the ephemeris (precise orbits) of all 2 launched and active satellites (3 spares) and up to local pseudo-lites (false ground satellites placed near airports). The geometrical constellation of the best of four “line of sight” satellites (forming a maximized volume spatial tetrahedron) is used to converge upon a GPS position through a form of triangulation called “ranging.”

Since there is no human operator, the CPR GPS initialization data such as a less than one month old almanac (crude satellite orbits), and crude initial position can be obtained from the Frame Merger/Sequencer Unit's, active GPS unit over the Video LAN. This GPS initialization position from the already tracking Frame Merger/Sequencer Unit's GPS receiver will in most cases be a better guess of the crash GPS location than the CPR's GPS receiver which will usually take up to twenty minutes to start producing accurate GPS positions after full deployment.

Alternately as a last resort, an extremely old (more than one month old) GPS satellite almanac (crude satellite orbits used for initial satellite acquisition) can be used without a date and crude, initial time and crude initial position in a “search the sky mode”. “Search the sky mode” should be required for the GPS receiver. This mode using an extremely old satellite almanac which might take three hours to find a single satellite for current almanac download. The almanac download from a single satellite will then usually take a maximum of fifteen minutes, but, may take up to thrity minutes on almanac roll-over). Satellite health is collected on the 25th page of data. There are 300 bits/sub-word and five words per page. There are 1500 bits per page and 50 bits/second amplitude modulation rate or 300 seconds/page. Pages 1-25 completes a data set, The almanac download is followed by satellite ephemeris (precise orbit) download for each of the 2 active launched satellites plus up to local pseudo-lites (artificial ground satellites for airport use) which takes about fifteen minutes, but may take up to thirty minutes on ephemeris roll-over. The ephemeris of all “in sight” satellites (less than 5) and pseudo-lites (usually less than 5) are used to select the best of four satellite constellation (using a maximized volume spread apart spacial tetrahedron geometry), followed by satellite tracking of four satellites and position convergence (takes five minutes).

The High Speed, Wireless, Maintenance LAN can also be used for GPS almanac update and verification of storage of a recent worldwide almanac.)

4444. Deployable CPR GPS Antenna and Cable

4447. Fire/Heat Transducer

Detects on-board slow burning fires which do not cause explosive forces, but, may destroy video recording storage if not ejected or fire/crash protected.

4448. Electronic Level Transducer

(could be a PCI bus Input/Output Plug-in Card for CPR Smart Motion Control Computer access in motion modeling)

4449. Slow Water Immersion Sensor

4450. Rate Accelerometers

(x-axis, y-axis, z-axis, could be a PCI bus Input/Output Plug-in Card for CPR Smart Motion Control Computer access in motion modeling)

4454. Deployable Ballast & Convective Ocean Cooling Fin

(e.g. battery is heavy for ballast use only in water landings with Electronic Level Transducer and Rate Accelerometers based motion model detecting pitch and roll or an upside down position on land landings.)

4458. Solar Cell

(for recharging battery after child CPR deployment)

4462. Solid State Cooling Element

4466. Video Recorder

If analog signal, a Video Cassette Recorder (VCR) of VHS or 8 mm tape format.

If digital signal, a computer streaming tape drive.

4470. Video Recorder Medium

If analog signal, a VCR Tape of VHS or 8 mm format.

If digital signal, a computer streaming tape cartridge.

4471. Video Recorder Controller PCI Interface Card

If analog signal, a VCR PCI Interface Card.

If digital signal, a Hard Disk Drive (HDD) interface.

4474. Crew Maintenance Video Recorder Medium Access Door

(Water-tight and air-tight Access Door)

4478. High Speed Wireless, Maintenance, Microwave Frequency, Local Area Network (uWave LAN) PCI Card

(PCI bus Spread Spectrum (Frequency Hopping), High Speed Wireless, Maintenance, Microwave Frequency, Local Area Network (uWave LAN) Card used for remote, short-range, downloading of encrypted, Video Recorder medium data down to a ground crew maintenance person using a laptop or palm computer with a similar plug-in PCI card. Would have on the circuit board a hardware encryption chip).

4479. Microwave LAN Antenna and Cable

(this antenna is already deployed exterior to the plane's rear protrusion for run-way use, so, its cable must be breakable cable threaded through the mother/child cable connector.)

4482. Deployable Radio Frequency (RF) Antenna and Cable

4486. Fully Charged Battery

5000. Ground Maintenance Crew Member's Laptop Computer

(PCI bus Spread Spectrum (Frequency Hopping), High Speed, Wireless, Maintenance, Microwave Frequency, Local Area Network (uWave LAN) Card used for remote, short-range, downloading of encrypted, Video Recorder Medium data down to a ground crew maintenance person using a laptop or palm computer with a similar plug-in PCI card. Would have on the circuit board a hardware encryption chip. Laptop computer would run maintenance history and automatic monitoring program to flag any mechanical, electrical, or detected structural problems or anomalies. Should also check for a recent satellite almanac in the Crash Prevention Recorder's GPS receiver).

5200. CPR Development Computer

For development and test purposes only.

5204. CPR Development Computer Standard PC Connectors

For development connection of CPR Development Computer only.

Following parts are part of the Alternative Embodiments:

Additional Parts of the Video Camera Components:

6000. Flight Control Surface Video Camera

6004. Flight Control Surface Control/Power Cable

6008. Exterior Blind Spot Video Camera

6012. Exterior Blind Spot Control/Power Cable

6016. Interior Crew/Passenger Cabin Audio/Video Camera

6020. Interior Crew/Passenger Cabin Control/Power Cable

6024.

Additional Parts of the Video Local Area Network (Video-LAN) Component:

7000. Flight Control Surface Audio/Video Signal Cable

7004. Exterior Blind Spot Audio/Video Signal Cable

7008. Interior Crew/Passenger Cabin Audio/Video Signal Cable

7040. High Speed, Fiber Optic, Star Topology, Duo-Redundant, Video Local Area Network (Video-LAN)

(future upgrade option for Commercial Winged Body Transports).

Has a fast Switching Hub at the star center. Fully digital signal format, single frequency fiber or multi-mode fiber.

7044. Custom, Symmetric, Cable Modem or Broadband Modem

(for fully digital signal use of coaxial cable use on both ends).

Additional Parts of the Crash Prevention Recorder (CPR) Component:

8000. Crash Prevention Recorder Digital Versatile Disk Rewritable (DVD−RW or DVD+RW)

(future upgrade option only—for fully digital crash data recording).

Currently has severe vibration limitations even with ruggedized housing.

8004. Digital Computer Streaming Tape

(future upgrade option only—for fully digital crash data recording).

8400. Augmented CPR (A-CPR) Box

This is a fixed or non-deployed and non-crashworthy box which large, digital streaming tape drive memory for digital audio/video/flight data storage of LESS CRITICAL MAINTENANCE AND SECURITY DATA.

Flight crew/ground maintenance crew streaming tape cassette access is possible from a locked door inside of the passenger compartment.

Has a Hard Disk Drive (HDD) interface to the PCI bus of the embedded Personal Computer motherboard controlling the box. May need an Analog to Digital Converter (ADC) and symmetric, broadband modem or cable modem for converting input analog modulated digital data from a coaxial cable into digital data. Output digital data might need modulation to analog by a Digital to Analog Converter (DAC) and a symmetric, broadband modem or cable modem for transmission over an analog coaxial cable.

Remember: THE VIDEO RECORDING DEVICE IS THE BOTTLENECK IN THE SYSTEM!!!!!!!.

8404. Augmented CPR Box Analog Video Splitter

8408. Augmented CPR Box Digital Video LAN Bridge

Following Parts are not part of Invention:

9000. Aircraft

9004. Pilot

9008. Cargo

9012. Front Blind-Spot

9016. Rear Blind-Spot

9020. Left Blind-Spot

9024. Right Blind-Spot

9028. Aircraft Battery

9032. Aircraft Power Supply to Invention

9036. Explosion Resistant Cockpit Door

9036. Global Positioning System (GPS) Satellite

(needs external, flight surface conforming, L-band antenna. Line of sight to a minimum of four, low-earth orbit, satellites (or ground based pseudo-lites or ground based false satellites used to improve accuracy and to give redundant reliability near airports) might require an upper and lower body antenna depending upon reliability of position and time data. Reliability of position and time data will depend upon aviation use such as in mid-air traffic control use especially with small planes, or just pilot information use.

The US Federal Aviation Administration (US FAA) has proposed a Wide Area Augmentation System (WAAS) which uses a single geosynchronous satellite to serve as a permanent “fifth GPS satellite”. This is a redundant satellite in case of GPS satellite failure during aircraft close approach landings or take-offs. It will augment ground based pseudo-lites near airports. It will also give a reliable communications channel regarding GPS satellite health.)

9037. Hand-held GPS Receiver w/Built-in Antenna

9040. INternational MARitime SATellite (INMARSAT) Commission, Standard C, Text Only Satellite

(text only worldwide, satellite calls—has aerodynamic, flight surface conforming, L-band, micro-strip antenna)

9044. US Coast Guard Rescue Helicopter

(monitoring Electronic Positioning Independent Radio Beacon (EPIRB) radio frequencies to receive Global Positioning Position (GPS) current drift positions both of Crash Prevention Recorder (CPR) float with EPIRB, pilot hand-held GPS receiver position hand keyed into a hand-held EPIRB giving current GPS position of the pilot's life-raft, from the CPR the historic GPS date, GPS time, and GPS position of the crash site, and from the pilot's hand-held EPIRB the keyed-in historic GPS date, GPS time, and GPS position of the crash site.)

9048. Flight Data Acquisition Unit (FDAU)

Collects discrete, digital, electronic inputs from the entire aircraft and avionics for condensing and sequential transfer over digital data link such as Ethernet or ARINC TBD to the Flight Data Recorder (FDR).

9052. Flight Data Recorder (FDR)

US FAA commercial aircraft and large private passenger private planes must have this box. Crashworthy/fire resistant/sonar locatable, but, not deployed.

US Military jets use combined CVR/FDR which are deployed, parachuted, floated, and have automatic satellite navigation based Electronic Location Transmitter's (ELT's).

9056. Cockpit Voice Recorder

US FAA commercial aircraft and large private passenger private planes must have this box. Crashworth/fire resistant/sonar locatable but not deployed.

US Military jets use combined CVR/FDR which are deployed, parachuted, floated, and have automatic satellite navigation based Electronic Location Transmitter's (ELT's).

9060. Hand-held Emergency Positioning Independent Radio Beacon (EPIRB)

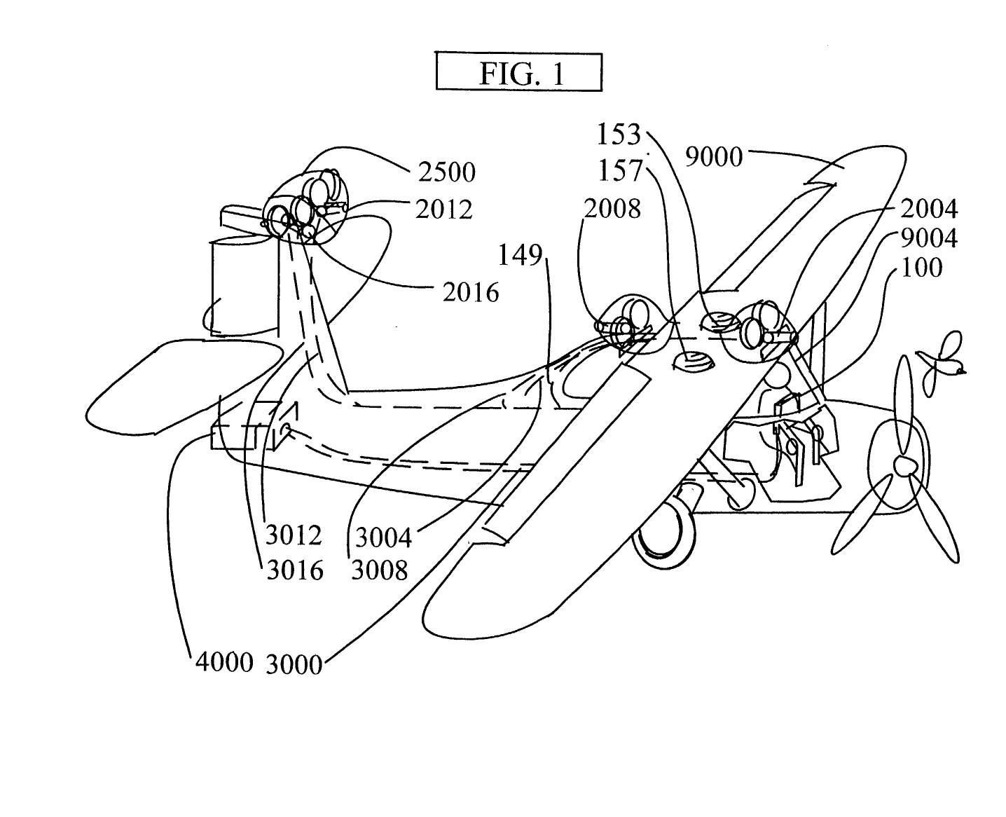

### Description—FIGS. 1-10:

### Detailed Description of Preferred Embodiment

FIG. 1. is a perspective drawing of the installed invention in the preferred embodiment in use with a single front engine, light airplane (9000). The three principle system components of the Electronic Rear View Mirror Component (100) (see Background Cross-Reference to My Related Inventions), the Video Recording Cameras Component (2000), and the Crash Prevention Recorder Package Component (4000) are shown.

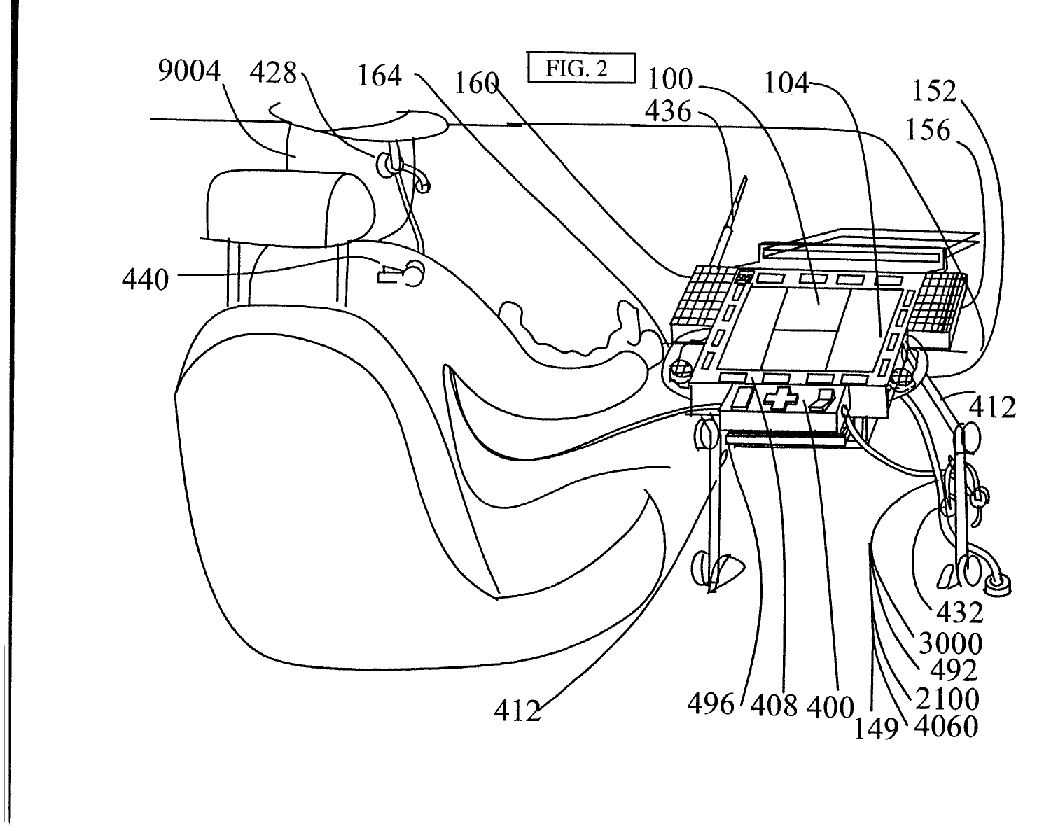

FIG. 2 is a close-up drawing of the action of a pilot of the single front engine, light airplane (9000), looking into the Electronic Rear View Mirror Component (100) (see Background—Cross-Reference to My Related Inventions). The placement of the Video Recording Camera Components (2000), the Front Video Camera (2004), Rear Video Camera (2008), Left Video Camera (2012), and Right Video Camera (2016) are shown with the pilot video display.

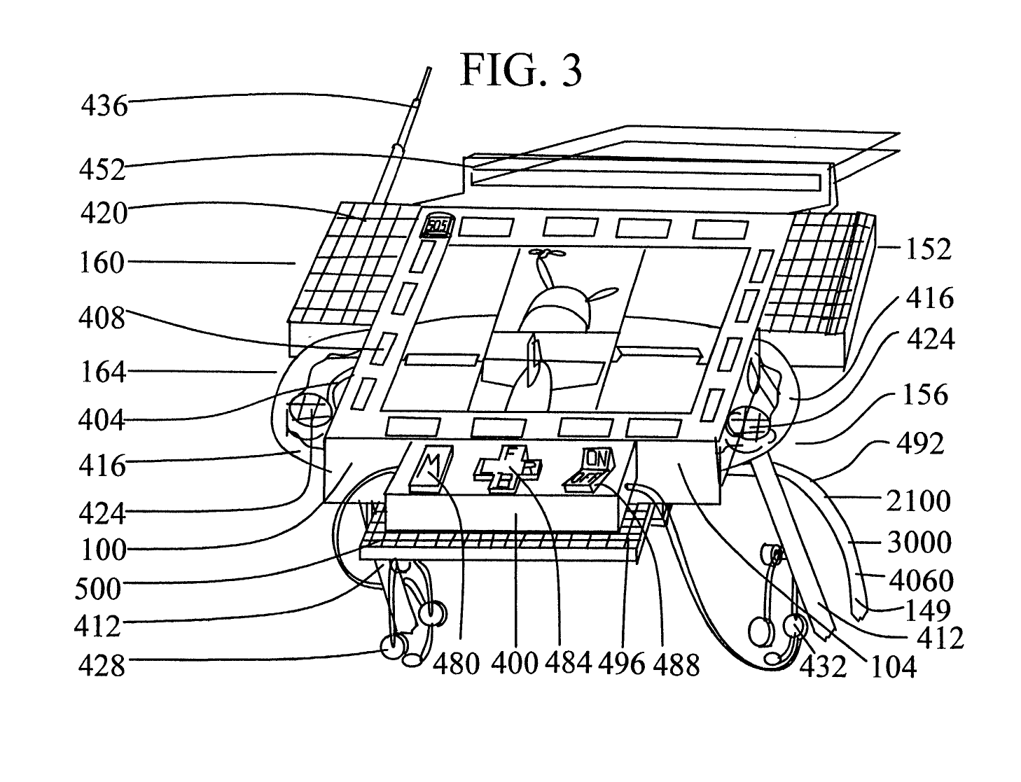

FIG. 3 is a close-up view of the Electronic Rear View Mirror Component (100).

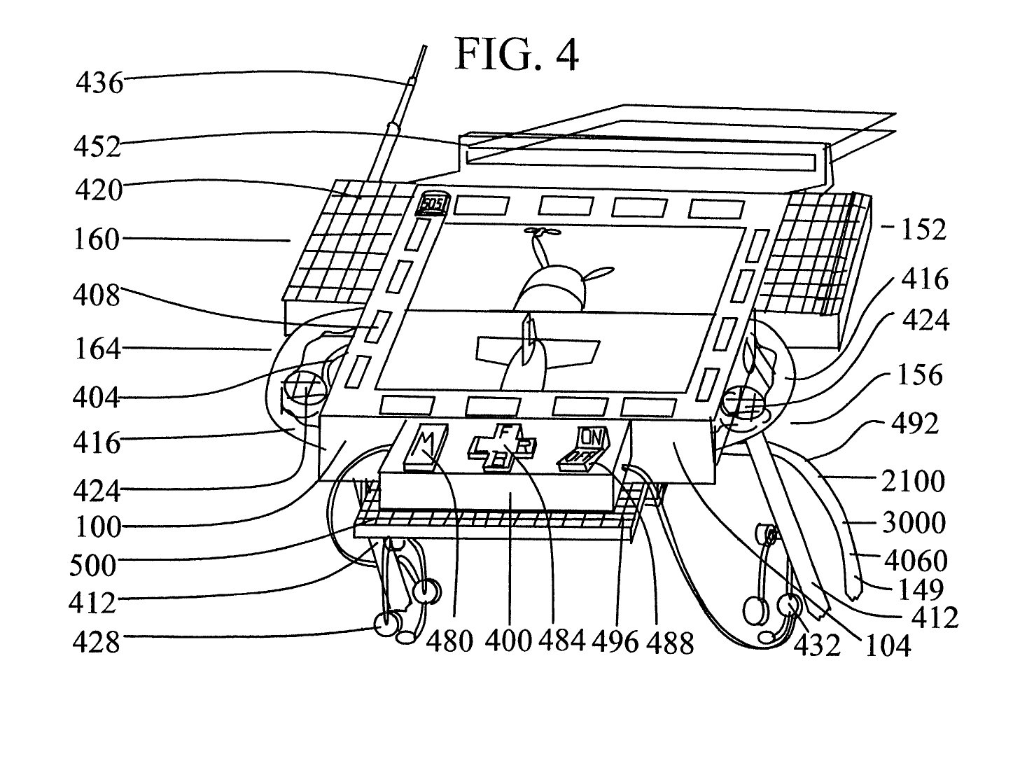

FIG. 4 is a close-up drawing of the action of someone looking into the Electronic Rear View Mirror Component (100) with “2 in 1 FB Mode” sequenced with “2 in 1 LR Mode” (shown in FIG. 4). The Front Blind-Spot (9012) and Rear Blind-Spot (9016) are shown.

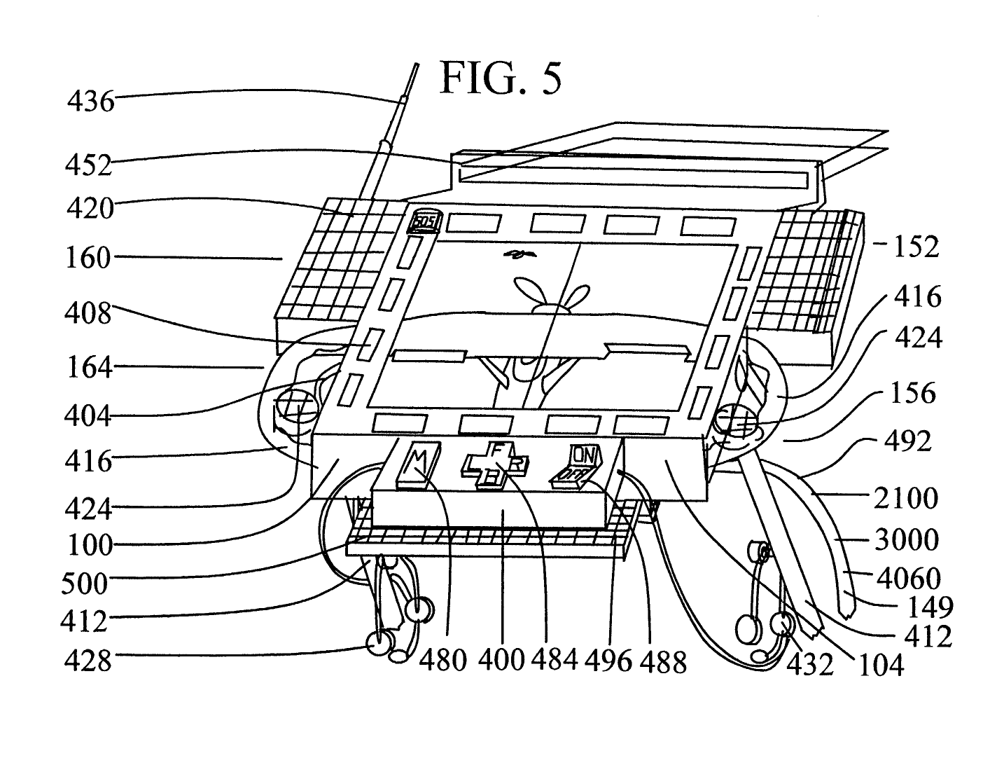

FIG. 5 is a close-up drawing of the action of a driver looking into the Electronic Rear View Mirror Component (100) with “2 in 1 LR Mode” sequenced with “2 in 1 FB Mode” (shown in FIG. 3). The Left Blind-Spot (9020) and Right Blind-Spots (9024) are shown.

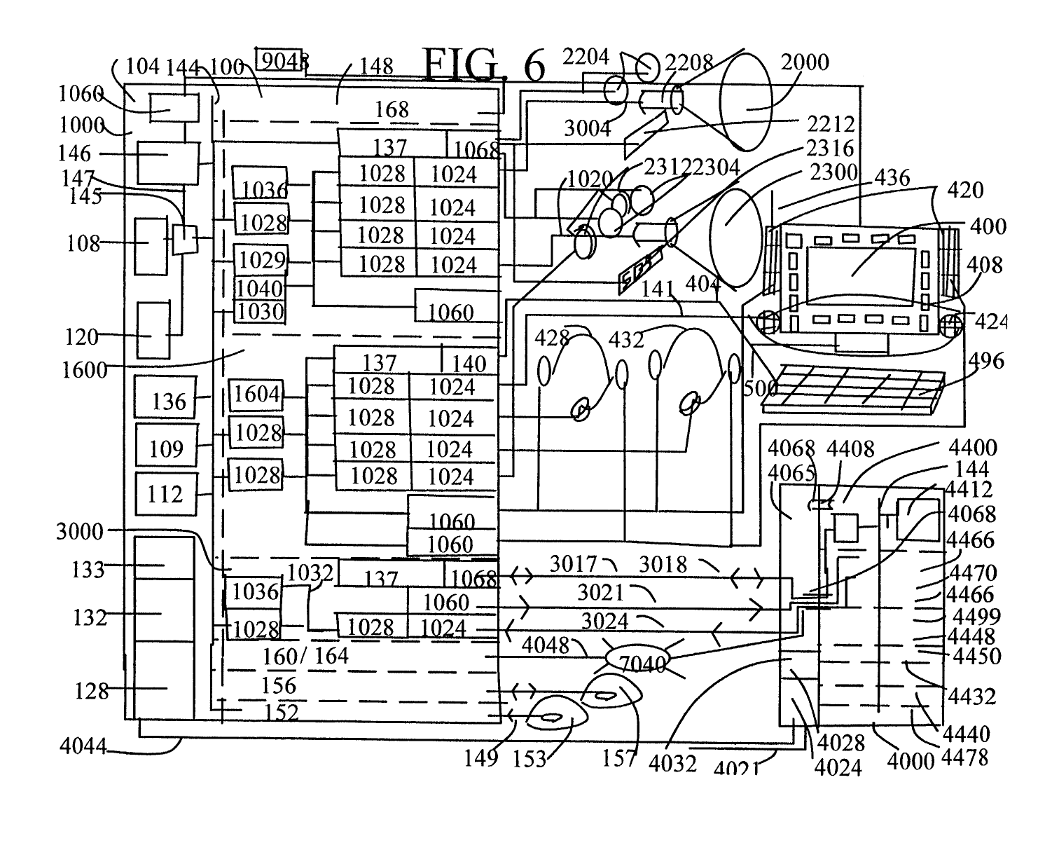

FIG. 6 is an electronic block diagram of a Video Frame Merger/Sequencer Unit design which is only one component of the Electronic Rear View Mirror (100) (see Background—Cross-Reference to My Related Inventions).

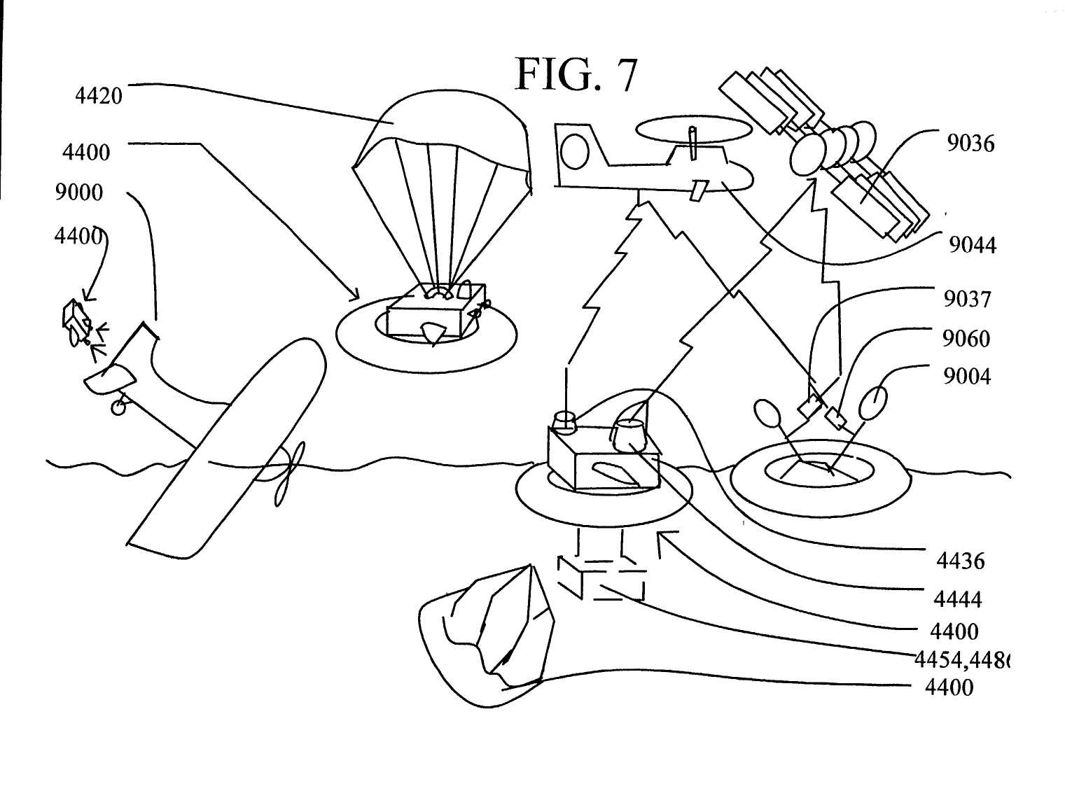

FIG. 7 is an action figure of the Crash Prevention Recorder Package Component (4000) showing pre-crash ejection, parachute deployment, float deployment, activation of Global Positioning System (GPS) satellite navigation receiver, and radio beacon activation.

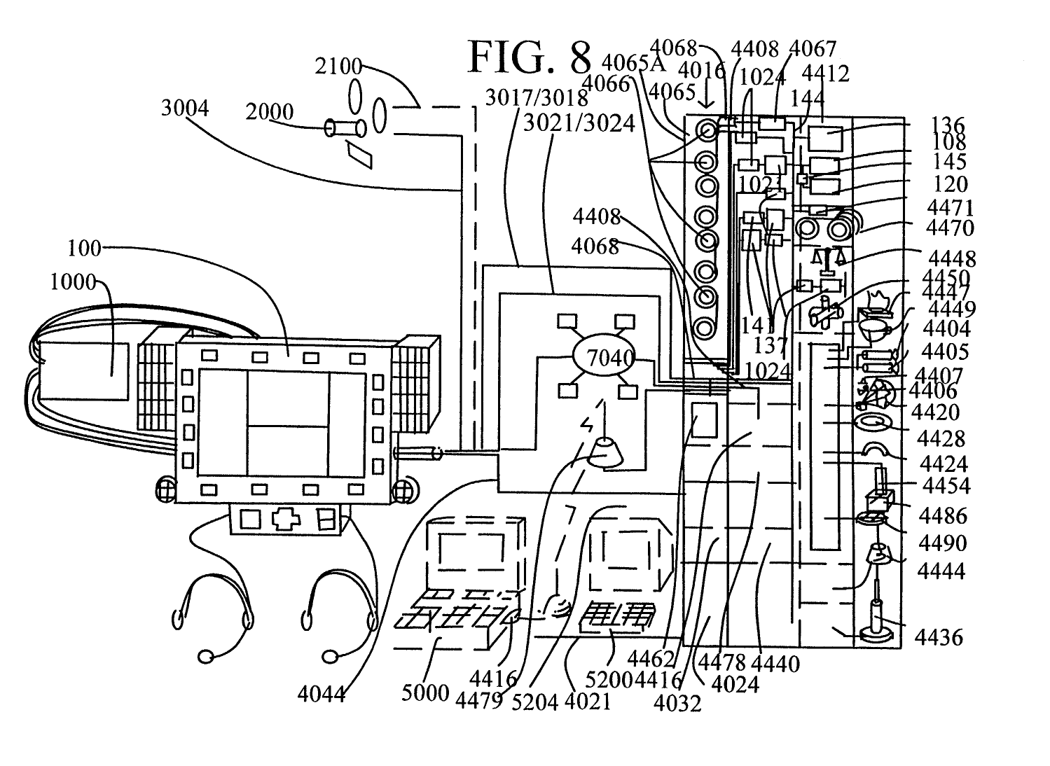

FIG. 8 is an electronic block diagram of the Crash Prevention Recorder Component (4000) package.

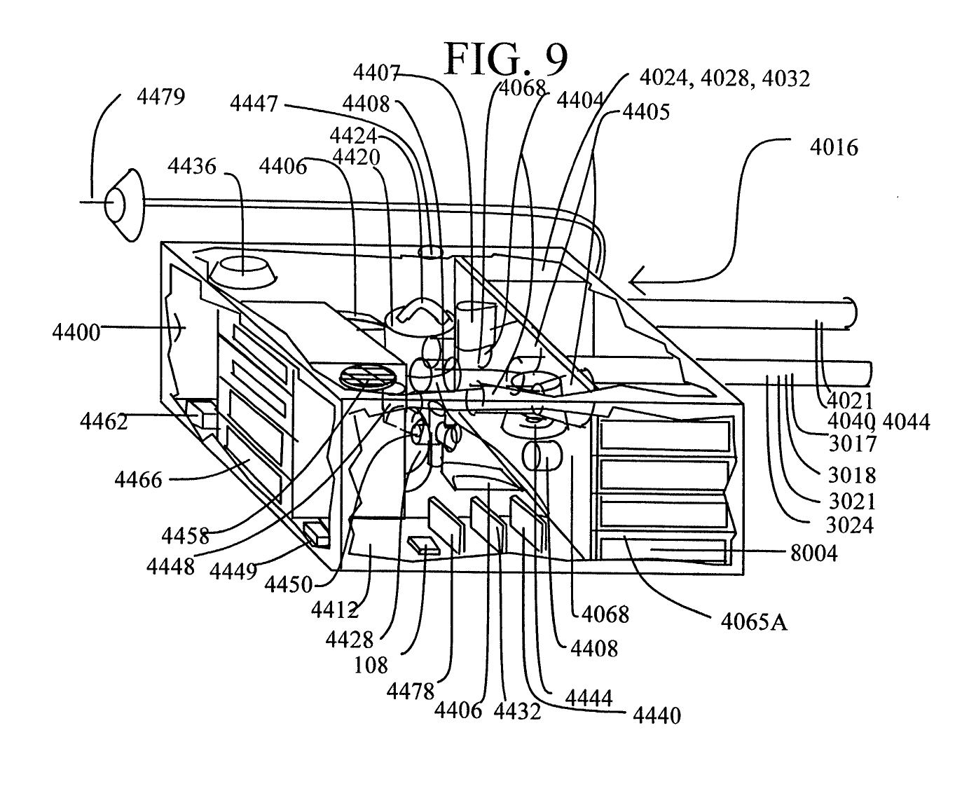

FIG. 9 is an mechanical block diagram of the Crash Prevention Recorder Component (4000) package.

### Operation of Invention—FIGS. 1-10:

### Detailed Operation of Preferred Embodiment

FIG. 1. is a perspective drawing of the installed invention in the preferred embodiment in use with a single front engine, light airplane (9000). The three principle system components of the Electronic Rear View Mirror Component (100) (see Background—Cross-Reference to My Related Inventions), the Video Recording Cameras Component (2000), and the Crash Prevention Recorder Package Component (4000) are shown.

FIG. 2 is a close-up drawing of the action of a pilot of the single front engine, light airplane (9000), looking into the Electronic Rear View Mirror Component (100) (see Background—Cross-Reference to My Related Inventions). The placement of the Video Recording Camera Components (2000), the Front Video Camera (2004), Rear Video Camera (2008), Left Video Camera (2012), and Right Video Camera (2016) are shown with the pilot video display.

FIG. 3 is a close-up view of the Electronic Rear View Mirror Component (100).

FIG. 4 is a close-up drawing of the action of someone looking into the Electronic Rear View Mirror Component (100) with “2 in 1 FB Mode” sequenced with “2 in 1 LR Mode” (shown in FIG. 4). The

Front Blind-Spot (806) and Rear Blind-Spot (808) are shown. FIG. 5 is a close-up drawing of the action of a driver looking into the Electronic Rear View Mirror Component (100) with “2 in 1 LR Mode” sequenced with “2 in 1 FB Mode” (shown in FIG. 3). The Left Blind-Spot (810) and Right Blind-Spots (812) are shown.

FIG. 6 is an electronic block diagram of a Video Frame Merger/Sequencer Unit design which is only one component of the Electronic Rear View Mirror ( ) (see Background—Cross-Reference to My Related Inventions).

FIG. 7 is an action figure of the Crash Prevention Recorder Package Component ( ) showing pre-crash ejection, parachute deployment, float deployment, activation of Global Positioning System (GPS) satellite navigation receiver, and radio beacon activation.

FIG. 8 is an electronic block diagram of the Crash Prevention Recorder Component ( ) package.

FIG. 9 is an mechanical block diagram of the Crash Prevention Recorder Component ( ) package.

### Advantages of the Preferred Embodiment

A. An advantage of this invention is to provide full pilot view of the left wing flap surfaces and right wing flap surfaces on a single, front engine, light airplane through an Electronic Rear View Mirror Component function (see BACKGROUND—Cross-Reference To My Related Inventions).

Current light aircraft have partial or obstructed pilot views of the left wing flap (aileron) surfaces and right wing flap (aileron) surfaces.

Current light aircraft have partial or obstructed pilot views of the left wing flap surfaces and right wing flap surfaces.

This is provided by the Left Video Camera mounted on the left wing and the Right Video Camera mounted on the right wing.

B. An advantage of this invention is to provide full pilot view of the front engine of a single, front engine, light plane and its rear vertical stabilizer (tail) with “rudder” surfaces through an Electronic Rear View Mirror Component function (see BACKGROUND—Cross-Reference To My Related Inventions).

Current light airplanes have full pilot view of a single, front mounted engine. Views of the vertical stabilizer and its “rudder” are non-existant or blocked.

Current light airplanes have full pilot view of a single, front mounted engine. Views of the vertical stabilizer and its “rudder” are non-existant or blocked.

This feature is provided by the Front Video Camera (2004) conformably mounted on the engine bay and the Rear Video Camera (2008) conformally mounted on the center of the rear fuselage.

C. An advantage of this invention is to provide full pilot view of both wing mounted engines and all flight control surfaces on twin engine, light aircraft through an electronic Rear View Mirror function (see BACKGROUND—Cross-Reference To My Related Inventions).

Twin engine, light aircraft have partial sideways pilot views of both engines mounted on each wing. Twin engine, light aircraft often have tail wings with tail based flaps called “elevators” and sometimes a vertical stabilizer contained tail “rudder”.

Twin engine, light aircraft have partial sideways pilot views of both engines mounted on each wing. Twin engine, light aircraft often have tail wings with rear tail flaps or “elevators” and sometimes a vertical stabilizer contained tail “rudder”.

The Left Video Camera (2012) will monitor the left wing flap. The Right Video Camera (2016) will monitor the right wing flap. The Front Video Camera (2004) will monitor the front of the plane with no engine bay. The Rear Video Camera (2008) will monitor the back of the plane.

A Left Video Camera Engine (2012) will monitor the left engine. A Right Video Camera Engine (2016) will monitor the right engine.

D. An advantage of this invention is to be fully electronic in implementation in everything except the Crash Prevention Recorder (CPR) Component's pre-crash ejectable, parachutable, floatable, and findable package. This full electronic design approach will lower system cost and increase system integration, flexibility and functionality.

E. An advantage of this invention is to not interfere in any way with any other aircraft aerodynamic controls, mechanical controls, or aircraft avionics systems.

This is accomplished by the add-on design approach, The Electronic Rear View Mirror Component is also an add-on device using two mechanical swing arms on either side of the flat panel display which is similar to a dentists chair x-ray machine arm.

Multi-redundant flight data recorders placed at different positions in the plane with different crash survival methods maximizes likelihood of at least one box surviving a tragic and fatal crash.

F. An advantage of this invention is to provide a High Security Data Recording (HSDR) Option for light aircraft.

This option is a specially protected security video recording feature to guard light planes parked in storage using motion sensor activated video cameras with low power florescent light floodlights.

The video recorder is kept in a tail mounted, pre-crash ejectable, parachutable, floatable, and findable package. The float package has a Global Positioning System (GPS) location system and an Emergency Positioning Independent Radio Beacon (EPIRB) or radio location system.

G. An advantage of this invention is to provide an inexpensive, vehicle Crash Prevention Recorder (CPR) Component consisting of a Video Flight Data Recorder (V-FDR) and Cockpit-Cabin Voice Recorder (CVR) to light aircraft.

Prior art for light airplanes is no crash recording beyond a portable, carry-on video camera and trying to radio for help.

For light airplanes this invention will offer the only low cost, Crash Prevention Recorder (CPR) feature.

A Crash Prevention Recorder (CPR), pre-crash ejectable, parachutable, floatable, and findable mechanism. The child unit will have parachute deployment, float deployment, GPS float location, radio beacon float location of the crash site.

This option gives a capability for monitoring vehicle crashes and also as a very low-cost, Video Flight Data Recorder (V-FDR), Cockpit-Cabin Voice Recorder (CVR) for light airplanes, and future hi-end upgrade to a digitally recording Crash Prevention Recorder (CPR).

This feature can be used on light airplanes with a Cockpit Voice Recorder (CVR) for an inexpensive Video Flight Data Recorder.

The video recorder is kept in a tail mounted, crash-detectable ejectable, parachute deployed, and raft deployed package. The float package has a Global Positioning System (GPS) location system and an Emergency Positioning Independent Radio Beacon (EPIRB) or radio location system.

H. An advantage of this invention is to provide a Telematics Computer Option or satellite navigation and trip planning computer option using Global Positioning System (GPS) satellite navigation receivers. The Global Positioning System receiver will allow use of GPS day, GPS time (extremely accurate to within 20 nanoseconds plus signal propagation delay of 10-20 microseconds), GPS latitude, GPS longitude, GPS alititude, GPS delta latitude, GPS delta longitude for digitally inserting into the video data of “GPS date, GPS time, and GPS position stamps” for recording by the Frame Merger/Sequencer Unit which is inside of the Electronic Rear View Mirror Component (100).

This option is a centralized, Man Machine Interface (MMI) to a vehicle navigation computer or telematics computer option which might be a light plane's only satellite navigation, Global Positioning System (GPS) based trip planning unit. This telematics computer feature is already provided by the Rear View Mirror Component (see BACKGROUND—Cross Reference To My Related Inventions).

Synthesized speech, voice recognition, keyboard entry, and bezel matrix display pushbutton entry will complete the Man Machine Interface (MMI).

A means for pilot control of light aircraft navigation computer and light aircraft navigation computer display is necessary. An optional aircraft navigation computer or Video Recorder display provides trip planning information and entertainment on long trips. Pilot monitoring is important on long trips to prevent flight hypnosis and driver sleep fatalities.

A newer commercial jet will have its own built-in GPS unit in an integrated, Inertial Navigation Unit (INU). In this case, the Telematics feature of the Rear View Mirror Component (see BACKGROUND—Cross-Reference To My Related Inventions) can act as a back-up GPS system and auxiliary system used with the attached Digital Versatile Disk (DVD) reader with a commercial trip planning DVD giving trip information and trip planning.

This option is a centralized, Man Machine Interface (MMI) to a vehicle navigation computer or telematics computer option which might be a light plane's only satellite navigation, Global Positioning System (GPS) based trip planning unit. This telematics computer feature is already provided by the Rear View Mirror Component (see BACKGROUND—Cross Reference To My Related Inventions).

I. An advantage of this invention is to provide an intelligent method of video reduction for the massive amounts of either analog or digital video recorded by a series of video cameras.

The Electronic Rear View Mirror Component is crucial for pilot/co-pilot selection of relevant frame merger/sequencing video to record given the massive full-motion data rates of analog or digital color video recording (see BACKGROUND). Remember: THE AUDIO/VIDEO RECORDER IS THE BOTTLENECK IN THE SYSTEM!!!!!!

For a 1st Alternative Embodiment consisting of an Add-on System to Large Commercial Jets, up to ten exterior flight surface/security video cameras, ten interior security audio/video cameras, and two cockpit security video cameras might be used all with very limited, crash survivable, data recording available.

Some video channels will need pilot selection for freeze-frame or time-lapse recording by a special video recorder at a minimum of two frames/second rates such as in security video recorders. Some video channels will be allocated to:

1). Deployed video recorder storage (see BACKGROUND—Flight Data Recorders) which is pre-crash ejected.

HIGHLY CRITICAL FLIGHT DATA with limited storage capacity.

2). Non-deployed video recorder storage in a CPR Mother Assembly with limited crash protection for removable digital streaming tape cassette access by ground crews or else through high speed, local, Microwave Frequency wireless access into a palm-held computer. MEDIUM CRITICAL FLIGHT DATA.

3). Augmented CPR Data Recording (for large private jets and large commercial jets) which will occur for non-deployed and non-crashworthy storage of digital video data and digital flight data by racks of removable streaming computer tape drives and digital tape cartridges accessible by locked access from inside of the passenger area. LOW CRITICAL FLIGHT DATA with almost unlimited storage capability for full-motion video and security cameras (see BACKGROUND—Crash Prevention Recorders).

HIGHLY CRITICAL FLIGHT DATA will need every ounce of storage efficiency squeezed in to make the best use of limited deployable memory storage. Special analog modulation and digital compression techniques introduced for the first time with this invention and unknown or unused in the prior art of flight data recording are mentioned below.

For analog audio/video signal recording, the unused “horizontal blanking period” and “vertical blanking period” (see BACKGROUND—Analog Signal Formats) can be used for inserting digital flight data modulated to analog by known modulation techniques, such as “Binary Phase Shift Keying (BPSK)” or “Quad Phase Shift Keying (QPSK)”. This digital flight data inserted can be GPS date, very accurate GPS time-stamps, GPS position information, Inertial Reference Unit (IRU) attitude information, GPS initialization informatin (such as recent satellite alamanac and initial crude time, date, and position), and even additional digitally compressed (MP3) audio channels which are modulated into analog signals. This modulation technique has been used before in other limited applications (see BACKGROUND—Mixed Analog and Digital Signals).

Alternately, for fully digital video signals, Moving Picture Experts Group II (MPEG II) digital video data compression can be used to reduce digital, color, full motion Super Video Graphics Array (SVGA) video from a whopping uncompressed 26.7 Mega byte/second data rate down to 3.4 Mega bytes/second. This compressed data rate is more manageable for recording.

For fully digital audio signals, Motion Picture Electronics Group I Level 3 (MP3) audio compression can be used. A single channel of digital audio can be compressed to a 20 Kilo bits/second data rate down from an uncompressed 56 Kilo bits/second data rate.

MPEG II compression can be slightly modified to handle insertion of the digital flight into a digital video screen background area. The digital flight data can be binary encoded by using American Standards Committee for Information Interchange (ASCII) encoding. The ASCII digital data can be inserted into a static digital, uncompressed, video background area of a single video channel. The variable starting location can be recorded using a variable starting address or offset from starting address of frame with the displaced background scene area being saved and also transmitted only once for a single variable background location for later re-construction. The variable starting position can be kept along with a contiguous digital flight data byte count at a fixed position such as the very last bytes of a frame.

The MPEG II compression process (see BACKGROUND—Digital Data Compression) will mark the digital flight data video area and digital flight ASCII data for special handling. The ASCII digital flight data will be digitally compressed by differencing between I-frames, P-frames, and B-frames to eliminate non-changing ASCII data between frames. Only ASCII data which changes between frames such as the least significant digits or lower digits of numerical data will be transmitted. However, the MPEG II compression process will be modified to mark the digital flight data for no use of lossy compression or data drop-out or simplification. The digital video data will be date stamped using GPS date, extremely accurately time stamped using GPS time (to within 20 nanoseconds plus signal propagation delay of 10-20 microseconds), GPS position stamped, GPS initialization data inserted, and even attitude stamped from an Inertial Reference Unit (IRU) accessed by the Electronic Rear View Mirror through the Flight Data Acquisition Unit. “Presentation time stamps” will be placed upon each frame to give the time of display.

MPEG I Level 3 (MP3) digital audio compression (see BACKGROUND—Digital Data Compression) will handle the entirely separate 2-channel (stereo) audio. This digital audio data is time correlated with the line sync and frame sync signals of the digital video data. “Presentation time stamps” will be placed with the audio digital data to sync it with the video.

Legal issues will arise to crash data such as: Who can look at it? Has it been tampered with? Was it thrown out to destroy evidence? Is final editing authority reserved to a competent Federal judge who can balance significant event Free Press rights vs. “privacy rights.”

Public Key Cryptography (authentication and Secret Key exchange) and Secret Key Cryptography (fast Secret Key encryption for secrecy) can be combined into Hybrid Key Cryptography. Hybrid Key Cryptography can give crash data the legal properties of:

1). data authentication—correct parties

2). data integrity—non-tampering

3). data secrecy—encryption to Secret Key holders

4). Digital Signaturing—Message Digest Cipher (MDC) computation and Public Key signing of the MDC.

5). data non-repudiation—denying a Digital Signature.

6). key escrow—Secret Keys and Private Keys key split with split keys stored with escrow parties for lost keys or government legal wiretaps.

7). copy counts—limited copying of clear-text data.

8). play counts—limited executions of clear-text data.

Hybrid Key Cryptography can be applied to the full digital data using a fast, hardware Secret Key encryption chip. Alternately, it can be applied to just the digital time stamp data for computation of a Message Digest Cipher which can be encrypted with the Public Key to produce a Digital Signature. The Message Digest Cipher and Digital Signature insures the full integrity of the data. A missing gap of frames from selective editing will become obvious.

J. An advantage of this invention is to provide an extremely inexpensive, non-crash survivable, Augmented Crash Prevention Recorder unit or sub-box which is in the same box as the crash survivable, Crash Prevention Recorder/Video-Flight Data Recorder (V-FDR)/Flight Data Recorder (FDR)/Cockpit Voice Recorder (CVR)/High Security Data Recorder (HSDR) unit for compact and inexpensive use in a light airplane.

The very first early 1990's Solid State Memories (see BACKGROND—Solid State Memories) in Flight Data Recorders stored only 80 Mega bytes of data. Year 2000 Flight Data Recorders made of several Solid State Memory boards filled with 256 Mega bits/IC EEPROM IC's can hold 5120 Mega bytes (5 Giga bytes) of memory. The latest Solid State Memories used in Video Flight Data Recorders with 5 Giga bytes of storage have enough capacity for freeze-frame (2 Hz or two frames a second) storage of even digital, MPEG II compressed, flight video from up to 8 video cameras with separate digital, compressed MPEG I Level 3 (MP3) audio channels from up to four audio channels.

Solid State Memory vs. Computer Streaming Tape Drives for video Flight Data Recording use. The future trend is towards all digital, all solid state electronics for use in crash resistant and deployable Flight Data Recording and Cockpit Voice Recording used only for HIGHEST CRITICALITY, CRASH DATA. This is because of almost no maintenance, almost human-goof-proof reliability, extremely high fire resistance with the addition of heat and vibration absorbing foam plastic fillings. The disadvantage of solid state memory is the high cost/Mega byte and the fact that the memory is NOT on-the-runway field-maintenance removable as the memory boards must be replaced by breaking black box seals at the certified depot maintenance level. The use of the data for on-the-runway maintenance must be accessed through real-time computer file downloading. This can be done through a palm-top or lap-top computer connected to an Ethernet Network Interface Card (NIC) (10 to 100 Mega bits/second) accessing the solid state memory or else through a palm-top or lap-top computer connected through a high-speed, Microwave Local Area Network (u-LAN) (100 Mega bits/second) to the solid state memory system. This is fine for short condensed data files such as time-stamped, avionics self-test data files, but, for huge digital video computer files (20 Giga bytes) will take a long time.

A secondary need is identified for LESSER CRITICALITY, FLIGHT MAINTENANCE, NON-CRASH DATA with quick on-the-runway access for routine, inexpensive, easy to remove, and extremely extensive maintenance data logging and huge capacity video flight data recording use. Digital streaming tape cartridge tape removal and replacement with a new tape by the pilot or flight crew is perfect for this secondary function. On-the-runway removal and replacement with a new cartridge for immediate post-flight pilot and maintenance crew analysis of streaming digital computer tapes is essential. This secondary function can be combined with solid state memory recording in the same fixed crash resistant or else deployed Flight Data Recorder or Cockpit Voice Recorder having external to the box, from the runway tape cartridge access. Alternately with much easier to access inside the passenger cabin tape cartridge data, an entirely separate box would be desirable on large commercial aircraft who can afford a separate box or a four box configuration of: 1). existing fixed Flight Data Recorder, 2). existing fixed Cockpit Voice Recorder, 3). new deployed Crash Prevention Recorder, 4). new fixed non-crashworthy Augmented Crash Prevention Recorder accessible from inside of the passenger cabin.

A secondary need is identified for LESSER CRITICALITY, FLIGHT MAINTENANCE, NON-CRASH DATA with quick on-the-runway access for routine, inexpensive, easy to remove, and extremely extensive maintenance data logging and huge capacity video flight data recording use. Future huge capacity, removable cartridge, Intel FLASH (R) Memory type of solid state memory cards can be used, but, is very expensive per memory card. Digital streaming tape cartridge tape removal and replacement with a new tape by the pilot or flight crew is perfect for this secondary function. On-the-runway removal and replacement with a new cartridge for immediate post-flight pilot and maintenance crew analysis of streaming digital computer tapes is essential.

This secondary in importance LESSER CRITICALITY, FLIGHT MAINTENANCE, NON-CRASH DATA function can be combined with HIGHEST CRITICALITY, CRASH DATA in a single box by using a mother/child design. A deployed child sub-box holding non-removable, crash survivable, solid state memory recording in the same box with a non-deployed mother sub-box holding lesser critical flight maintenance and flight safety data using removable cartridge type storage of digital computer streaming tape or Intel FLASH (R) memory types of cartridges. This gives for light commercial airplanes an inexpensive 3 box design of:

1). existing fixed Flight Data Recorder (FDR) box,

HIGHEST CRITICALITY CRASH DATA.

2). existing fixed Cockpit Voice Recorder (CVR) box,

HIGHEST CRITICALITY CRASH DATA.

3). add-on, deployed Crash Prevention Recorder (CPR) box,

child (deployed) sub-box has:

holds solid state memory reserved for HIGHEST CRITICALITY CRASH DATA:

Selected Crash Prevention Recording (CPR) data,

Selected Video Flight Data Recording (V-FDR) data,

Selected Cockpit Voice Recording (CVR) data,

Selected High Security Data Recording (HSDR) data.

mother (non-deployed) sub-box has:

new fixed, non-crashworthy, Augmented Crash Prevention Recorder Sub-box (A-CPR-sub-box) accessible from the rear of the aircraft for the removal and replacement of Solid State Memory Cards or Digital Streaming Tape Cartridges for LESSER CRITICALITY, FLIGHT MAINTENANCE DATA AND FLIGHT SAFETY DATA.

Alternately, with much easier access from inside the passenger cabin to LESSER CRITICALITY, FLIGHT MAINTENANCE AND FLIGHT SAFETY, NON-CRASH DATA, an entirely separate Augmented Crash Prevention Recorder (A-CPR) box would be desirable on larger private aircraft and also large commercial aircraft whose major airlines can afford a separate box or a four box data recording function configuration of:

1). existing, fixed, Flight Data Recorder (FDR) box,

2). existing, fixed, Cockpit Voice Recorder (CVR) box,

3). add-on, deployed Crash Prevention Recorder (CPR) box with the mother/child sub-box design described just above,

4). add-on, fixed, non-crashworthy, Augmented Crash Prevention Recorder (A-CPR) box accessible from inside of the passenger cabin.

Z. Further advantages of my invention will become apparent from a consideration of the drawings and ensuing description of it.

### Detailed Description of the 1st Alternative Embodiment

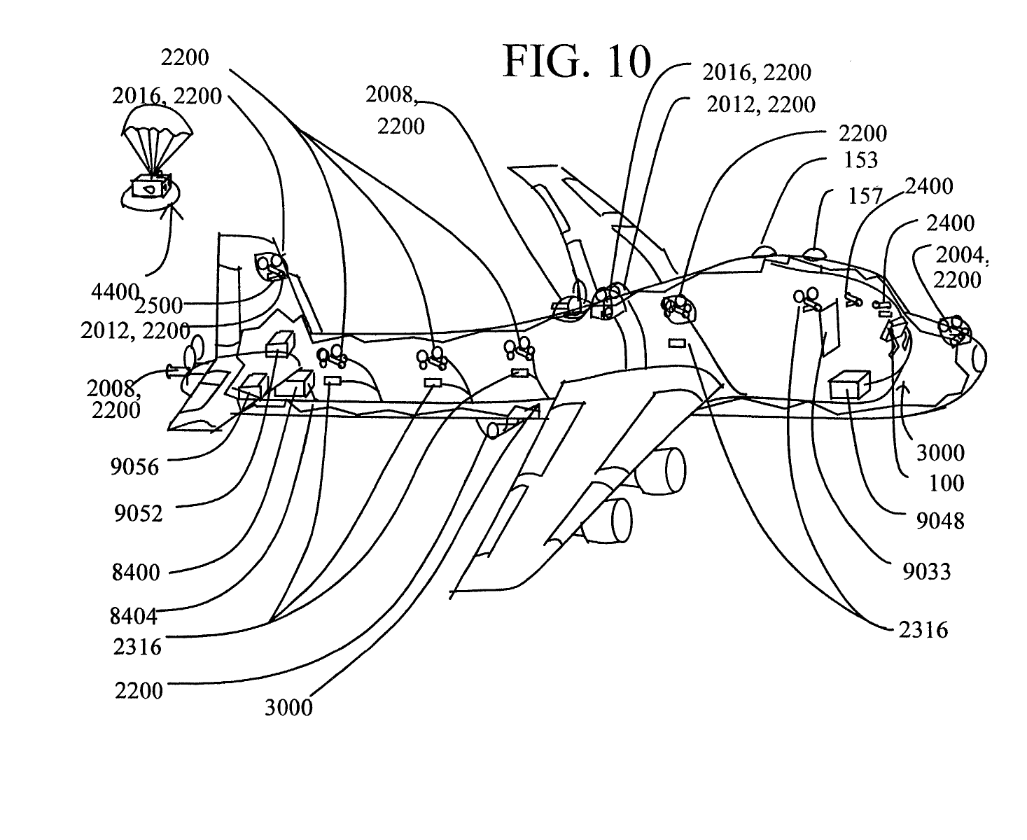

FIG. 10 is a perspective drawing of the 1st Alternative Embodiment or the Add-on Option To a Large, Commercial Jet Aircraft showing the Video Camera Components (2000), the exterior flight surface video cameras (2200), exterior Blind-Spot view video cameras (2200), interior security audio/video cameras (2300), Electronic Rear View Mirror Component (100) in the flight crew cabin, Video Local Area Network (V-LAN) (3000), Crash Prevention Recorder Component (CPR) (4000) in the tail assembly, Augmented Crash Prevention Recorder Component (A-CPR) (8400) in the passenger cabin, which will supplement the existing Flight Data Recorder (FDR) (9052) in the tail assembly, and also the existing Cockpit Voice Recorder (CVR) (9056) in the tail assembly.

### Detailed Description of Operation of the 1st Alternative Embodiment

FIG. 10 is a perspective drawing of the 1st Alternative Embodiment or the Add-on Option To a Large, Commercial Jet Aircraft showing the Video Camera Components (2000), the exterior flight surface video cameras (2200), exterior Blind-Spot view video cameras (2200), interior security audio/video cameras (2300), Electronic Rear View Mirror Component (100) in the flight crew cabin, Video Local Area Network (V-LAN) (3000), Crash Prevention Recorder Component (CPR) (4000) in the tail assembly, Augmented Crash Prevention Recorder Component (A-CPR) (8400) in the passenger cabin, which will supplement the existing Flight Data Recorder (FDR) (9052) in the tail assembly, and also the existing Cockpit Voice Recorder (CVR) (9056) in the tail assembly.

### Advantages of the 1st Alternative Embodiment

K. An advantage of this invention is to provide a 1st Alternative Embodiment consisting of an Add-on System to Large Commercial Jets which provides pilots with a full visible sight, pilot view of all flight control surfaces on existing, wide body, commercial jet aircraft.

Current large commercial jet aircraft have no pilot views of wing mounted engine pods, tail mounted engine pods, limited views of front and rear wing flaps also called ailerons, no views of tail wing flaps also called elevators, no view of the vertical stabilizer or “rudder” flight control surface, no view of any other tail mounted flight control surface such as the small, movable, tail mounted tail winglet on Boeing 727? jets (which have caused a few fatal crashes by mechanical failure).

L. An advantage of this invention is to provide a 1st Alternative Embodiment consisting of an Add-On System to Large Commercial Jets which provides pilots constant visible sight, 360 degree pitch plane, 360 degree roll plane, and 360 degree yaw plane knowledge of the airspace around their aircraft for emergency evasive maneuver.

Current light aircraft often give about 150 degree pitch plane, 360 degree pilot yaw plane, and 180 degree roll plane pilot visibility.

Current large commercial jetcraft give very limited pilot visibility. Mid-air crashes between large commercial jets and light planes often occur under “visible flight rules” without Visible IDentification (VID) by one or both pilots, Pilots must rely upon instrument readings, ground radar, FAA approved flight plans, co-pilot visible ID verifications, flight crew and passenger visible reports.

Ground radar units manned by Federal Aviation Administration (FAA) flight controllers usually radar capture small planes flying very near fast flying commercial jets in “incidents” in which the flight controllers must radio contact both planes to warn them of each other. Often near large airports, small planes unintentionally wander into FAA restricted air corridors restricted to fast flying commercial jet planes. These “incidents” often produce “near misses” when the air controller cannot radio contact the small plane or the small plane is piloted by a very amateur pilot endangering a commercial, 550 passenger jumbo jet.

M. An advantage of this invention in the 1st Alternative Embodiment consisting of an Add-On System for Large Commercial Jets is to provide an interior of crew/passenger cabin audio/video security recording and display and alerting function to the pilot or co-pilot for security purposes and prevention of hijackings by the alerting of undercover, on-board US Sky Marshalls. Interior audio/video cameras should have “SOS” buttons (instead of motion sensors) for flight crew and passenger alarms to the cockpit. As well, the evidence is video recorded and stored in the Crash Prevention Recorder (CPR) Component to help catch hijackers or suicide bomber accomplices.

Existing commercial jets have no such features. Hijackings often occur in the passenger cabin without pilot or co-pilot knowledge in the flight crew cabin. A voice contact or intercom contact must be made from the flight crew to the pilot and co-pilot.

N. An advantage of this invention in the 1st Alternative Embodiment consisting of an Add-On System for Large Commercial Jets is to provide a Crash Prevention Recorder (CPR) Component which will include a Video Flight Data Recorder (V-FDR) and Cockpit-Cabin Voice Recorder (CVR) which is pre-crash ejectable, parachutable, floatable, and findable which will supplement the existing Flight Data Recorder (FDR) and separate Cockpit Voice Recorder (CVR) or the famous “black boxes.”

This video data medium will be crew obtainable from outside of the plane through a locked service door for routine maintenance, service review. The video data can also be sent over a wireless, high-speed microwave frequency, Local Area Network (uWave-LAN), to a ground crew member equipped with a palm held computer running a maintenance and data recording computer program.

An inside the passenger cabin locked box, fixed (non-deployed) box, non-crashworthy, Augmented Crash Prevention Recorder (A-CPR) box will also have convenient cartridge tape removal access of voluminous video flight data and self-test data.

For the 1st Alternative Embodiment or Add-on Option System to Large Commercial Jets, this invention will supplement the existing, standard “black boxes” or the Flight Data Recorder (FDR) and Cockpit Voice Recorder (CVR). Video Flight Data Recording (V-FDR) of flight control surfaces and interior to the passenger cabin security video in cases of hijackings can be integrated with satellite navigation (Global Positioning System or GPS) and Inertial Navigation Unit (INU) data for collection in the Crash Prevention Recorder (CPR) for crash use and more importantly for pilot training, routine maintenance, and crash-detectable ejectable preventive diagnostics.

A Crash Prevention Recorder (CPR) will have a tail mounted, pre-crash ejectable, parachutable, floatable, and findable mechanism which uses parachute deployment, float deployment, GPS float location, radio beacon float location, and radio beacon location of the original crash site.

This option gives a capability for monitoring vehicle crashes and also as a very low-cost, Video Flight Data Recorder (V-FDR), Cockpit-Cabin Voice Recorder (CVR) for light airplanes.

This feature can be used on light airplanes with a Cockpit Voice Recorder (CVR) for an inexpensive Video Flight Data Recorder.

The video recorder is kept in a tail mounted, crash-ejectable, parachutable, floatable, findable package. The float package has a Global Positioning System (GPS) location system and an Emergency Positioning Independent Radio Beacon (EPIRB) or radio location system.

Large commercial aircraft will probably prefer a four box Flight Data Avionics approach shown in FIGS. 8, 9, 10, and 11 of:

1). existing Flight Data Recorder (FDR) (see BACKGROUND—Flight Data Recorders)

2). existing Cockpit Voice Recorder (CVR) (see BACKGROUND—Flight Data Recorders)

3). add-on deployable Crash Prevention Recorder (CPR) with Video Flight Data Recording (V-FDR) in two parts:

limited child deployable recording, and

more non-deployed and limited crash-worthy mother recording.

4) add-on Augmented Crash Prevention Recorder (A-CPR) with non-deployed and non-crashworthy but almost limitless data recording.

O. An advantage of this invention is to allow pilot or co-pilot selection of appropriate video to view and record. The frame merger/sequencer function allows the pilot or co-pilot to monitor the entire interior and exterior of the plane. However, not all the video can be recorded at once at all times as this will overwhelm any data recording device. Only human selected merged video can be viewed and recorded or else a full sequenced mode with a timed delay will sequence through and record all cameras one at a time.

The purpose of this feature is to add interior audio and video cameras to monitor the cabin spaces with only pilot or co-pilot selected frame merging/sequencing and video recording in the Crash Prevention Recorder (CPR).

The Add-on Option for Large Commercial Aircraft will add up to 8 units of interior to the cabin, audio/video security, and a total of 8 units of external video cameras for a total of 16 video cameras from which a co-pilot selection of up to a maximum of 4 units of exterior or interior video cameras will be used in frame merging for co-pilot listening, co-pilot display, and video recording. Video sequencing can sequence through all or a co-pilot chosen selection of the possible 16 video units for co-pilot listening, co-pilot display, and video recording.

The video recorder for the Crash Data Recorder (CDR) will be kept in a tail mounted, pre-crash ejectable, parachutable, floatable, and findable package. The float package has a Global Positioning System (GPS) location system and an Emergency Positioning Independent Radio Beacon (EPIRB) or radio location system.

This is accomplished throught the prior art component of the Electronic Rear View Mirror (see BACKGOUND—Cross-Reference To My Related Inventions).

P. An advantage of this invention in the 1st Alternative Embodiment of an Add-on System for Large, Commercial Aircraft is to provide an upgradable Video Local Area Network (Video LAN) Component above the initial low bandwidth, analog, Video Local Area Network (Video-LAN) Component used. This will NOT allow digital recording of more crash prevention data, since, Remember: the VIDEO RECORDING DEVICE IS THE BOTTLENECK IN THE SYSTEM!!!!.

Future upgrade to a high speed, high noise immunity, digital, fiber optic data bus used for extensive Crash Prevention Recorder (CPR) data recording of selected integrated data from flight instruments, video flight data of aerodynamic control surfaces, video flight data of internal passenger cabin activities, integrated with selected satellite navigation and Inertial Navigation Unit (INU) data. This data recording will be useful for preventive crash prevention efforts supplementing the use of the prior art Flight Data Recorder/Cockpit Voice Recorder “post mortem” crash prevention analysis.

Q. An advantage of the 1st Alternative Embodiment of an Add-on System for Large, Commercial Aircraft is to provide an easy to remove from inside of the passenger cabin system of data cartridges for post-analysis, in a fixed (non-deployed) and non-crashworthy, Augmented Crash Prevention Recorder (A-CPR), independent box for the holding of LOWER CRITICAL FLIGHT SAFETY DATA such as voluminous video data and extensive time-stamped self-test data.

The very first early 1990's Solid State Memories (see BACKGROND—Solid State Memories) in Flight Data Recorders stored only 80 Mega bytes of data. Year 2002 Flight Data Recorders made of several Solid State Memory boards filled with 256 Mega bits/IC (32 Mega bytes/IC) EEPROM IC's will be able to hold 5120 Mega bytes (5 Giga bytes) of memory using about 300 Integrated Circuit chips. The y. 2002 Solid State Memories used in Video Flight Data Recorders will be able to hold 5 Giga bytes of storage. Y. 2002 solid state memory cartridges will have enough capacity for freeze-frame (2 Hz or two frames a second) storage of even digital, MPEG II compressed, flight video from up to 8 video cameras with separate digital, compressed MPEG I Level 3 (MP3) audio channels from up to four audio channels.

Solid State Memory vs. Computer Streaming Tape Drives for video Flight Data Recording use. The future trend is towards all digital, all solid state electronics for use in crash resistant and deployable Flight Data Recording and Cockpit Voice Recording used only for HIGHEST CRITICALITY, CRASH DATA. This is because of almost no maintenance, almost human-goof-proof reliability, extremely high fire resistance with the addition of heat and vibration absorbing foam plastic fillings. The disadvantage of solid state memory is the high cost/Mega byte and the fact that the memory is NOT on-the-runway field-maintenance removable as the memory boards must be replaced by breaking black box seals at the certified depot maintenance level. The use of the data for on-the-runway maintenance must be accessed through real-time computer file downloading. This can be done through a palm-top or lap-top computer connected to an Ethernet Network Interface Card (NIC) (10 to 100 Mega bits/second) accessing the solid state memory or else through a palm-top or lap-top computer connected through a high-speed, Microwave Local Area Network (u-LAN) (100 Mega bits/second) to the solid state memory system. This is fine for short condensed data files such as time-stamped, avionics self-test data files, but, for huge digital video computer files (20 Giga bytes) will take a long time.

A secondary need is identified for LESSER CRITICALITY, FLIGHT MAINTENANCE, NON-CRASH DATA with quick on-the-runway access for routine, inexpensive, easy to remove, and extremely extensive maintenance data logging and huge capacity video flight data recording use. Digital streaming tape cartridge tape removal and replacement with a new tape by the pilot or flight crew is perfect for this secondary function. On-the-runway removal and replacement with a new cartridge for immediate post-flight pilot and maintenance crew analysis of streaming digital computer tapes is essential. This secondary function can be combined with solid state memory recording in the same fixed crash resistant or else deployed Flight Data Recorder or Cockpit Voice Recorder having external to the box, from the runway tape cartridge access. Alternately with much easier to access inside the passenger cabin tape cartridge data, an entirely separate box would be desirable on large commercial aircraft who can afford a separate box or a four box configuration of: 1). existing fixed Flight Data Recorder, 2). existing fixed Cockpit Voice Recorder, 3). new deployed Crash Prevention Recorder, 4). new fixed non-crashworthy Augmented Crash Prevention Recorder accessible from inside of the passenger cabin.

A secondary need is identified for LESSER CRITICALITY, FLIGHT MAINTENANCE, NON-CRASH DATA with quick on-the-runway access for routine, inexpensive, easy to remove, and extremely extensive maintenance data logging and huge capacity video flight data recording use. Future huge capacity, removable cartridge, Intel FLASH (R) Memory type of solid state memory cards can be used, but, is very expensive per memory card. Digital streaming tape cartridge tape removal and replacement with a new tape by the pilot or flight crew is perfect for this secondary function. On-the-runway removal and replacement with a new cartridge for immediate post-flight pilot and maintenance crew analysis of streaming digital computer tapes is essential.

This secondary in importance LESSER CRITICALITY, FLIGHT MAINTENANCE, NON-CRASH DATA function can be combined with HIGHEST CRITICALITY, CRASH DATA in a single box by using a mother/child design. A deployed child sub-box holding non-removable, crash survivable, solid state memory recording in the same box with a non-deployed mother sub-box holding lesser critical flight maintenance and flight safety data using removable cartridge type storage of digital computer streaming tape or Intel FLASH (R) memory types of cartridges. This gives for light commercial airplanes an inexpensive 3 box design of:

1). existing, fixed, Flight Data Recorder (FDR) box,

HIGHEST CRITICALITY CRASH DATA.

2). existing, fixed, Cockpit Voice Recorder (CVR) box,

HIGHEST CRITICALITY CRASH DATA.

3). add-on, deployed, Crash Prevention Recorder (CPR) box,

child (deployed) sub-box has:

holds solid state memory reserved for HIGHEST CRITICALITY CRASH DATA:

Selected Crash Prevention Recording (CPR) data,

Selected Video Flight Data Recording (V-FDR) data,

Selected Cockpit Voice Recording (CVR) data,

Selected High Security Data Recording (HSDR) data.

mother (non-deployed) sub-box has:

new fixed, non-crashworthy, Augmented Crash Prevention Recorder Sub-box (A-CPR-sub-box) accessible from the rear of the aircraft for the removal and replacement of Solid State Memory Cards or Digital Streaming Tape Cartridges for LESSER CRITICALITY, FLIGHT MAINTENANCE DATA AND FLIGHT SAFETY DATA.

Alternately, with much easier access from inside the passenger cabin to LESSER CRITICALITY, FLIGHT MAINTENANCE AND FLIGHT SAFETY, NON-CRASH DATA, an entirely separate Augmented Crash Prevention Recorder (A-CPR) box would be desirable on large commercial aircraft whose major airlines can afford a separate box or a four box data recording function configuration of:

1). existing, fixed, Flight Data Recorder (FDR) box,

2). existing, fixed, Cockpit Voice Recorder (CVR) box,

3). add-on, deployed, Crash Prevention Recorder (CPR) box with the mother/child sub-box design described just above,

4). add-on fixed, non-crashworthy, Augmented Crash Prevention Recorder (A-CPR) box accessible from inside of the passenger cabin.

### Detailed Description of the 2nd Alternative Embodiment

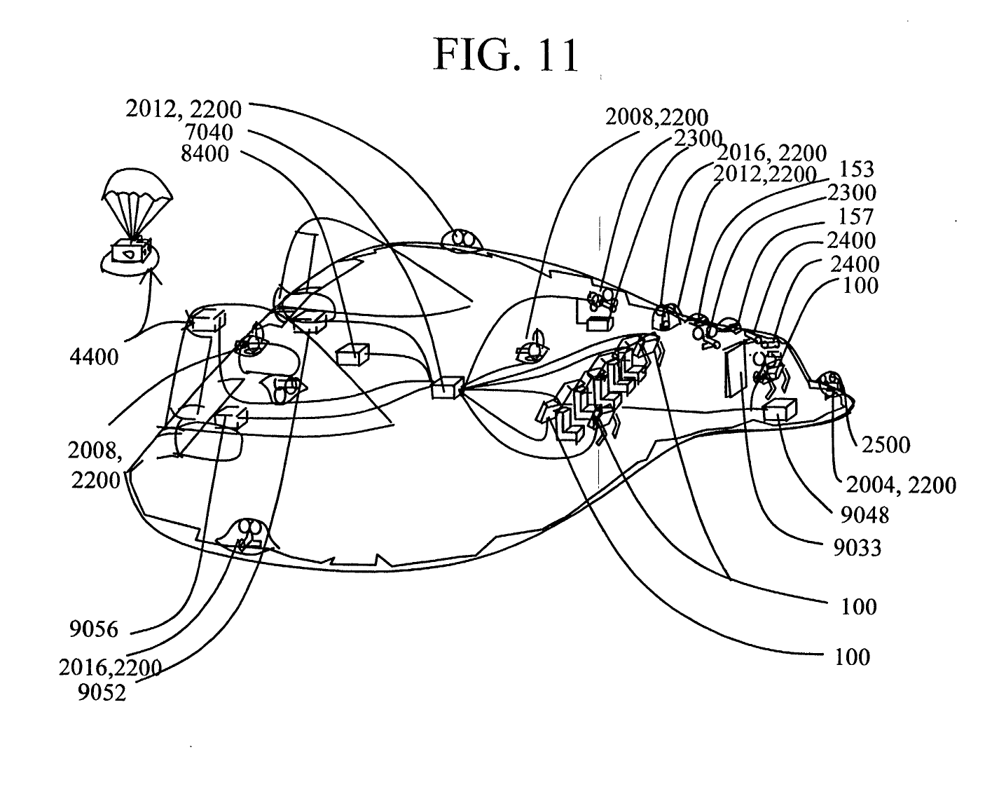

FIG. 11 is a perspective drawing of the 2nd Alternative Embodiment or Design-in Option Used In a Future, Commercial, Winged-body Aircraft having no passenger windows. The systems level invention will consist of an Electronic Rear View Mirror Component (see BACKGROUND—Cross-Reference To My Related Inventions) (100), a Video Camera Component (2000), a Video Local Area Network Component (V-LAN) (3000), a Crash Prevention Recorder Component (CPR) (4000), and an Augmented Crash Prevention Recorder Component (A-CPR) (8400) in the passenger cabin which will supplement existing non-deployed Flight Data Recorder (FDR) (9052) and an existing non-deployed Cockpit Voice Recorder (CVR) (9056).

Each passenger gets up to 20 electronic windows from his own highly integrated, Electronic Rear View Mirror Component ( ) (see BACKGROUND—Cross-Reference To My Related Inventions) installed in the seatback. A master control and display Electronic Rear View Mirror Component (see BACKGROUND—Cross-Reference To My Related Inventions) will sit in the cockpit for pilot and co-pilot use. The Video Camera Components ( ) will video capture all of the exterior flight control surfaces, the exterior Blind-Spot yaw and roll plane areas, and the interior flight crew and passenger cabin areas. The Video Local Area Network (Video LAN) Component ( ) will connect all the invention's electronics in a fault tolerant manner. The Crash Prevention Recorder (CPR) Component will sit in the tail assembly for crash detection and ejection.

### Detailed Description of Operation of the 2nd Alternative Embodiment

FIG. 11 is a perspective drawing of the 2nd Alternative Embodiment or Design-in Option Used In a Future, Commercial, Winged-body Aircraft having no passenger windows. The systems level invention will consist of an Electronic Rear View Mirror Component (see BACKGROUND—Cross-Reference To My Related Inventions) (100), a Video Camera Component (2000), a Video Local Area Network Component (V-LAN) (3000), a Crash Prevention Recorder Component (CPR) (4000), and an Augmented Crash Prevention Recorder Component (A-CPR) (8400) in the passenger cabin which will supplement existing non-deployed Flight Data Recorder (FDR) (9052) and an existing non-deployed Cockpit Voice Recorder (CVR) (9056).

Each passenger gets up to 20 electronic windows from his own highly integrated, Electronic Rear View Mirror Component ( ) (see BACKGROUND—Cross-Reference To My Related Inventions) installed in the seatback. A master control and display Electronic Rear View Mirror Component (see BACKGROUND—Cross-Reference To My Related Inventions) will sit in the cockpit for pilot and co-pilot use. The Video Camera Components ( ) will video capture all of the exterior flight control surfaces, the exterior Blind-Spot yaw and roll plane areas, and the interior flight crew and passenger cabin areas. The Video Local Area Network (Video LAN) Component ( ) will connect all the invention's electronics in a fault tolerant manner. The Crash Prevention Recorder (CPR) Component will sit in the tail assembly for crash detection and ejection.

### Advantages of the 2nd Alternative Embodiment

R. An advantage of the 2nd Alternative Embodiment Design-in System for a Commercial Winged Body Plane's Electronic Rear View Mirror Component (see BACKGROUND—Cross-Reference To My Related Inventions), Video Camera Components, Video Local Area Network Components, Crash Prevention Recorder Component, and Augmented Crash Prevention Recorder Component is to provide an integrated video function for the future, windowless passenger compartment, Boeing aircraft.

Each commercial, winged body, passenger will get NO physical windows, instead, he will get built into the facing seatback, his own Rear View Mirror Component (see BACKGROUND—Cross-Reference To My Related Inventions) with a 17″ flat panel display which will have a customer selectable choice of up to thirty electronic views around the aircraft!!!!!!! This will be integrated with a Crash Prevention Recorder (CPR) Component, a Video Camera Component, and a Video Local Area Network (Video LAN) Component.

There is no prior art on commercial, Winged Body aircraft, electronic window design. Military Winged Body aircraft such as the Northrop B2 bomber, have only pilot windows.

### Conclusion, Ramifications and Scope

A. This invention provides full pilot view of the left wing flap surfaces and right wing flap surfaces on a single, front engine, light airplane through an Electronic Rear View Mirror function (see BACKGROUND—Cross-Reference To My Related Inventions).

B. This invention provides full pilot view of the front engine of a single, front engine, light plane and its rear vertical stabilizer (tail) with “rudder” surfaces through an Electronic Rear View Mirror function (see BACKGROUND—Cross-Reference To My Related Inventions).

C. This invention provides full pilot view of both wing mounted engines and all flight control surfaces on twin engine, light aircraft through an Electronic Rear View Mirror function (see BACKGROUND—Cross-Reference To My Related Inventions).

D. This invention is fully electronic in implementation in everything except the Crash Prevention Recorder (CPR) Component's pre-crash ejectable, parachutable, floatable, and findable package. This full electronic design approach will lower system cost and increase system integration, flexibility and functionality.

E. This invention does not interfere in any way with any other aircraft aerodynamic controls, mechanical controls, or aircraft avionics systems.

F. This invention provides a High Security Data Recording (HSDR) Option for light aircraft.

G. This invention provides an inexpensive, vehicle Crash Prevention Recorder (CPR) Component consisting of a Video Flight Data Recorder (V-FDR) and Cockpit-Cabin Voice Recorder (CVR) to light aircraft.

H. This invention provides a Telematics Computer Option or satellite navigation and trip planning computer option using Global Positioning System (GPS) satellites and receivers. The Global Positioning System receiver will allow use of GPS day, GPS time, GPS latitude, GPS longitude, GPS alititude, GPS delta latitude, GPS delta longitude for digitally inserting into the video data for recording by the Frame Merger/Sequencer Unit which is inside of the Electronic Rear View Mirror Component (100).

I. This invention provides an intelligent method of video reduction for the massive amounts of either analog or digital video recorded by a series of video cameras.

For a 1st Alternative Embodiment consisting of an Add-on System to Large Commercial Jets, up to ten exterior flight surface/security video cameras, ten interior security audio/video cameras, and two cockpit security video cameras might be used all with very limited, crash survivable, data recording available.

J. This invention provides an extremely inexpensive, non-crash survivable, Augmented Crash Prevention Recorder unit or sub-box which is in the same box as the crash survivable, Crash Prevention Recorder/video-Flight Data Recorder (V-FDR)/Flight Data Recorder (FDR)/Cockpit Voice Recorder (CVR)/High Security Data Recorder (HSDR) unit for compact and inexpensive use in a light airplane.

K. This invention provides a 1st Alternative Embodiment consisting of an Add-on System to Large Commercial Jets which provides pilots with a full visible sight, pilot view of all flight control surfaces on existing, wide body, commercial jet aircraft.

L. This invention provides a 1st Alternative Embodiment consisting of an Add-On System to Large Commercial Jets which provides pilots constant visible sight, 360 degree pitch plane, 360 degree roll plane, and 360 degree yaw plane knowledge of the airspace around their aircraft for emergency evasive maneuver.

M. This invention provides a 1st Alternative Embodiment consisting of an Add-On System for Large Commercial Jets which provides an interior of passenger cabin audio/video security recording and display function to the pilot or co-pilot for security purposes and prevention of hijackings by the alerting of undercover on-board US Sky Marshalls. This alerting and monitoring function is done by the pilot or co-pilot using the Electronic Rear View Mirror to do real-time, audio/video surveillance of the interior cabin areas as well as the use of “SOS” buttons accessible to the passengers and flight crew. As well, the evidence is video recorded and stored in the Crash Prevention Recorder (CPR) Component to help catch hijackers or suicide bomber accomplices.

N. This invention provides a 1st Alternative Embodiment consisting of an Add-On System for Large Commercial Jets which provides a Crash Prevention Recorder (CPR) Component which will include a Video Flight Data Recorder (V-FDR) and Cockpit-Cabin Voice Recorder (CVR) which is pre-crash ejectable, parachutable, floatable, and findable and which will supplement the existing Flight Data Recorder (FDR)/Cockpit Voice Recorder (CVR) or the famous “black boxes.”

This video data medium is crew obtainable from outside of the plane through a locked service door for routine, maintenance, service review.

An inside the passenger cabin locked box, fixed (non-deployed) box, non-crashworthy, Augmented Crash Prevention Recorder (A-CPR) box will also have convenient cartrdige tape removal access of voluminous video flight data and self-test data.

O. This invention in the 1st Alternative embodiment provides a process for pilot or co-pilot selection of appropriate video to view and record. The frame merger/sequencer function allows the pilot or co-pilot to monitor the entire interior and exterior of the plane. However, not all the video can be recorded at once at all times as this will overwhelm any data recording device. Only human selected merged video can be viewed and recorded or else a full sequenced mode with a timed delay will sequence through and record all cameras one at a time.

P. This invention provides a 1st Alternative Embodiment of an Add-on System for Large, Commercial Aircraft which provides an upgradable Video Local Area Network (Video LAN) Component above the initial low bandwidth, analog, Video Local Area Network Component used in the Add-on Option to Large Commercial Jets. This will NOT allow digital recording of more crash prevention data, since, Remeber: THE VIDEO RECORDING DEVICE IS THE BOTTLENECK IN THE SYSTEM!!!!! This video data medium is crew obtainable from outside of the plane through a locked service door for routine service review.

Q. This invention in the 1st Alternative Embodiment of an Add-on System for Large, Commercial Aircraft provides an easy to remove from inside of the passenger cabin system of data cartridges for post-analysis, in a fixed (non-deployed) and non-crashworthy, Augmented Crash Prevention Recorder (A-CPR), independent box for the holding of LOWER CRITICAL FLIGHT SAFETY DATA such as voluminous video data and extensive time-stamped self-test data.

R. This invention in the 2nd Alternative Embodiment of a Design-in System for a Commercial Winged Body Plane's Integrated Rear View Mirror Component (see BACKGROUND—Cross-Reference To My Related Inventions), Video Camera Components, Video Local Area Network Components, Crash Prevention Recorder Component, and Augmented Crash Prevention Recorder Component which provides an integrated video function for the future, windowless passenger compartment, Boeing aircraft.

Z. Further objects and advantages of my invention will become apparent from a consideration of the drawings and ensuing description of it.

While my above description contains many specifications, these should not be construed as limitations on the scope of the invention, but rather as an exemplification of some preferred embodiments thereof. Any skilled product designer with knowledge of all prior art in the field and knowledge of this patent's example embodiments should be able to produce many other alternative embodiments. Many other variations are possible. For example a color, glare-resistant, Back-lit Liquid Crystal Display (LCD) display can be used for the Rear-view Mirror (100) or else a glare-resistant, Flat Surface Cathode Ray Tube (CRT) Display with a bent picture tube. The Electronic Rear-view Mirror can be in different positions in the cockpit. The basic flight recorder functions can be done by different boxes and combinations of boxes with both fixed and deployable boxes which fixed boxes can be either crash survivable or limited crash survivable or non-crash survivable. Analog audio/video signal formats can be used for fully digital compressed, audio/digital signal formats can be used. The Video Local Area Network can be fully analog for transfer of analog audio/analog video/and modulated digital flight data or else it can be fully digital sending digital compressed audio/digital compressed audio/digital flight data which is modulated to analog for transmission. The Video Local Area Network can upwardly migrate to a full digital fiber optic network. Analog, digital, analog/digital signal formats are fully interchangeable given the presense of conversion losses. Analog audio/video/modulated digital video recording devices can be interchanged with fully digital video recording devices such as computer streaming tape drives. The modern trend is to slowly migrate all equipment up to be able to handle fully analog signals to analog/digital signals to fully digital signals. The legal scope of this invention should be determined by the accompanying legal claims listed below and not by the detailed embodiments.

I claim:

1. A method or process of integrating previously defined and used, prior art, system components including an electronic rear view mirror component, a video camera component, a video local area network component, a crash prevention recorder component with means of audio/video recording and flight data recording of data for later retrieval through the steps of:
a) capturing of audio/video images by the video camera,
b) capturing of digital flight data to be inserted into the audio/video data stream to create audio/video/flight data,
c) merging and sequencing of frames by the frame merger and sequencer unit with human judgement and selection as to which of many views are selectable for video display and video recording with use of selective merging mode to merge selected views and selective sequencing mode to sequence selected views with audio/video recording of all pilot selected displays,
d) transferring of data by the video local area network component,
e) displaying of video data by the electronic rear view mirror component,
f) playing of audio data by the speakers on the electronic rear view mirror component,
g) storing of audio/video/flight data by the crash prevention recorder component.

2. The process of claim 1 whereby the step b) of capturing of digital flight data to be inserted into the audio/video data stream to form audio/video/flight data includes Global Positioning System (GPS) date, Global Positioning System time, Global Positioning System latitude, Global Positioning System longitude, Global Positioning System altitude, Global Positioning System delta latitude, Global Positioning System delta longitude, and other relevant flight data parameters in example being attitude or angle data from an Inertial Reference Unit (IRU) used to position stamp the video data, and GPS intialization information such as almanac and crude initial position.

3. The process of claim 1 whereby the step d) of transferring of data by the video local area network component does both integrated analog and digital data modulated to analog with the analog transferring consisting of the substeps of:
a) frame synchronising of frames using timing pulses,
b) transferring of analog signals or s-shaped video signals of one picture frame consisting of analog lines of video, line synchronisation timing pulses, and a horizontal blanking period, followed by,
c) inserting of digital flight data modulated to analog data by known modulation techniques during the vertical blanking period which occurs between picture frames,
d) transferring of analog audio signals through known modulation techniques with example means being Frequency Modulation on a different frequency.

4. The process of claim 3 whereby the horizontal blanking period also has inserted digital data modulated to analog data.

5. The process of claim 3 whereby the video local area network medium used is Closed Circuit TeleVision (CCTV), coaxial cable.

6. The process of claim 3 whereby the sub-step c) of inserting of digital data modulated to analog data by known techniques during the vertical blanking period is done by the electronic rear view mirror component's frame merger/sequencer unit.

7. The process of claim 6 whereby the frame merger/sequencer unit inserts current satellite navigation date, time, and position stamp data into the audio and video data stream in a very precise date and time stamp and also a position stamp which allows highly accurate space time diagram re-construction of events by post-event investigators.

8. The process of claim 7 whereby the digital date, and time stamp in particular and additional digital data is subject to hybrid key cryptography techniques which is combined Secret Key cryptography for the legal attributes of speed and secrecy and Public Key cryptography for the legal attributes of authentication and integrity of data.

9. The process of claim 6 whereby the frame merger/sequencer unit inserts Global Positioning System (GPS) initialization data such as current satellite almanac and initial crude position into the audio and video data stream for recording and initialization use by the Crash Prevention Recorder component's independent Global Positioning System (GPS) receiver which is not yet deployed until during a crash.

10. The process of claim 6 whereby the frame merger/sequencer unit inserts Inertial Reference Unit (IRU) attitude data into the audio video data stream for recording by the Crash Prevention Recorder component as an attitude stamp for space and time diagram reconstruction by post-event investigators.

11. The process of claim 6 whereby the frame merger/sequencer unit inserts additional compressed, digital audio channels modulated to analog into the audio video data stream for recording by the Crash Prevention Recorder component.

12. The process of claim 3 whereby the sub-step d) is followed by the sub-step of playing of the analog audio/video/flight data modulated to analog on the digital display, electronic rear-view mirror with dis-inserting of the digital flight data for display over-writing for uses such as but not limited to satellite navigation date, time, position, etc.

13. The process of claim 3 whereby the sub-step d) is followed by the sub-step of playing of the analog audio/video/flight data modulated to analog on the analog speakers of the electronic rear-view mirror with separation of the audio frequency from the video frequency.

14. The process of claim 3 whereby the sub-step d) is followed by the sub-step of recording of the analog audio/video/flight data modulated to analog on the crash prevention recorder component's analog video recorder medium.

15. The process of claim 14 whereby the recording of the analog audio/video/flight data modulated to analog is done by a video cassette recorder player with storage of data upon an appropriate, removable, analog, magnetic tape, cartridge medium.

16. The process of claim 1 whereby the step d) of transferring of data by the video local area network component does only integrated, fully, digital data transferring consisting of the substeps of:
a) frame synchronising of frames using timing pulses,
b) transferring of compressed digital video signals or binary 1's and 0's signals of one picture frame consisting of digital lines of video, presentation time stamps, furthermore, an example means of compression is given as Moving Picture Experts Group Level II (MPEG II) digital video compression, which is followed by,
c) inserting of binary encoded data with example means being American Standards for Computing Information and Interchange (ASCII) encoded digital flight data which is inserted into a static background video area which does not vary between picture frames, furthermore, the digital flight data is marked for non-lossy digital compression with compression means such that all non-changing digits of the digital flight data are differenced out by the digital compression process, furthermore, the static video background area is transmitted for background video re-construction, furthermore, a protocol means is provided for indicating the starting address and byte length of the variably positioned flight data as well as the displaced background video such as through example means use of a static field in the last bytes of the video frame,
d) transferring of compressed digital audio signals on a separate digital channel with presentation time stamps synchronising it to the video data, furthermore, an example means of digital audio compression is MPEG I Level 3 (MP3) audio compression.

17. The process of claim 16 whereby the video local area network medium used is fiber, optic cable of some kind given by specific example such as single frequency or single-mode, multi-frequency or multi-mode fiber.

18. The process of claim 16 whereby the video local area network media used is coaxial cable or Closed Circuit TeleVision (CCTV) cable using a fully digital, full-duplex, multi-frequency, symmetric, cable modem which is also called a digital, broadband modem.

19. The process of claim 16 whereby the sub-step c) of inserting of binary encoded digital flight data into static video background areas is done by the electronic rear view mirror component's frame merger/sequencer unit.

20. The process of claim 19 whereby the frame merger/sequencer unit inserts current digitally encoded satellite navigation date, time, and position stamp data into the audio and video data stream in a very precise date and time stamp and position stamp allowing accurate space and time diagrams done by post-event investigators.

21. The process of claim 19 whereby the frame merger/sequencer unit inserts digital Global Positioning System (GPS) initialization data such as current satellite almanac and initial crude position into the audio and video data stream for recording and use by the Crash Prevention Recorder component's independent Global Positioning System (GPS) receiver.

22. The process of claim 21 whereby the digital date, and time stamp in particular and additional digital data is subject to hybrid key cryptography techniques which is combined Secret Key cryptography for the legal attributes of speed and secrecy and Public Key cryptography for the legal attributes of authentication and integrity of data.

23. The process of claim 19 whereby the frame merger/sequencer unit inserts digitally encoded Inertial Reference Unit (IRU) attitude data into the audio video data stream for recording by the Crash Prevention Recorder component in an attitude stamp for accurate attitude re-construction by post event investigators.

24. The process of claim 16 whereby the sub-step d) is followed by the sub-step of playing of the compressed, digital video on the digital display, electronic rear-view mirror with dis-inserting of the digital flight data for display over-writing for uses such as but not limited to satellite navigation date, time, position, etc.

25. The process of claim 16 whereby the sub-step d) is followed by the sub-step of playing of the compressed, digital audio on the analog speakers of the electronic rear-view mirror.

26. The process of claim 16 whereby the sub-step d) is followed by the sub-step of storing of the compressed digital audio and digital video data by the crash prevention recorder component using a digital video recorder.

27. The process of claim 26 whereby the storing of the compressed digital audio and digital video data is done on a Digital Versatile Disk (DVD) Player on an appropriate removable disk data storage medium.

28. The process of claim 26 whereby the storing of the compressed digital audio and digital video data is done by a digital computer tape drive also known as a streaming tape drive with storage done upon appropriate removable digital computer tape cassette.

29. The process of claim 16 whereby the Video Local Area Network (V-LAN) medium used is digital, fiber optic cable with a duo-redundant, star topology with passenger seat-back, electronic rear view mirror components and a master cockpit electronic rear view mirror component used in a winged body transport.

30. A method or process of using a crash prevention recorder component having the processes of:
a) modeling by computer of electronic motion sensors and transducers used to detect crash conditions for ejection, slow water immersion, end of parachute fall, water landings and upside-down landings,
b) ejecting of float package or child sub-component which contains the recording medium from the mother sub-component by the crash prevention recorder component such as through example means of solid rocket propellant, air foil, or pneumatic push,
c) deploying of parachutes on the float package by the crash prevention recorder component,
d) deploying of float on the float package by the crash prevention recorder component,
e) releasing of parachute on the float package by the crash prevention recorder component,
f) reading of electronic motion sensor for water landings and upside-down landings,
g) deploying of ballast only in water landings and upside-down landings to reduce rocking and to right a child sub-component of crash prevention recorder component which is capsized by large ocean waves,
h) deploying of satellite navigation antenna by the crash prevention recorder component,
i) receiving of radio frequency signals by the satellite navigation receiver in the crash prevention recorder component,
j) deploying of radio location antenna by the crash prevention recorder component,
k) transmitting of radio location beacon signals by the crash prevention recorder component.

31. The process of claim 30 whereby the step a) of modeling by electronic motion sensors and transducers for detecting crash conditions for ejection, end of parachute fall, water landings and upside-down landings, is done by computer with electronic slow water immersion sensors, electronic leveling sensors, and rate accelerometer sensors.

32. The process of claim 30 whereby the step b) of ejecting of float package or the child sub-component which holds the recording medium from the mother sub-component of the crash prevention recorder is done with solid rocket propellant.

33. The process of claim 32 whereby the solid rocket propellant containers end with directional thrust nozzles controlled by the smart, motion control computer to direct the Crash Prevention Recorder away from the aircraft in an upwards direction despite aircraft orientation.

34. The process of claim 32 whereby the Crash Prevention Recorder has deployable mini-winglets to allow aerodynamic control during ejection.

35. The process of claim 30 whereby the step k) of transmitting of radio location beacon data by the radio location beacon is done with a prior art, standard, US Coast Guard approved, Emergency Positioning Independent Radio Beacon (EPIRB) doing the fully automatic sub-steps of:
a) broadcasting of satellite navigation historic date and time of crash,
b) broadcasting of historic satellite navigation position of crash site with plane and pilot,
c) broadcasting of current date and time, and current, satellite navigation drift position of float with recording medium.

36. The process of claim 30 whereby the step k) of transmitting of radio location beacon data by the radio location beacon is done with a prior art, US Air Force Electronic Location Transmission (ELT) component doing the fully automatic sub-steps of:
a) broadcasting of satellite navigation historic date and time of crash,
b) broadcasting of historic satellite navigation position of crash site with plane and pilot,
c) broadcasting of current date and time, and current, satellite navigation drift position of float with recording medium.
